(19) United States
(12) Patent Application Publication
(10) Pub. No.: US 2006/0263097 A1
(43) Pub. Date: Nov. 23, 2006

(54) Optical transmitting apparatus, optical receiving apparatus, and optical communication system comprising them

(75) Inventors: Yuichi Akiyama, Kawasaki (JP); Takeshi Hoshida, Kawasaki (JP); Akira Miura, Kawasaki (JP); Hiroki Ooi, Kawasaki (JP); Jens Rasmussen, Kawasaki (JP); Kentaro Nakamura, Kawasaki (JP); Naoki Kuwata, Kawasaki (JP); Yoshinori Nishizawa, Kawasaki (JP); Tomoo Takahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/256,128

(22) Filed: Oct. 24, 2005

(30) Foreign Application Priority Data
May 23, 2005 (JP) 2005-150219
Jun. 30, 2005 (JP) 2005-192971

(51) Int. Cl. H04B 10/04

(52) U.S. Cl. 398/188

(57) ABSTRACT

A phase shift unit provides a prescribed phase difference (π/2, for example) between a pair of optical signals transmitted via a pair of arms constituting a data modulation unit. A low-frequency signal f₀ is superimposed on one of the optical signals. A signal of which phase is shifted by π/2 from the low-frequency signal f₀ is superimposed on the other optical signal. A pair of the optical signals is coupled, and a part of which is converted into an electrical signal by a photodiode. 2f₀ component contained in the electrical signal is extracted. Bias voltage provided to the phase shift unit is controlled by feedback control so that the 2f₀ component becomes the minimum.

### BACKGROUND OF THE INVENTION

1. Field of the Invention

The present invention relates to an optical transmitting apparatus, an optical receiving apparatus, and an optical communication system comprising them, and more specifically to an optical transmitting apparatus for transmitting an optical signal using PSK modulation, an optical receiving apparatus for receiving an optical signal from the optical transmitting apparatus, and an optical communication system comprising those apparatus.

2. Description of the Related Art

Development of a practical implementation of an optical transmitting apparatus aiming to establish a high capacity and long distance optical transmission system has been awaited in recent years. Particularly, expectations for implementation of an optical transmitting apparatus, which employs an optical modulation technique adequate for high capacity and long-distance, to an actual system are growing high. In order to meet with expectations, optical transmission systems using phase shift keying such as DPSK (Differential Phase Shift Keying) and DQPSK (Differential Quadrature Phase Shift Keying) are envisioned.

NRZ (Non-Return-to-Zero) modulation techniques and RZ (Return-to-Zero) modulation techniques, actually operated on land and under the sea, are known as actual optical modulation techniques. In an optical transmission system using such modulation techniques, technology for stabilizing operation of components in a transmitter for optical transmission signal has great importance. An example is an ABC (Automated Bias Control) circuit in the NRZ modulation for preventing transmission signal degradation caused by drift of the operating point of a LN (Lithium Niobate) modulator. (See Patent Document 1)

There is also a bias control method for an optical SSB (Single Side-Band) modulator with a plurality of optical modulation units, in which appropriate correction of direct-current bias for each optical modulation unit is performed during normal operation of the modulator. (See Patent Document 2)

An example of an optical receiving apparatus for receiving a DQPSK signal is described in Patent Document 3. In the optical receiving apparatus in the Patent Document 3, a phase of an optical signal is shifted by π/4 in one of a pair of waveguides constituting a Mach-Zehnder interferometer.

[Patent Document 1] Japanese laid-open unexamined patent publication No. 03-251815

[Patent Document 2] Japanese laid-open unexamined patent publication No. 2004-318052

[Patent Document 3] Japanese publication of translated version No. 2004-516743

FIG. 1 is a block diagram describing a configuration of an optical transmitting apparatus employing a conventional NRZ modulation technique with an ABC circuit for NRZ. In FIG. 1, the optical transmitting apparatus employing a conventional NRZ modulation comprises a laser diode 111, a phase modulator 221, comprising a MZ (Mach-Zehnder) modulator etc., which carries out phase modulation by inputting an NRZ data signal DATA to a modulating electrode, and an ABC circuit for NRZ 550, which, by monitoring a part of the optical output of the phase modulator 221, detects a low frequency signal superposed on the data signal DATA, applies a control signal to bias tees (not shown in figures) of the phase modulator 221, and compensates for a deviation of an operating point.

The ABC circuit in the conventional optical transmitting apparatus employing the NRZ modulation, however, only performs bias control, which compensates for the deviation of an operating point of the MZ modulator, and it does not comprise means for monitoring the amount of phase shift of a phase shift unit necessary for phase shift keying such as DQPSK, which is receiving attention for its anticipated potential. For that reason, the conventional technology shown in FIG. 1 could not be applied to phase shift keying such as DQPSK. There was a problem that the concept of total control of phase shifting and DC drift with regard to an entire optical transmitting apparatus employing phase shift keying such as DQPSK did not exist.

Additionally, in an optical receiving apparatus described in the Patent Document 3, it is required to shift the phase of an optical signal by π/4; however, no measures have been taken to prevent loss of accuracy of an optical device due to age deterioration.

### SUMMARY OF THE INVENTION

It is an object of the present invention to provide a configuration of an optical transmitting apparatus comprising a phase modulator, in which phase shifting and DC drift etc. can be properly controlled.

It is another object of the present invention to provide a configuration in which phase shifting and DC drift etc. in a phase shifting unit, a phase modulator, and an intensity modulator can be properly controlled in an entire optical transmitting apparatus.

It is a further object of the present invention to provide a configuration of an optical receiving apparatus for receiving a modulated optical signal, in which the phase shift necessary for demodulating a received signal is properly controlled.

The optical transmitting apparatus according to the present invention comprises a phase modulator and a driving signal generation unit for driving the phase modulator. The phase modulator comprises a phase shift unit which provides a proper phase difference between a pair of split optical signals on an optical waveguide, a data modulation unit which performs a phase modulation of the optical signals on the split optical waveguide and an electrode for superimposing a low-frequency signal. The optical transmitting apparatus according to the present invention comprises: low-frequency signal superimposing means for generating low-frequency signals with a proper phase difference and for providing the low-frequency signals to the electrode on the split optical waveguide; monitor means for monitoring at least one of maximum power, minimum power and phase of a low-frequency signal or a higher harmonic signal of the low-frequency signal superimposed on the optical signal after coupling of the split optical waveguide; and phase difference control means for controlling the phase shift unit so as to obtain a proper phase difference based on the output of the monitor means.

The optical transmitting apparatus according to another aspect of the present invention transmits a modulated optical signal corresponding to a data signal, and comprises: a phase shift unit for controlling a phase of at least one of a first optical signal and a second optical signal, acquired by splitting an optical input, so that the first and the second optical signals have a predetermined phase difference on an optical waveguide; a data modulation unit for modulating the phases of the first and the second optical signals by using the data signal on the optical waveguide; monitor means for monitoring average optical power of a modulated optical signal acquired by coupling the first and the second optical signals modulated by the data modulation unit; and control means for controlling the phase shift unit based on an output of the monitor means. The data modulation unit comprises phase addition means for adding a prescribed phase to a phase determined according to the data signal.

The optical receiving apparatus according to the present invention receives and demodulates a phase-modulated optical signal, and comprises: an interferometer comprising a first arm for delaying first split light of optical input by a symbol time period and a second arm for shifting a phase of the second split light of the optical input by a prescribed amount; an O/E converter circuit for converting an optical signal output from the interferometer into an electrical signal; a calculation circuit for generating a squared signal or an absolute value signal of the electrical signal; a filter, connected to the calculation circuit, for transmitting at least a part of frequency component except for the frequency, which is a integral multiple of a symbol frequency; and control means for controlling the amount of the phase shift in the second arm based on the output from the filter.

According to the present invention, quality of the output optical signal can be stabilized by controlling phase shift, which may deviate by fluctuation of temperature change or aging and so forth of components constituting an optical transmitting apparatus, to obtain a proper phase.

In addition, since the phase shift necessary for demodulating the receiving optical signal can be appropriately controlled, deterioration of the receiving characteristics can be eliminated.

### BRIEF DESCRIPTION OF THE DRAWINGS

FIG. 1 is a block diagram describing a configuration of an optical transmitting apparatus comprising a conventional NRZ modulator;

FIG. 2 is a diagram showing a configuration of an optical communication system relating to the preferred embodiment of the present invention;

FIG. 3 is a diagram explaining a principle of the DQPSK modulation;

FIG. 4 is a diagram explaining deterioration of communication quality in the DQPSK modulation;

FIG. 5 is a diagram showing an entire configuration of an optical transmitting apparatus using the RZ-DQPSK modulation relating to the preferred embodiment of the present invention;

FIG. 6 is a diagram showing a first configuration of an optical transmitting apparatus relating to the first embodiment of the present invention;

FIG. 7 is a waveform diagram presenting a simulation result of the low-frequency signal component, when n=1 in the phase shifter;

FIG. 8 is a waveform diagram presenting a simulation result of the low-frequency signal component, when n=2 in the phase shifter;

FIG. 9 is a waveform diagram presenting a simulation result of the low-frequency signal component, when n=3 in the phase shifter;

FIG. 10 through FIG. 12 are diagrams describing second through fourth configuration of an optical transmitting apparatus relating to the first embodiment of the present invention;

FIG. 13 through FIG. 16 are diagrams describing first through fourth configuration of an optical transmitting apparatus relating to the second embodiment of the present invention;

FIG. 17 and FIG. 18 are diagrams describing first and second configuration of an optical transmitting apparatus relating to the third embodiment of the present invention;

FIG. 19 and FIG. 20 are diagrams describing first and second configuration of an optical transmitting apparatus relating to the fourth embodiment of the present invention;

FIG. 21 is a diagram describing a configuration of an optical transmitting apparatus relating to the fifth embodiment of the present invention;

FIG. 22 is a diagram describing a configuration of an optical transmitting apparatus relating to the sixth embodiment of the present invention;

FIG. 23 is a diagram describing a configuration of an optical transmitting apparatus relating to the seventh embodiment of the present invention;

FIG. 24 is a diagram describing a configuration of an optical transmitting apparatus relating to the eighth embodiment of the present invention;

FIG. 25 is a diagram describing a configuration of an optical transmitting apparatus relating to the ninth embodiment of the present invention;

FIG. 26A is a diagram showing waveform of optical power detected by a square-law detection;

FIG. 26B is a graph showing a relation between the amount of phase shift and the peak power;

FIG. 27 is a diagram describing an entire configuration of the optical transmitting apparatus using the DMPSK modulation;

FIG. 28 is a diagram describing a first specific example of the control method shown in FIG. 27;

FIG. 29 is a diagram describing a second specific example of the control method shown in FIG. 27;

FIG. 30 is a diagram showing an entire configuration of an optical transmitting apparatus using CSRZ-DPSK modulation;

FIG. 31 is a diagram showing a first practical example of fluctuation control in the optical transmitting apparatus shown in FIG. 30;

FIG. 32 is a diagram showing a second configuration example of a fluctuation control in the optical transmitting apparatus shown in FIG. 30;

FIG. 33 is a diagram describing a specific example of the first configuration shown in FIG. 31;

FIG. 34 is a diagram describing a specific example of the second configuration shown in FIG. 32;

FIG. 35 is a diagram indicating a relation between the bias in the MZ modulator and detected low-frequency signals;

FIG. 36 is a diagram indicating a relation between the bias in the intensity modulator and detected low-frequency signals;

FIG. 37 is a diagram showing a modified example of the optical transmitting apparatus shown in FIG. 31;

FIG. 38 is a diagram explaining a principle of the twelfth embodiment;

FIG. 39 through FIG. 41 are first through third practical example of the 12th embodiment;

FIG. 42 is a diagram explaining a principle of the 13th Embodiment;

FIG. 43 is a diagram explaining a brief overview of a method for controlling a mark rate of a data signal;

FIG. 44 is a diagram describing a configuration of an optical receiving apparatus of an embodiment of the present invention;

FIG. 45 is a diagram describing an optical receiving apparatus of the first embodiment;

FIG. 46A and FIG. 46B are diagrams showing waveforms of the differential signal;

FIG. 47A and FIG. 47B are diagrams showing eye diagram of the differential signal;

FIG. 48A and FIG. 48B are diagrams indicating the waveform of the squared signal;

FIG. 49A and FIG. 49B are diagrams showing spectrum of the squared signal;

FIG. 50 is a diagram showing a modified example of an optical receiving apparatus shown in FIG. 45;

FIG. 51 is a diagram describing a configuration of the optical receiving apparatus of the second embodiment;

FIG. 52A through FIG. 52C explain the principle of operation of the optical receiving apparatus of the second embodiment;

FIG. 53 is a diagram describing a configuration of the optical receiving apparatus of the third embodiment;

FIG. 54A through FIG. 54D explain the principle of operation of the optical receiving apparatus of the third embodiment;

FIG. 55 is a diagram describing a configuration of the optical receiving apparatus for receiving the DPSK modulated signal;

FIG. 56A and FIG. 56B are diagrams showing eye diagrams of a signal received by the optical receiving apparatus shown in FIG. 55;

FIG. 57 is a diagram describing a configuration of the optical receiving apparatus of the fourth embodiment;

FIG. 58A through FIG. 58C show the waveform of the differential signal;

FIG. 59A through FIG. 59C show waveform of the squared signals;

FIG. 60 describes a relation between the deviation amount of the delay time and the average power of the squared signal;

FIG. 61 is a diagram describing a modified example of the optical receiving apparatus shown in FIG. 57;

FIG. 62 is a diagram describing a configuration of the optical receiving apparatus of the fifth embodiment; and

FIG. 63A through FIG. 63C explain the principle of operation of the optical receiving apparatus of the fifth embodiment.

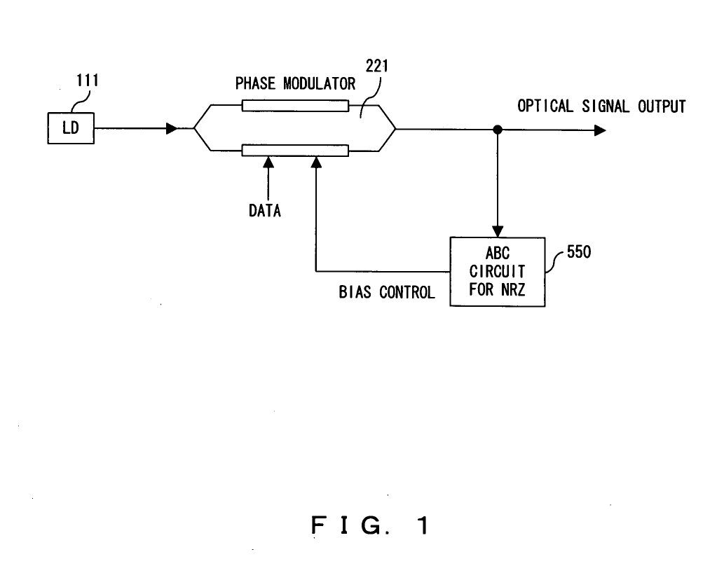

### DESCRIPTION OF THE PREFERRED EMBODIMENTS

In the following description, the preferred embodiments of the present invention are set forth with reference to the drawings.

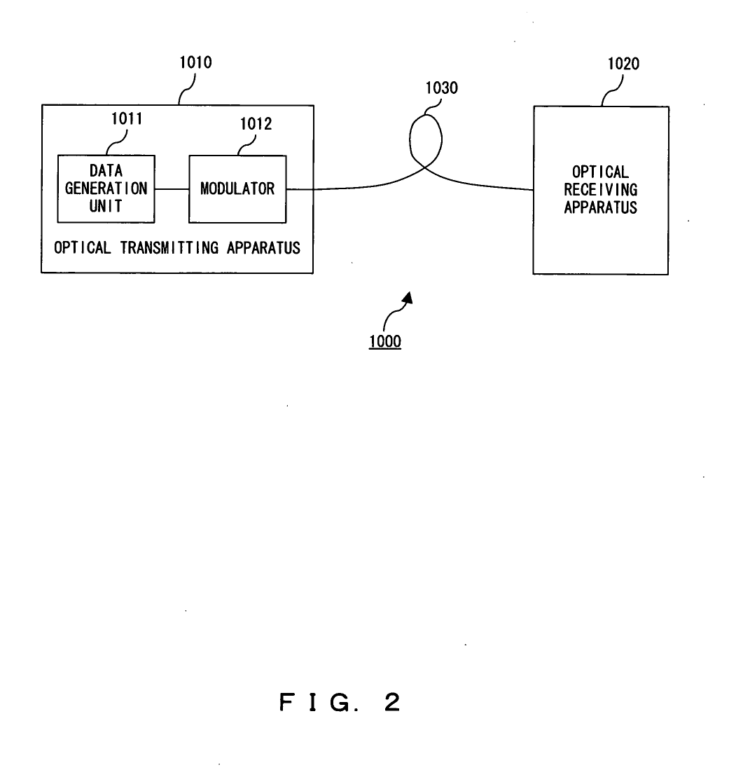

FIG. 2 is a diagram showing a configuration of an optical communication system relating to the preferred embodiment of the present invention. An optical communication system 1000 shown in FIG. 2 comprises an optical transmitting apparatus 1010, an optical receiving apparatus 1020, and a transmission channel optical fiber 1030 for connecting between the preceding devices. The optical transmitting apparatus 1010 comprises a data generation unit 1011 and a modulator 1012. The data generation unit 1011 generates data to be transmitted. The modulator 1012 generates a modulated optical signal using the data generated by the data generation unit 1011. In this case, the modulation method is not limited in particular but is the DQPSK, for example. The optical receiving apparatus 1020 obtains data by demodulating an optical signal transmitted via the transmission channel optical fiber 1030. An optical amplifier or an optical repeater can be provided on the transmission channel optical fiber 1030.

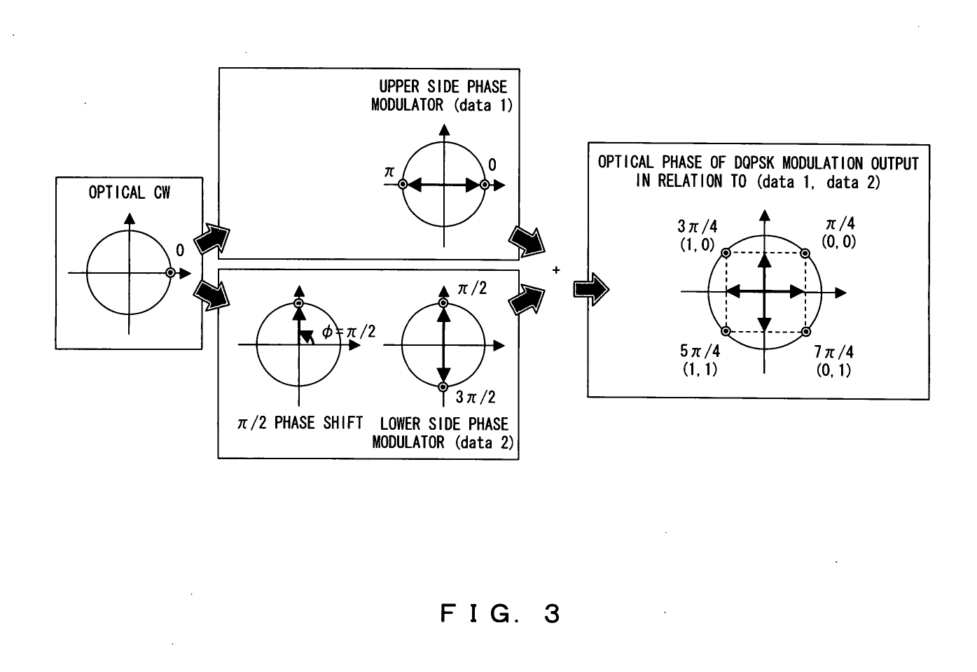

FIG. 3 is a diagram explaining the principle of the DQPSK (or QPSK) modulation. In the DQPSK modulation, two-bit data (data 1, data 2) is transmitted as one symbol. Here, each symbol is assigned with a phase corresponding to a combination of the data (data 1, data 2). In the example shown in FIG. 3, “π/4” is assigned to the symbol (0, 0), “3π/4” is assigned to the symbol (1,0), “5π/4” is assigned to the symbol (1,1), and “7π/4” is assigned to the symbol (0,1). Therefore, the optical receiving apparatus can regenerate data by detecting the phase of the received signal.

In order to achieve the above phase modulation, optical CW (Continuous Wave) is split into two, and one of the split light is phase modulated by the data 1 and the other split light is phase modulated by the data 2. Then, the phase assigned to the data 2 is shifted by “π/2” with respect to the phase assigned to the data 1. In other words, a device to generate π/2-phase shift is required in the DQPSK modulation.

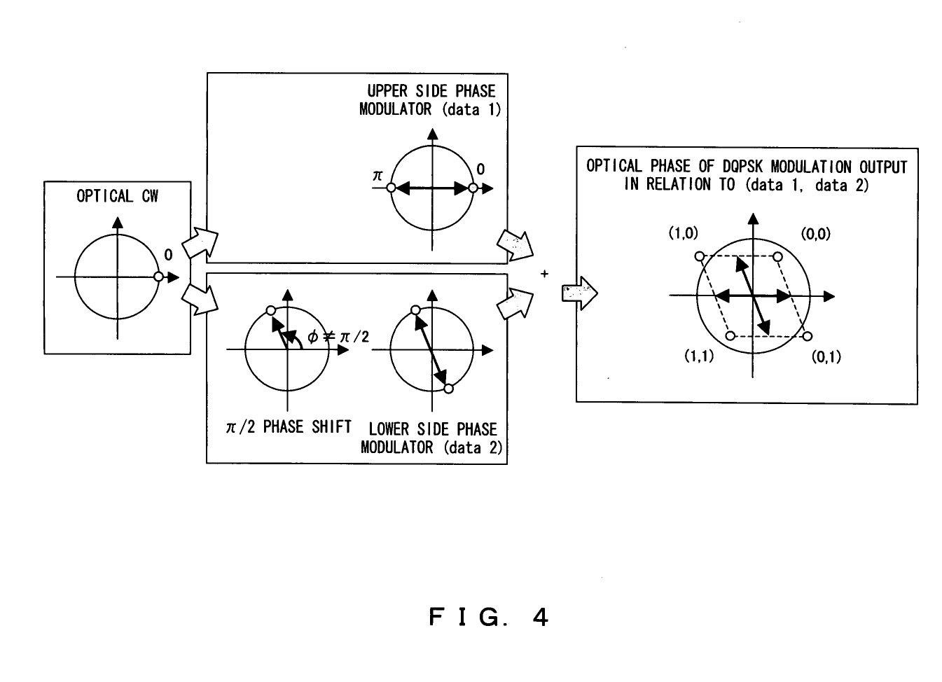

FIG. 4 is a diagram explaining deterioration of communication quality in the DQPSK modulation. An optical transmitting apparatus employing the DQPSK modulation, as described above, comprises a device for generating π/2-phase shift. However, when the amount of phase shift deviates from π/2 due to aging phenomenon etc., the positions of each symbol on a phase plane also deviate, as shown in FIG. 4, and the possibility of erroneous data recognition increases in an optical receiving apparatus. Therefore, in order to improve the communication quality of the DQPSK modulation system, it is important to maintain high accuracy of the π/2-phase shift device.

<<Optical Transmitting Apparatus>>

### First Embodiment

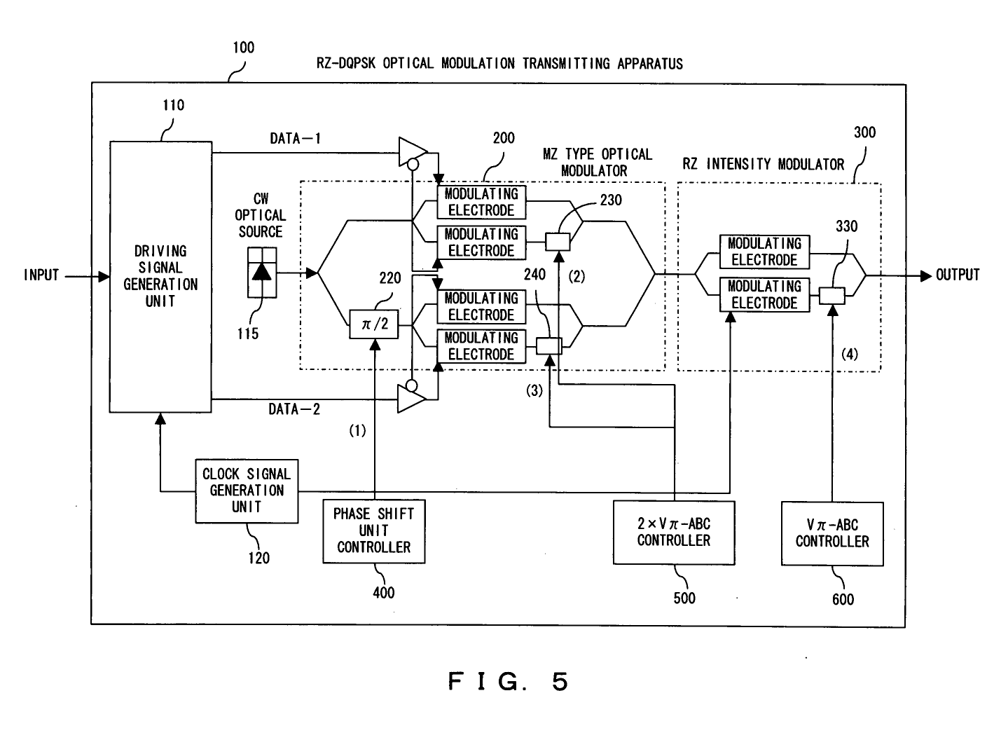

FIG. 5 is an overview block diagram showing a entire configuration of an optical transmitting apparatus with RZ-DQPSK modulation relating to the preferred embodiment of the present invention. In FIG. 5, a RZ-DQPSK optical modulation transmitter comprises a driving signal generation unit 110 for receiving an input signal and a clock signal from a clock signal generation unit 120 and for generating a driving signal for an MZ (Mach-Zehnder) modulator 200, a clock signal generation unit 120 for providing a clock signal to the driving signal generation unit 110 and an RZ intensity modulator 300, a CW optical source 115 for generating CW (Continuous Wave) light, a phase shift unit 220 for providing an appropriate phase difference for a pair of optical inputs obtained by branching optical waveguide, an MZ modulator 200 comprising a plurality of modulating electrodes in a first arm and a second arm and terminals for inputting data signals DATA 1 and DATA 2 pre-coded for DQPSK to the electrodes, and a RZ intensity modulator 300 for making the output of the MZ modulator 200 RZ-pulsed. The MZ modulator 200 comprises bias input units 230 and 240 for receiving a bias signal for compensating for a drift of each arm. The RZ intensity modulator 300 comprises a bias input unit 330 for receiving a bias signal for compensating for a drift. The configuration and operation of the driving signal generation unit 110 is described in, for example, Japanese patent publication of translated version No. 2004-516743.

Additionally, the optical transmitting apparatus of the embodiment comprises a 2Vπ-ABC controller 500 for compensating for wavelength fluctuation in the CW optical source 115 and deviation of the operating point (DC drift) in the MZ modulator 200, and a Vπ-ABC controller 600 for compensating for deviation of an operating point (DC drift) in the RZ intensity modulator 300. When the CSRZ modulation is to be performed, the 2Vπ-ABC controller should be comprised instead of the Vπ-ABC controller 600. Details of the configuration and operation of the 2Vπ-ABC controller are, for example, described in Japanese laid-open unexamined patent publication No. 2000-162563.

In the optical transmitting apparatus relating to the embodiment of the present invention, a phase shift unit controller 400 performs bias control (see (1) of FIG. 5) so that the amount of phase shift by the phase shift unit 220 attains an appropriate value (for example, an odd-numbered multiple of π/2, that is an odd-numbered multiple of λ/4 of the optical input). The ABC controllers 500 and 600 compensate for the DC drift by ABC control (see (2), (3) and (4) shown in FIG. 5).

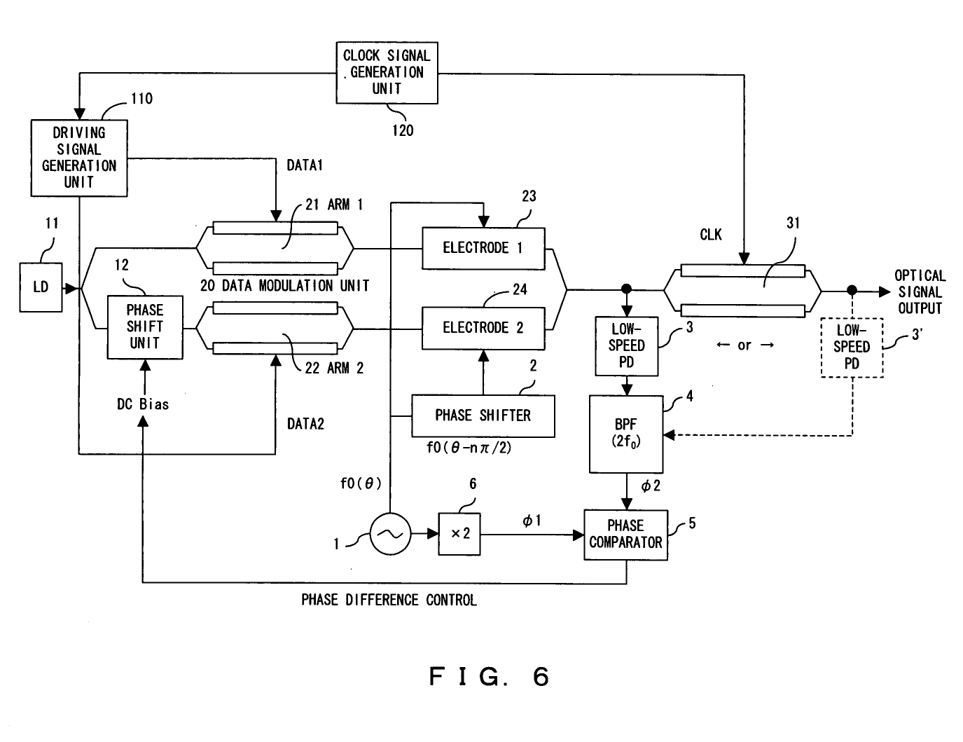

FIG. 6 is a block diagram showing a first configuration of an optical transmitting apparatus relating to the first embodiment of the present invention. The optical transmitting apparatus relating to the present embodiment in FIG. 6 comprises a clock signal generation unit 120; a driving signal generation unit 110 for generating data signals DATA 1 and DATA 2 pre-coded for the DQPSK using a clock signal from the clock signal generation unit 120; a semiconductor laser (LD) 11; a phase modulator comprising a phase shift unit 12 for providing an appropriate phase difference between a pair of optical inputs obtained by branching optical waveguide, a data modulation unit 20 comprising data terminals for respectively inputting the pre-coded data signals DATA 1 and DATA 2 to first arm 21 and second arm 22, and first and second electrodes 23 and 24, provided in later stages of corresponding arms of the data modulation unit 20, for superposing a low-frequency signal; and an intensity modulator 31 for modulating the intensity of the optical output from the phase modulator using the clock signal from the clock signal generation unit 120. The optical transmitting apparatus further comprises a low-frequency superimposing unit, comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 23 and also for providing the low-frequency signal f₀, of which the phase was shifted by nπ/2 by the phase shifter 2, to the second electrode 24; a monitor unit comprising a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀ (one of higher harmonics), a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5). The low-speed photodiode 3 may be replaced by a low-speed photodiode 3′ so as to detect an optical signal from the output side of the intensity modulator 31.

Because the phase shifter 2 is operated at a low frequency, amount of phase shift by the phase shifter 2 may be fixed.

In the optical transmitting apparatus with the above configuration, the semiconductor laser 11 generates optical CW. The optical CW is split into two, one split light is guided to an upper side arm 21 of the data modulation unit 20, and the other split light is guided to a lower side arm 22 via a phase shift unit 12. Here, the amount of phase shift by the phase shift unit 12 is controlled at “nπ/2 (n is a natural number other than 0 and multiples of 4)” by feedback control.

The electrodes 23 and 24 are provided to bias the waveguides connected to the output sides of the arms 21 and 22, respectively. The electrodes 23 and 24 are formed using the X-cut or Z-cut, for example, in consideration of crystal orientation of waveguides. The electrode 23 is provided with the low-frequency signal generated by the low-frequency generator 1 without any modification. On the other hand, the electrode 24 is provided with a low-frequency signal with its phase shifted by “nπ/2 (n is a natural number other than 0 and multiples of 4)” using the phase shifter 2. The low-frequency signal generated by the low-frequency signal generator 1 is a sine curve signal, for example, and its amplitude is so small that a transmitted optical signal does not receive an adverse effect.

Although an optical signal generated by the data modulation unit 20 is guided to the intensity modulator 31, a part of which is split and guided to a low-speed photodiode 3. The optical signal is split by an optical splitter, for example. In the present invention, however, “split (or branch)” of an optical signal is not limited to split by an optical splitter, and it may be realized by guiding optical leakage in Y-coupler to the low-speed photodiode 3. A technology to monitor optical leakage of an MZ modulator is described in Japanese laid-open unexamined patent publication No. 10-228006, for example. When coupling the output side waveguides of the arm 21 and the arm 22 by “X-coupler”, one output of the X-coupler may be guided to the intensity modulator 31 and the other output of the X-coupler may be guided to the low-speed photodiode 3. There is a description about an optical modulator comprising an X-coupler in Japanese laid-open unexamined patent publication No. 2001-244896, for example.

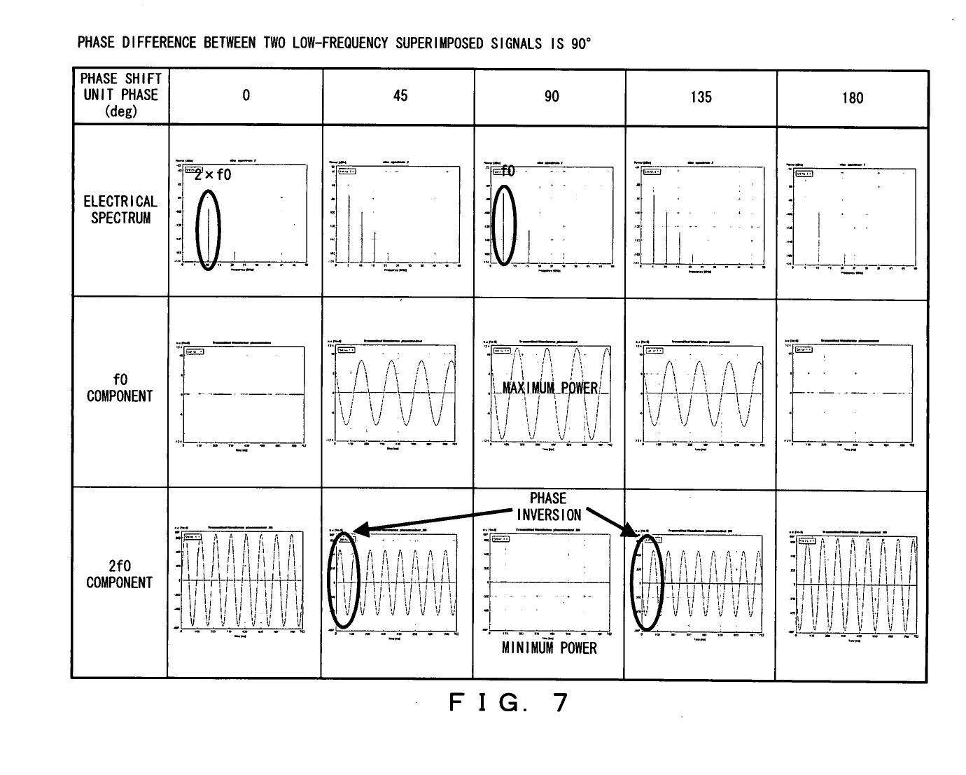

FIG. 7 is a waveform diagram presenting a simulation result of the low-frequency signal component, when n=1 in the phase shifter 2. Here, “n=1” represents that the phase difference between two low-frequency signals provided to the electrodes 23 and 24 in FIG. 6 is π/2.

In this simulation, electric spectrum of the f₀ component and the 2f₀ component are observed by changing the phase shift of the phase shift unit 12 by π/4 in a range between 0°-180°. As a result, when the phase shift of the phase shift unit 12 approaches “90°”, that is “π/2”, the following condition is acquired.

(1) Electric spectrum of the f₀ component is detected prominently

(2) Power reaches its maximum in the f₀ component

(3) Power attains its minimum in the 2f₀ component

The phase of the 2f₀ component signal when the amount of phase shift provided by the phase shift unit 12 is less than “π/2” (45° in FIG. 7), is the inverted from the phase when the amount of phase shit provided by the phase shift unit 12 is greater than “π/2” (135° in FIG. 7).

Therefore, feedback control of bias voltage provided to the phase shift unit 12 so that the power of the f₀ component reaches its maximum enables to maintain the amount of phase shift provided by the phase shift unit 12 at “π/2”. Alternatively, feedback control of bias voltage provided to the phase shift unit 12 so that the power of the 2f₀ component attains minimum enables to maintain the amount of phase shift provided by the phase shift unit 12 at “π/2”. In such feedback control, it is possible to determine whether the bias voltage should be larger or smaller by monitoring the phase of the f₀ component or the 2f₀ component.

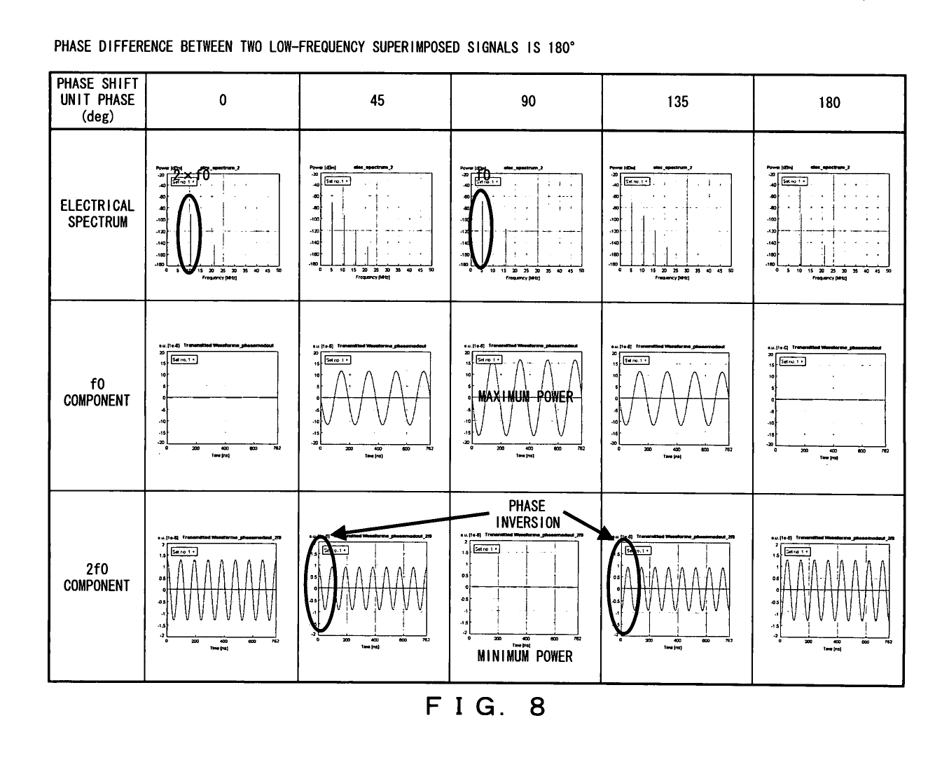

FIG. 8 is a waveform diagram presenting a simulation result of the low-frequency signal component, when n=2 in the phase shifter 2. Here, “n=2” represents that the phase difference between two low-frequency signals provided to the electrodes 23 and 24 in FIG. 6 is π. The simulation result when “n=2” is the same as the result when “n=1”. In other words, the characteristics of the above (1)-(3) are also obtained when n=2. The phase of the 2f₀ component when the phase of the phase shift unit 12 is 45° is inverted from the phase of the 2f₀ component when the phase of the phase shift unit 12 is 135°.

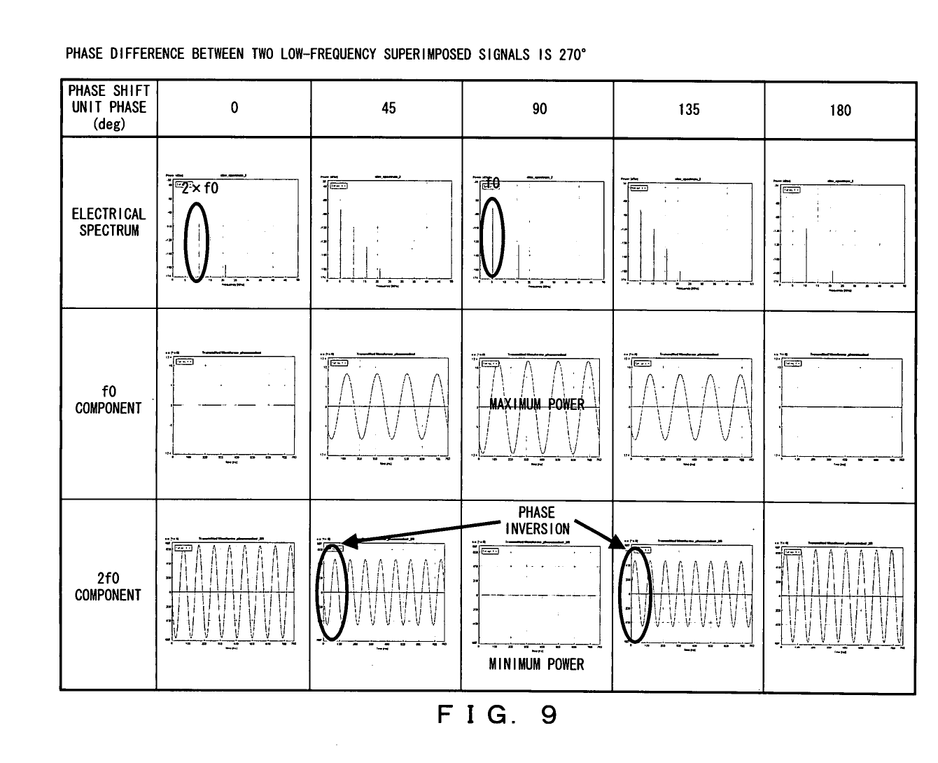

FIG. 9 is a waveform diagram presenting a simulation result of the low-frequency signal component, when n=3 in the phase shifter 2. Here, “n=3” represents that the phase difference between two low-frequency signals provided to the electrodes 23 and 24 in FIG. 6 is 3π/2. The simulation result when “n=3” is the same as the result when “n=1 and 2”. In other words, the characteristics of the above (1)-(3) are also obtained when n=3. The phase of the 2f₀ component when the phase of the phase shift unit 12 is 45° is inverted from the phase of the 2f₀ component when the phase of the phase shift unit 12 is 135°. When n is a natural number of 5 or above (except for multiples of 4), the results are the same as the results when n=1, 2 or 3.

In simulations shown in FIG. 6 through FIG. 9, the electric spectrum can be obtained as output of the low-speed photodiode 3. That is to say, the f₀ component is an f₀ component comprised in the output of the low-speed photodiode 3. In addition, the 2f₀ component is a 2f₀ component comprised in the output of the low-speed photodiode 3.

In such a manner, the optical transmitting apparatus shown in FIG. 6 is controlled so that the phase difference between the low-frequency signal provided to one electrode and the low-frequency signal provided to another electrode is nπ/2 (n is a natural number other than 0 and multiples of 4) or approximately nπ/2, when superimposing the low-frequency signal on the modulated optical signal via the electrodes 23 and 24. Additionally the 2f₀ component, comprised in the output optical signal is extracted by the synchronous detection using the low-speed photodiode 3, the band-pass filter 4 and the phase comparator 5 etc. The phase shift of the phase shift unit 12 is maintained at an appropriate value (for example, an odd-numbered multiples of π/2) by controlling the phase shift unit 12 with the feedback control so that the power of the 2f₀ component attains the minimum. By so doing, the quality of the output optical signal can be stabilized.

In the above embodiment, a frequency component, in which the frequency f₀ of the low-frequency signal was doubled, is monitored; however, the present invention is not limited to this frequency component. In other words, it is possible that, in the present invention, the feedback control can be performed using an nth harmonics (n is a natural number 2 or above) to be superposed on the modulated optical signal.

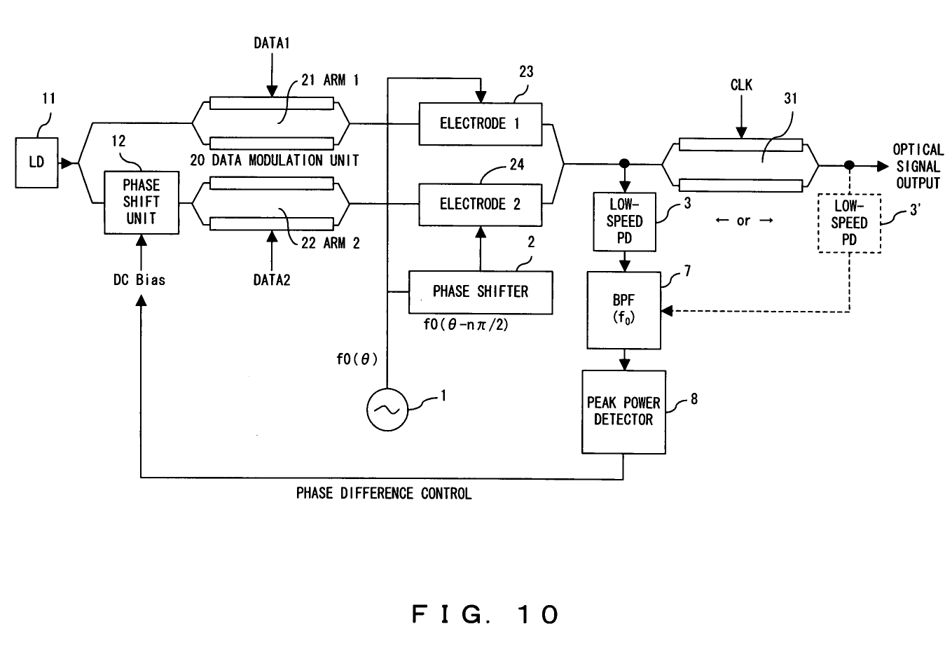

FIG. 10 is an overview block diagram describing a second configuration of an optical transmitting apparatus relating to the first embodiment of the present invention. In FIG. 10, the illustration of the driving signal generator unit 110 and the clock signal generator unit 120 shown in FIG. 6 is omitted.

The optical transmitting apparatus shown in FIG. 6 performs feedback control by monitoring power of a doubled component (2f₀) of the frequency of the low-frequency signal. On the other hand, the optical transmitting apparatus shown in FIG. 10 performs the feedback control by monitoring peak power of the frequency f₀ of the low-frequency signal. Therefore, the optical transmitting apparatus comprises a BPF 7, which passed the frequency component f₀, and a peak power detector 8 for detecting peak power of the output of the BPF7. The other configuration of the optical transmitting apparatus shown in FIG. 10 is basically the same as the optical transmitting apparatus shown in FIG. 6.

The optical transmitting apparatus shown in FIG. 10 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, a data modulation unit 20 comprising data terminals for respectively inputting the pre-coded data signals DATA 1 and DATA 2 to first arm 21 and second arm 22, and first and second electrodes 23 and 24, provided in later stages of corresponding arms of the data modulation unit 20, for superposing a low-frequency signal; and an intensity modulator 31 for modulating the intensity of the optical output from the phase modulator using the clock signal from the clock signal generation unit. The optical transmitting apparatus further comprises a low-frequency superimposing unit, comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 23 and also for providing the low-frequency signal f₀, of which the phase was shifted by nπ/2 by the phase shifter 2, to the second electrode 24; a monitor unit comprising a low-speed photodiode 3 for extracting a low-frequency signal from optical output of the phase modulator, which has waveguide to split optical beam into two for generating two optical signals and to couple the two optical signals, a band-pass filter BPF 7 with its center frequency of f₀, and a peak power detector 8 for detecting peak power of the output of the band-pass filter BPF 7. In addition, a phase difference control unit, not shown in figures, for controlling the amount of phase shift of the phase shift unit 12 according to the output of the monitor unit (the peak power detector 8).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

The simulation results of the optical power of the frequency f₀ contained in the modulated optical signal are the same as shown in FIG. 7 through FIG. 9. In other words, the peak power of the frequency f₀ becomes greater as the amount of phase shift by the phase shift unit 12 approaches to “π/2”.

In such a manner, the optical transmitting apparatus shown in FIG. 6 is controlled so that the phase difference between the low-frequency signal provided to one electrode and the low-frequency signal provided to another electrode is nπ/2 (n is a natural number other than 0 and multiples of 4) or approximately nπ/2, when superimposing the low-frequency signal on the modulated optical signal via the electrodes 23 and 24. Additionally the peak power of the f₀ component, comprised in the output optical signal, is detected using the low-speed photodiode 3, the band-pass filter 7 and the peak power detector 8. The phase shift of the phase shift unit 12 is maintained at an appropriate value (for example, an odd-numbered multiple of π/2) by controlling the phase shift unit 12 with the feedback control so that the peak power of the f₀ component reaches the maximum. By so doing, the quality of the output optical signal can be stabilized.

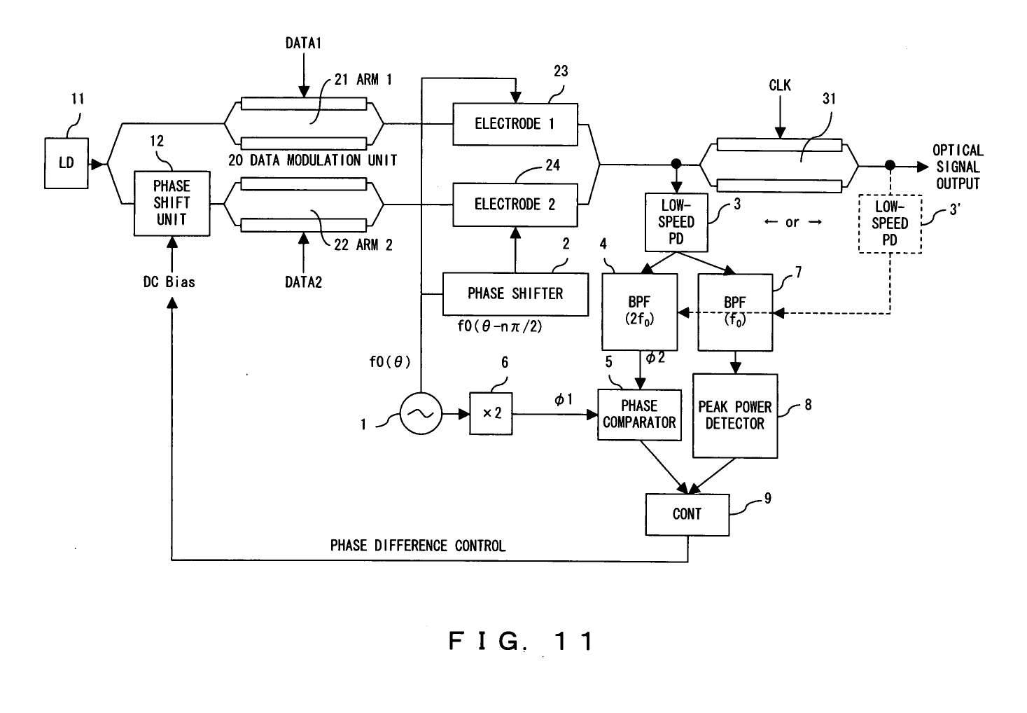

FIG. 11 is an overview block diagram describing a third configuration of an optical transmitting apparatus relating to the first embodiment of the present invention. In FIG. 11, the illustration of the driving signal generator unit 110 and the clock signal generator unit 120 shown in FIG. 6 is omitted.

The optical transmitting apparatus shown in FIG. 11 comprises both a control function shown in FIG. 6 (a configuration for generating bias voltage using 2f₀ component) and a control function shown in FIG. 10 (a configuration for generating bias voltage using f₀ component). A controller (cont) 9 controls the amount of phases shift in the phase shift unit 12 by adjusting the bias voltage according to both control functions (for example, an average value). It is also possible that the controller 9 controls the amount of phase shift according to either one of the control functions.

The optical transmitting apparatus shown in FIG. 11 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, a data modulation unit 20 comprising data terminals for respectively inputting the pre-coded data signals DATA 1 and DATA 2 to first arm 21 and second arm 22, and first and second electrodes 23 and 24, provided in later stages of corresponding arms of the data modulation unit 20, for superposing a low-frequency signal; an intensity modulator 31 for modulating the intensity of the optical output from the phase modulator using the clock signal from the clock signal generation unit; and a low-frequency superimposing unit, comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 23 and also for providing the low-frequency signal f₀, of which the phase was shifted by nπ/2 by the phase shifter 2, to the second electrode 24. The optical transmitting apparatus further comprises a first monitor unit comprising a low-speed photodiode 3 for extracting a low-frequency signal from optical output of the phase modulator, which has waveguide to split optical beam into two for generating two optical signals and to couple the optical two signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4; a second monitor unit comprising the low-speed photodiode 3, a band-pass filter BPF 7 with its pass frequency of f₀, and a peak power detector 8 for detecting peak power of the signal output from the band-pass filter BPF 7, and a controller CONT 9 for monitoring output of the first monitor means (the phase comparator 5), and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example) and for monitoring the power variation of the second monitor means (the peak power detector 8), and for carrying out bias control on the phase shift unit 12 so that the power reaches its peak.

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

The simulation results of the optical power of the frequency f₀ contained in the modulated optical signal are the same as shown in FIG. 7 through FIG. 9. In other words, as the amount of phase shift by the phase shift unit 12 approaches to “π/2”, the peak power of the frequency f₀ becomes greater, and the power of the frequency 2f₀ becomes smaller.

In such a manner, in the optical transmitting apparatus shown in FIG. 11, the amount of phase shift by the phase shift unit 12 is controlled by using both the f₀ component and the 2f₀ component contained in the modulated optical signal, and therefore the amount of phase shift by the phase shift unit 12 is maintained at an appropriate value (for example, an odd-numbered multiples of π/2) with a high degree of accuracy. By so doing, the quality of the output optical signal can be further stabilized.

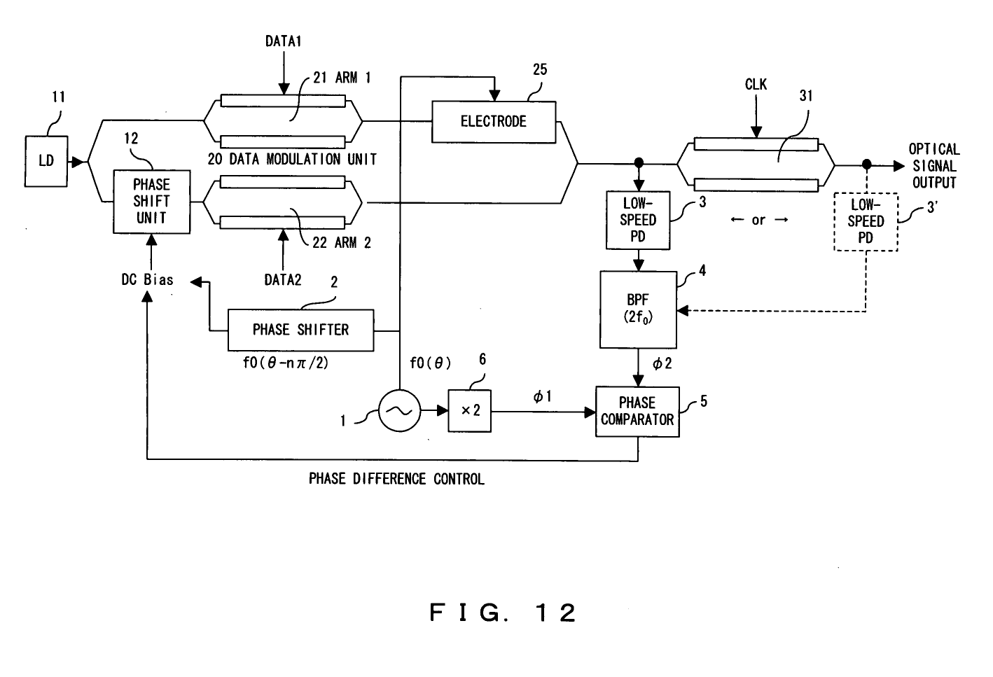

FIG. 12 is an overview block diagram describing a fourth configuration of an optical transmitting apparatus relating to the first embodiment of the present invention. In FIG. 12, the illustration of the driving signal generator unit 110 and the clock signal generator unit 120 shown in FIG. 6 is omitted.

In the optical transmitting apparatus shown in FIG. 12, a low-frequency signal f₀ is provided to an electrode 25. By so doing, the low-frequency signal f₀ is superimposed on the optical signal output from the arm 21 of a data modulation unit 20. A signal acquired by shifting the phase of the low-frequency signal f₀ by nπ/2 (where n is a natural number other than 0 and multiples of 4) using the phase shifter 2 is superimposed on bias voltage (DC Bias) for controlling the phase shift unit 12. The other configuration of the optical transmitting apparatus shown in FIG. 12 is basically the same as that of the optical transmitting apparatus shown in FIG. 6.

The optical transmitting apparatus shown in FIG. 12 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, a data modulation unit 20 comprising data terminals for respectively inputting the pre-coded data signals DATA 1 and DATA 2 to first arm 21 and second arm 22, and an electrodes 25, provided in later stage of the arm 21 of the data modulation unit 20, for superposing a low-frequency signal; and an intensity modulator 31 for modulating the intensity of the optical output from the phase modulator using the clock signal from the clock signal generation unit. The optical transmitting apparatus further comprises a low-frequency superimposing unit, comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the electrode 25 and also for providing the low-frequency signal f₀, of which the phase was shifted by nπ/2 by the phase shifter 2, to the bias input unit of the phase shift unit 12; and a monitor unit comprising a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example). In addition, The optical transmitting apparatus further comprises a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

The optical transmitting apparatus shown in FIG. 12 has a difference from the optical transmitting apparatus shown in FIG. 6 in the position where the low-frequency signal is applied. However, the same characteristics as shown in FIG. 7 through FIG. 9 are also acquired from the configuration shown in FIG. 12. That is, as the amount of phase shift by the phase shift unit 12 approaches to nπ/2 (where n is a natural number other 0 and than multiples of 4), the 2f₀ component becomes smaller.

Therefore, in the optical transmitting apparatus shown in FIG. 12, the phase shift of the phase shift unit 12 can be maintained at an appropriate value (for example, an odd-numbered multiple of π/2) by controlling the phase shift unit 12 by the feedback control so that the power of the 2f₀ component attains the minimum. By such a feedback control, the quality of the output optical signal can be stabilized.

In the optical transmitting apparatus of the first embodiment, the feedback control may be performed by using the f₀ component in the configuration shown in FIG. 12, or the feedback control may be performed by using both of the f₀ component and the 2f₀ component.

### Second Embodiment

The optical transmitting apparatus of the first embodiment comprises the phase shift unit 12 at the former stage of the data modulation unit 20. On the contrary, the optical transmitting apparatus of the second embodiment a phase shift unit 13 is configured in the later stage of a data modulation unit 40. By so doing, the amplitudes of the f₀ component and the 2f₀ component shown in FIG. 7 through FIG. 9 become larger, compared with the first embodiment. Therefore, in the second embodiment, compared with the first embodiment, detection of the f₀ component and the 2f₀ component is more facilitated, and control accuracy of the amount of phase shift is improved.

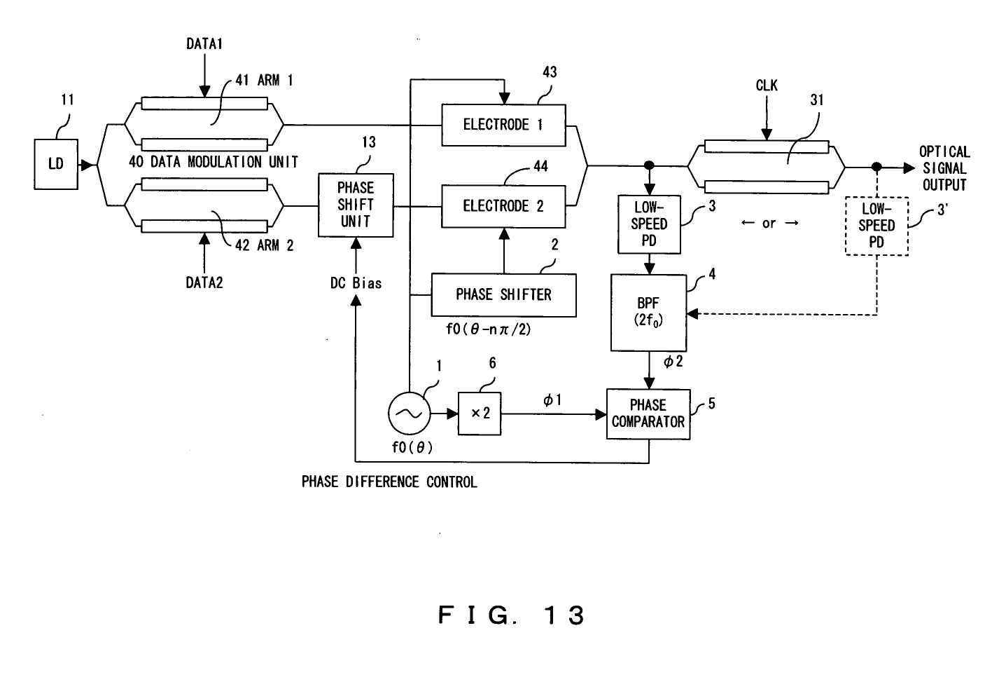

FIG. 13 is an overview block diagram describing a first configuration of an optical transmitting apparatus relating to the second embodiment of the present invention. The configuration of the optical transmitting apparatus shown in FIG. 13 is basically the same as that of the optical transmitting apparatus shown in FIG. 6. However, in the optical transmitting apparatus shown in FIG. 13, the phase shift unit 13 is configured in a later stage of the data modulation unit 40. In FIG. 13, the illustration of the driving signal generator unit 110 and the clock signal generator unit 120 shown in FIG. 6 is omitted.

The optical transmitting apparatus shown in FIG. 13 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a data modulation unit 40 comprising data terminals for respectively inputting the pre-coded data signals DATA 1 and DATA 2 to first arm 41 and second arm 42, a phase shift unit 13 for providing an appropriate phase difference between a pair of optical inputs obtained by branching optical waveguide, and first and second electrodes 43 and 44, provided respectively in later stages of the arm 42 of the data modulation unit 40 and the phase shift unit 13 for superposing a low-frequency signal; and an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 43 and also for providing the low-frequency signal f₀, of which the phase was shifted by nπ/2 by the phase shifter 2, to the second electrode 44. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 13, the characteristics of the f₀ component and the 2f₀ component presented in FIG. 7 through FIG. 9 are also acquired. However, the optical transmitting apparatus configures the phase shift unit 13 in the later stage of the data modulation unit 40, the amplitudes of the f₀ component and the 2f₀ component become large, as explained above.

Consequently, in the optical transmitting apparatus shown in FIG. 13, the phase shift of the phase shift unit 13 can be maintained at an appropriate value (for example, an odd-numbered multiple of π/2) by controlling the phase shift unit 13 with feedback control so that the power of the 2f₀ component attains the minimum.

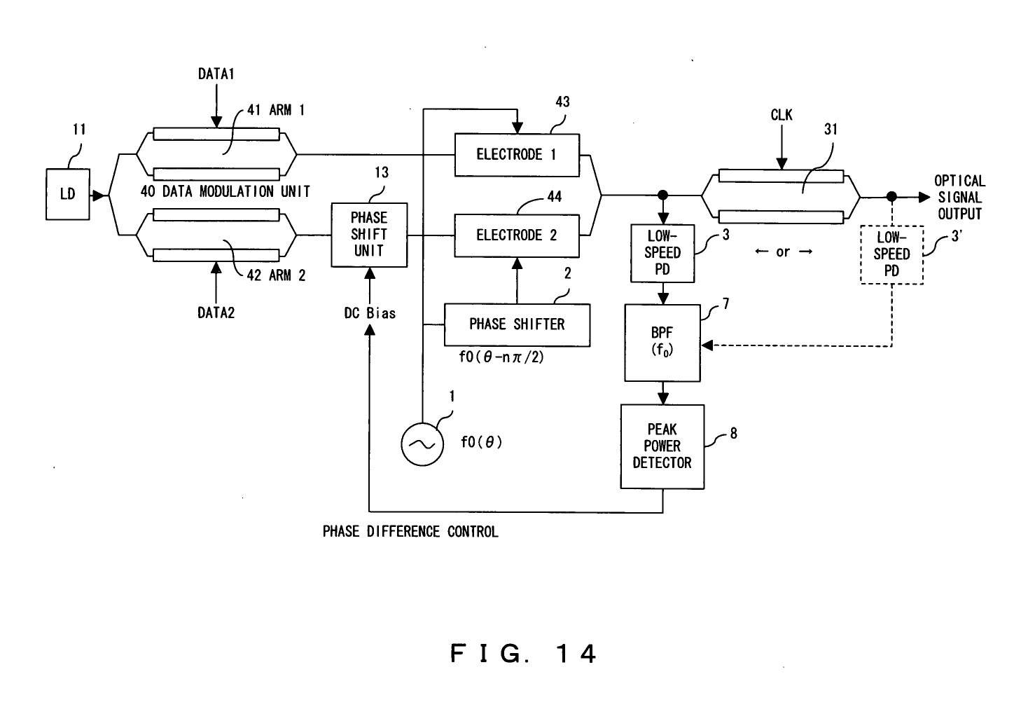

FIG. 14 is an overview block diagram describing a second configuration of an optical transmitting apparatus relating to the second embodiment of the present invention. The configuration of the optical transmitting apparatus shown in FIG. 14 is basically the same as that of the optical transmitting apparatus shown in FIG. 10. However, in the optical transmitting apparatus shown in FIG. 14, the phase shift unit 13 is configured in a later stage of the data modulation unit 40. In FIG. 14, the illustration of the driving signal generator unit 110 and the clock signal generator unit 120 shown in FIG. 6 is omitted.

The optical transmitting apparatus shown in FIG. 14 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a data modulation unit 40 comprising data terminals for respectively inputting the pre-coded data signals DATA 1 and DATA 2 to first arm 41 and second arm 42, a phase shift unit 13 for providing an appropriate phase difference between a pair of optical inputs obtained by branching optical waveguide, and first and second electrodes 43 and 44, provided respectively in later stages of the arm 42 of the data modulation unit 40 and the phase shift unit 13 for superposing a low-frequency signal; and an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 43 and also for providing the low-frequency signal f₀, of which the phase was shifted by nπ/2 by the phase shifter 2, to the second electrode 44. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 7 with its center frequency of f₀, and a peak power detector 8 for detecting peak power of the output of the band-pass filter BPF 7. In addition, a phase difference control unit, not shown in figures, for controlling the amount of phase shift of the phase shift unit 12 according to the output of the monitor unit (the peak power detector 8).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 14, the characteristics of the f₀ component and the 2f₀ component presented in FIG. 7 through FIG. 9 are also acquired. Consequently, in the optical transmitting apparatus shown in FIG. 14, the phase shift of the phase shift unit 13 can be maintained at an appropriate value (for example, an odd-numbered multiple of π/2) by controlling the phase shift unit 13 with feedback control so that the power of the f₀ component attains the maximum.

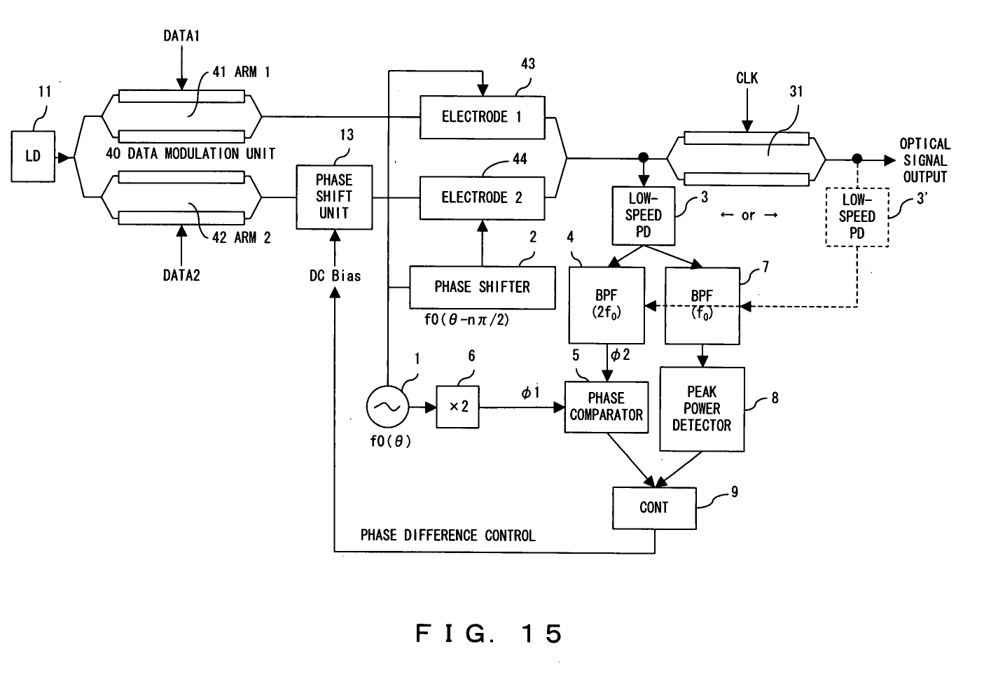

FIG. 15 is an overview block diagram describing a third configuration of an optical transmitting apparatus relating to the second embodiment of the present invention. The configuration of the optical transmitting apparatus shown in FIG. 15 is basically the same as that of the optical transmitting apparatus shown in FIG. 11. However, in the optical transmitting apparatus shown in FIG. 15, the phase shift unit 13 is configured in a later stage of the data modulation unit 40. In FIG. 15, the illustration of the driving signal generator unit 110 and the clock signal generator unit 120 shown in FIG. 6 is omitted.

The optical transmitting apparatus shown in FIG. 15 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a data modulation unit 40 comprising data terminals for respectively inputting the pre-coded data signals DATA 1 and DATA 2 to first arm 41 and second arm 42, a phase shift unit 13 for providing an appropriate phase difference between a pair of optical inputs obtained by branching optical waveguide, and first and second electrodes 43 and 44, provided respectively in later stages of the arm 42 of the data modulation unit 40 and the phase shift unit 13 for superposing a low-frequency signal; and an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 43 and also for providing the low-frequency signal f₀, of which the phase was shifted by nπ/2 by the phase shifter 2, to the second electrode 44. The optical transmitting apparatus further comprises a first monitor unit comprising a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4; a second monitor unit comprising the low-speed photodiode 3, a band-pass filter BPF 7 with its pass frequency of f₀, and a peak power detector 8 for detecting peak power of the signal output from the band-pass filter BPF 7, and a controller CONT 9 for monitoring output of the first monitor means (the phase comparator 5), and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example) and for monitoring the power variation of the second monitor means (the peak power detector 8), and for carrying out bias control on the phase shift unit 12 so that the power reaches its peak.

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 15, the characteristics of the f₀ component and the 2f₀ component presented in FIG. 7 through FIG. 9 are also acquired. Consequently, in this optical transmitting apparatus also, the phase shift of the phase shift unit 13 can be maintained at an appropriate value (for example, an odd-numbered multiple of π/2) by controlling the phase shift unit 13 with feedback control so that the power of the 2f₀ component attains the minimum and the power of the f₀ component reaches the maximum.

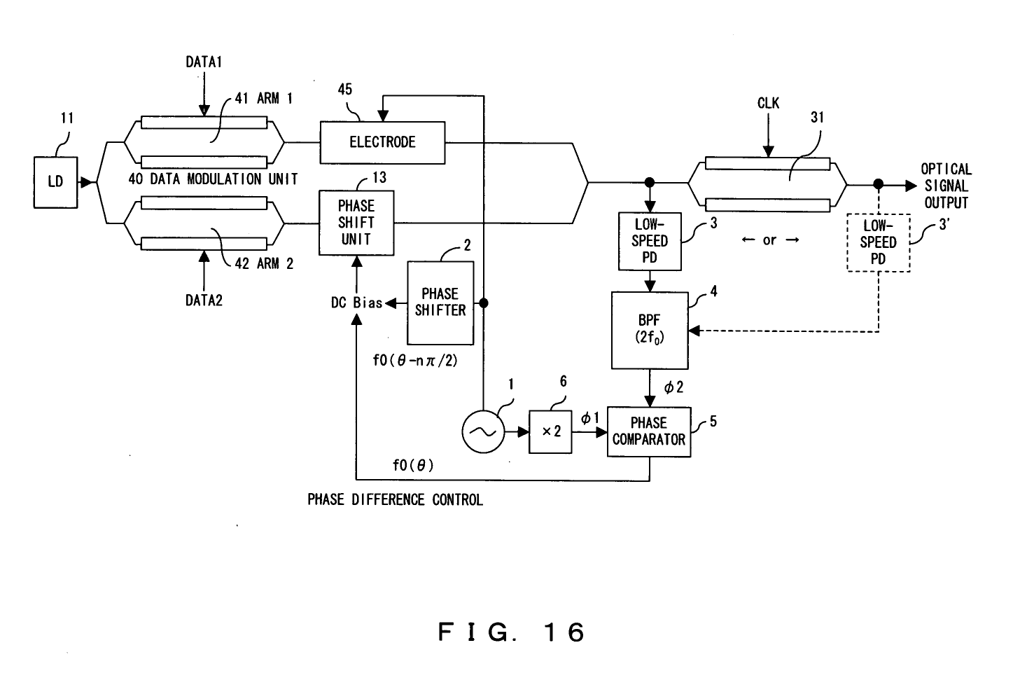

FIG. 16 is an overview block diagram describing a fourth configuration of an optical transmitting apparatus relating to the second embodiment of the present invention. The configuration of the optical transmitting apparatus shown in FIG. 16 is basically the same as that of the optical transmitting apparatus shown in FIG. 12. However, in the optical transmitting apparatus shown in FIG. 13, the phase shift unit 13 is configured in the later stage of the data modulation unit 40. In FIG. 16, the illustration of the driving signal generator unit 110 and the clock signal generator unit 120 shown in FIG. 6 is omitted.

The optical transmitting apparatus shown in FIG. 16 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a data modulation unit 40 comprising data terminals for respectively inputting the pre-coded data signals DATA 1 and DATA 2 to first arm 41 and second arm 42, a phase shift unit 13 for providing an appropriate phase difference between a pair of optical inputs obtained by branching optical waveguide, and an electrode 45, provided in later stage of the arm 41 of the data modulation unit 40 for superposing a low-frequency signal; and an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the electrode 45 and also for providing the low-frequency signal f₀, of which the phase was shifted by nπ/2 by the phase shifter 2, to the phase shift unit 13. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 16, like the other optical transmitting apparatus, the characteristics of the f₀ component and the 2f₀ component presented in FIG. 7 through FIG. 9 are also acquired. Consequently, in this optical transmitting apparatus also, it is possible to maintain the phase shift of the phase shift unit 13 at an appropriate value (for example, an odd-numbered multiple of π/2) by controlling the phase shift unit 13 with feedback control so that the power of the 2f₀ component attains the minimum.

In the optical transmitting apparatus of the second embodiment, the feedback control may be performed by using the f₀ component in the configuration shown in FIG. 16, or the feedback control may be performed by using both of the f₀ component and the 2f₀ component.

### Third Embodiment

In the optical transmitting apparatus of the third embodiment, a low-frequency signal is superimposed on an optical signal in an MZ modulator performing data modulation. In this configuration, the characteristics of the f₀ component and the 2f₀ component presented in FIG. 7 through FIG. 9 are also acquired. In the following description, a configuration for performing the feedback control by using the 2f₀ component is presented; however in the third embodiment, the feedback control may be performed by using the f₀ component, or the feedback control may be performed by using both of the f₀ component and the 2f₀ component.

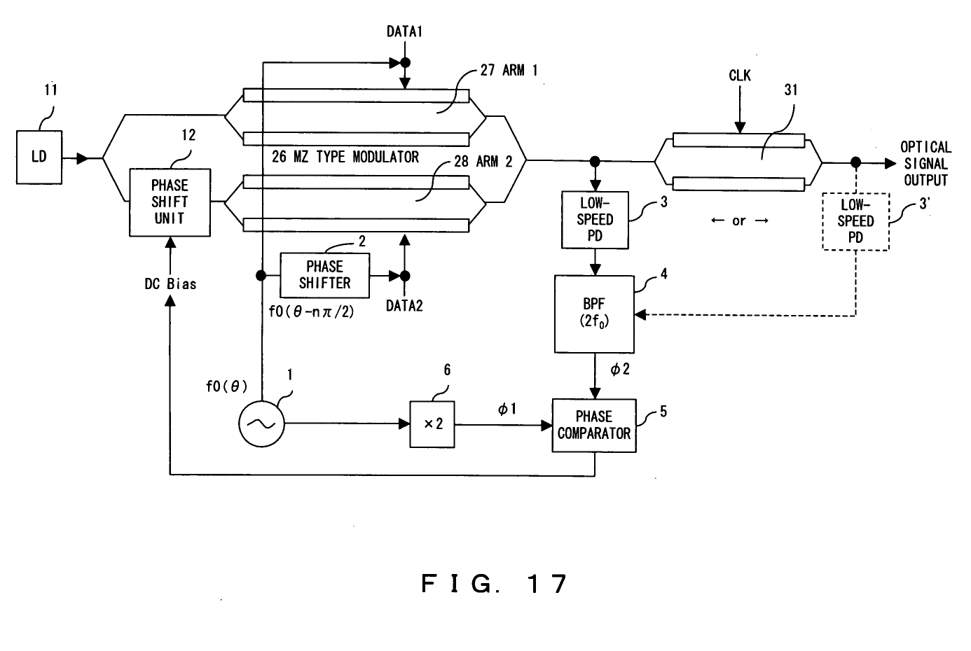

FIG. 17 is an overview block diagram describing a first configuration of an optical transmitting apparatus relating to the third embodiment of the present invention. In this optical transmitting apparatus, the low-frequency signal is superimposed on each of the data DATA 1 and the data DATA 2. In FIG. 17, the illustration of the driving signal generator unit 110 and the clock signal generator unit 120 shown in FIG. 6 is omitted.

The optical transmitting apparatus shown in FIG. 17 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide and a MZ (Mach-Zehnder) modulator 26 comprising data terminals for respectively inputting the pre-coded data signals DATA 1 and DATA 2 to first arm 27 and second arm 28; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to an input terminal for the data signal DATA 1 of the first arm 27 and also for providing the low-frequency signal f₀, of which the phase was shifted by nπ/2 by the phase shifter 2, to an input terminal for the data signal DATA 2 of the second arm 28. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 17, the characteristics of the f₀ component and the 2f₀ component presented in FIG. 7 through FIG. 9 are also acquired. Consequently, in this optical transmitting apparatus as well, the phase shift of the phase shift unit 12 can be maintained at an appropriate value (for example, an odd-numbered multiple of π/2) by controlling the phase shift unit 12 with feedback control so that the power of the 2f₀ component attains the minimum.

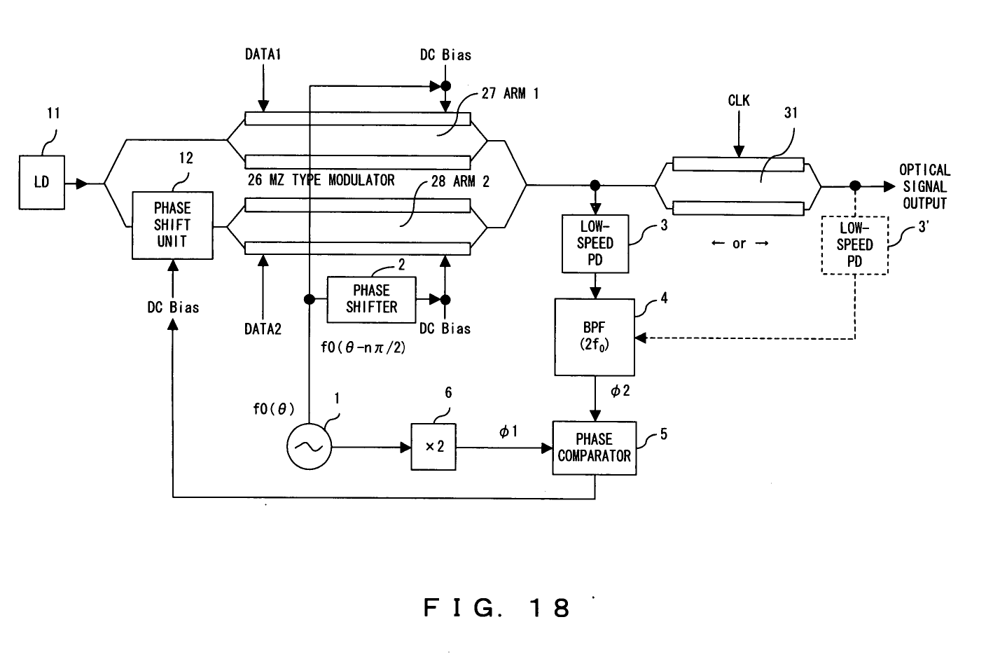

FIG. 18 is an overview block diagram describing a second configuration of an optical transmitting apparatus relating to the third embodiment of the present invention. The configuration of the optical transmitting apparatus shown in FIG. 18 is basically the same as that of the optical transmitting apparatus shown in FIG. 17. However, in the optical transmitting apparatus shown in FIG. 18, the low-frequency signal is superimposed on a DC bias signal of the MZ modulator. In FIG. 18, the illustration of the driving signal generator unit 110 and the clock signal generator unit 120 shown in FIG. 6 is omitted.

The optical transmitting apparatus shown in FIG. 18 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide and a MZ (Mach-Zehnder) modulator 26 comprising data terminals for inputting the pre-coded data signals DATA 1 and DATA 2 and bias terminals through which low-frequency signals with different phase being input to first arm 27 and second arm 28, respectively; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the bias terminal of the first arm 27 and also for providing the low-frequency signal f₀, of which the phase was shifted by nπ/2 by the phase shifter 2, to the bias terminal of the second arm 28. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 18, the characteristics of the f₀ component and the 2f₀ component presented in FIG. 7 through FIG. 9 are also acquired. Consequently, in this optical transmitting apparatus, the phase shift of the phase shift unit 12 can be also maintained at an appropriate value (for example, an odd-numbered multiple of π/2) by controlling the phase shift unit 12 with feedback control so that the power of the 2f₀ component attains the minimum.

### Fourth Embodiment

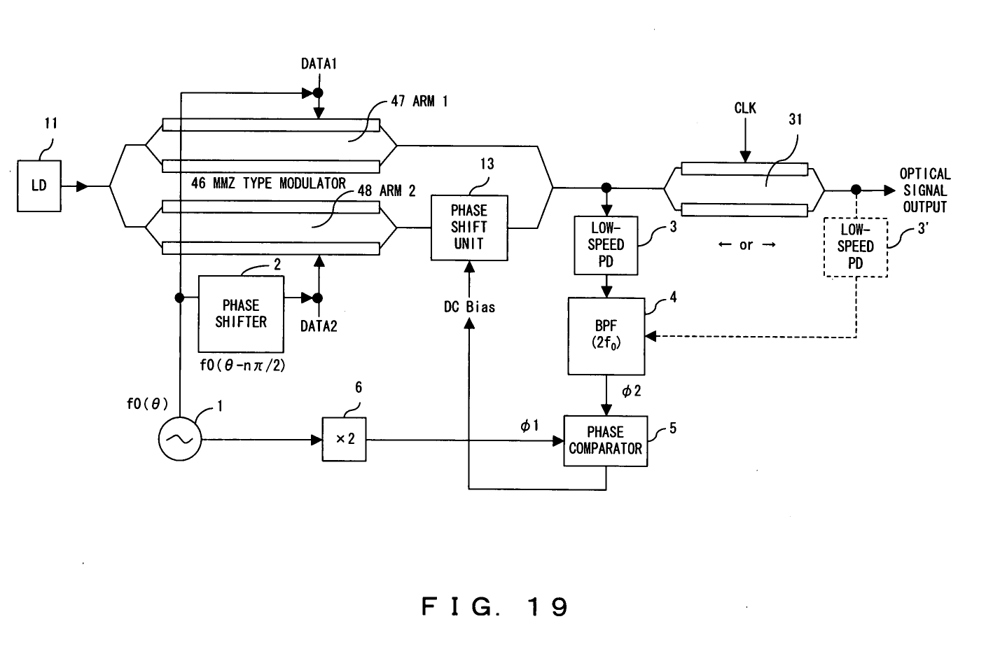

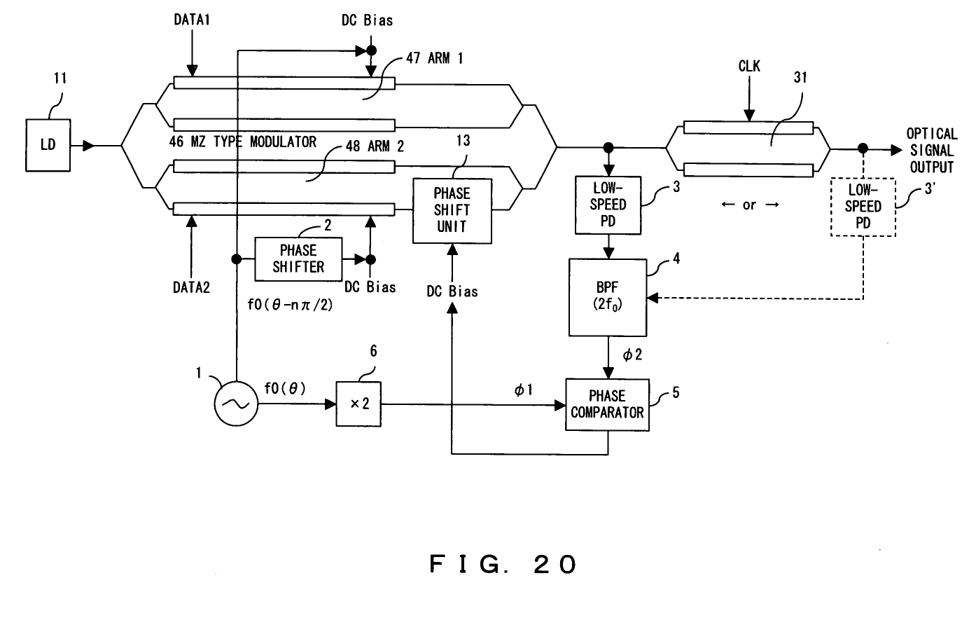

The fourth configuration of the optical transmitting apparatus is basically the same as that of the optical transmitting apparatus of the third embodiment. However, in the configuration of the optical transmitting apparatus of the fourth embodiment, the phase shift unit 13 is configured in the later stage of the MZ modulator (the data modulation unit). In FIG. 19 and FIG. 20 describing the fourth embodiment, the illustration of the driving signal generator unit 110 and the clock signal generator unit 120 shown in FIG. 6 is omitted.

FIG. 19 is an overview block diagram describing a first configuration of an optical transmitting apparatus relating to the fourth embodiment of the present invention. The optical transmitting apparatus shown in FIG. 19 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a MZ (Mach-Zehnder) modulator 46 comprising data terminals for respectively inputting the pre-coded data signals DATA 1 and DATA 2 to first arm 47 and second arm 48 and a phase shift unit 13 for providing an appropriate phase difference between a pair of optical inputs obtained by branching optical waveguide; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the data terminal for the data signal DATA 1 of the first arm 47 and also for providing the low-frequency signal f₀, of which the phase was shifted by nπ/2 by the phase shifter 2, to the data terminal for the data signal DATA 2 of the second arm 48. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 19, the characteristics of the f₀ component and the 2f₀ component presented in FIG. 7 through FIG. 9 are also acquired. Consequently, in this optical transmitting apparatus, the phase shift of the phase shift unit 13 can be maintained at an appropriate value (for example, an odd-numbered multiple of π/2) by controlling the phase shift unit 13 with feedback control so that the power of the 2f₀ component attains the minimum.

FIG. 20 is an overview block diagram describing a second configuration of an optical transmitting apparatus relating to the fourth embodiment of the present invention. The optical transmitting apparatus shown in FIG. 20 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a MZ (Mach-Zehnder) modulator 46 comprising data terminals for inputting the pre-coded data signals DATA 1 and DATA 2 and bias terminals through which low-frequency signals with different phase being input to first arm 47 and second arm 48, respectively and a phase shift unit 13 for providing an appropriate phase difference between a pair of optical inputs obtained by branching optical waveguide; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the bias terminal of the first arm 47 and also for providing the low-frequency signal f₀, of which the phase was shifted by nπ/2 by the phase shifter 2, to the bias terminal of the second arm 48. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 20, the characteristics of the f₀ component and the 2f₀ component presented in FIG. 7 through FIG. 9 are also acquired. Consequently, in this optical transmitting apparatus, the phase shift of the phase shift unit 13 can be maintained at an appropriate value (for example, an odd-numbered multiple of π/2) by controlling the phase shift unit 13 with feedback control so that the power of the 2f₀ component attains the minimum.

In the fourth embodiment also, the feedback control may be performed by using the f₀ component, or the feedback control may be performed by using both of the f₀ component and the 2f₀ component.

### Fifth Embodiment

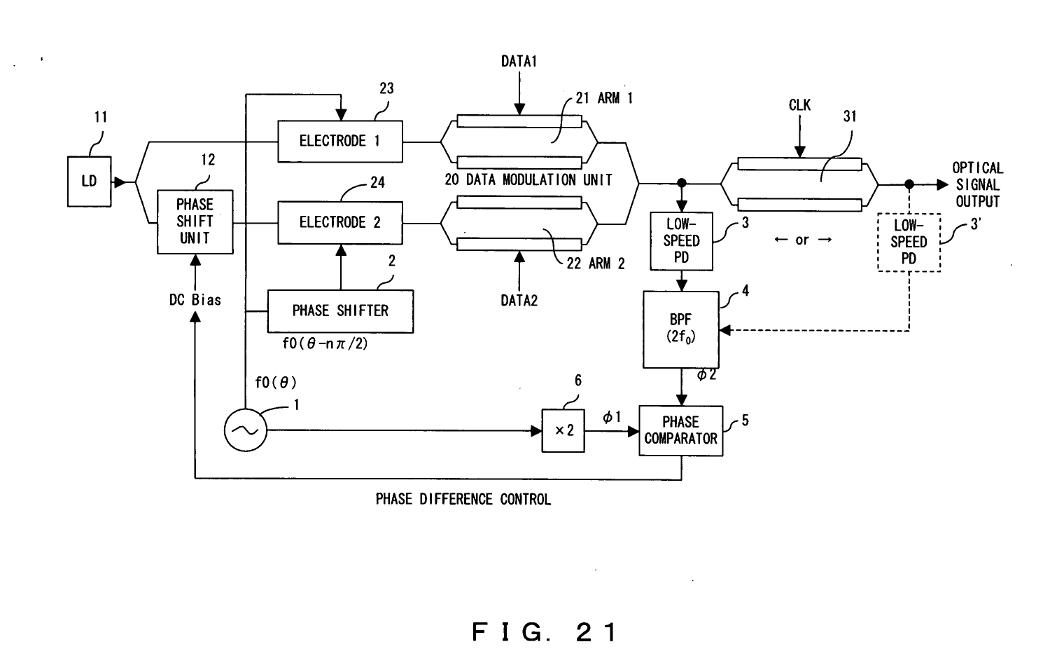

In the optical transmitting apparatus of the fifth embodiment, electrodes for superimposing a low-frequency signal on an optical signal is configured in the former stage of a data modulation unit and a phase shift unit is configured in the former stage of the electrodes. In FIG. 21 describing the fifth embodiment, the illustration of the driving signal generator unit 110 and the clock signal generator unit 120 shown in FIG. 6 is omitted.

FIG. 21 is an overview block diagram describing a configuration of an optical transmitting apparatus relating to the fifth embodiment of the present invention. The optical transmitting apparatus shown in FIG. 21 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, first and second electrodes 23 and 24, provided in former stages of corresponding arms of a data modulation unit 20, for superposing a low-frequency signals, and the data modulation unit 20 comprising data terminals for respectively inputting the pre-coded data signals DATA 1 and DATA 2 to first arm 21 and second arm 22; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 23 and also for providing the low-frequency signal f₀, of which the phase was shifted by nπ/2 by the phase shifter 2, to the second electrode 24. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 21, the characteristics of the f₀ component and the 2f₀ component presented in FIG. 7 through FIG. 9 are also acquired. Consequently, in this optical transmitting apparatus, the phase shift of the phase shift unit 12 can be maintained at an appropriate value (for example, an odd-numbered multiple of π/2) by controlling the phase shift unit 12 with feedback control so that the power of the 2f₀ component attains the minimum.

In the fifth embodiment also, the feedback control may be performed by using the f₀ component, or the feedback control may be performed by using both of the f₀ component and the 2f₀ component.

### Sixth Embodiment

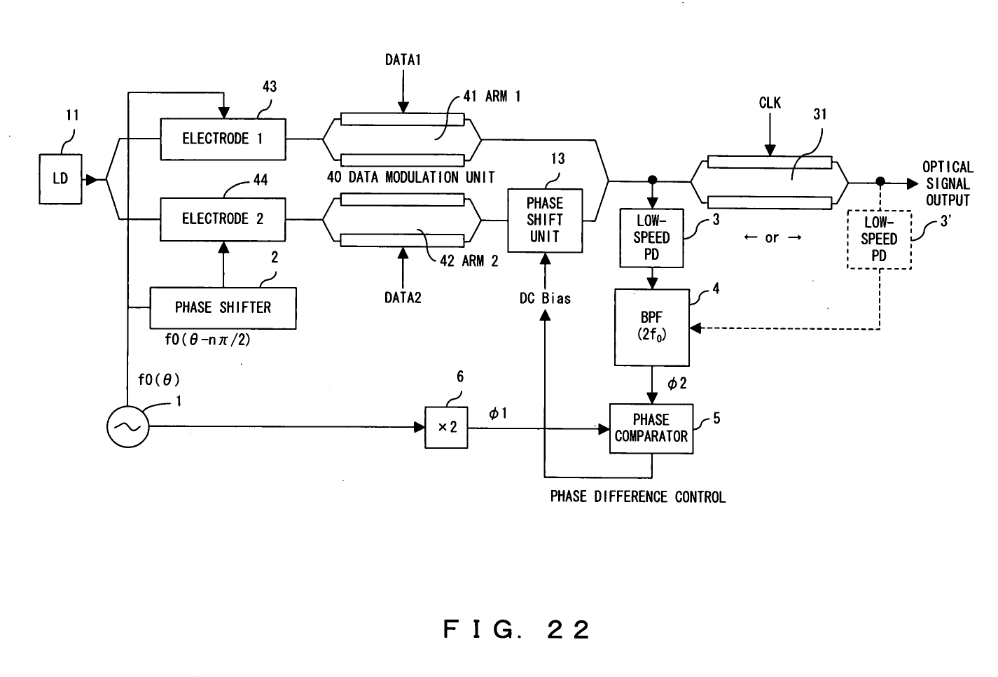

In the optical transmitting apparatus of the sixth embodiment, the electrodes for superimposing a low-frequency signal on an optical signal is configured in the former stage of the data modulation unit, and a phase shift unit is configured in the later stage of the data modulation unit. In FIG. 22 describing the sixth embodiment, the illustration of the driving signal generator unit 110 and the clock signal generator unit 120 shown in FIG. 6 is omitted.

FIG. 22 is an overview block diagram describing a configuration of an optical transmitting apparatus relating to the sixth embodiment of the present invention. The optical transmitting apparatus shown in FIG. 22 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising first and second electrodes 43 and 44, provided in former stages of corresponding arms of a data modulation unit 40, for superposing a low-frequency signals, the data modulation unit 40 comprising data terminals for respectively inputting the pre-coded data signals DATA 1 and DATA 2 to first arm 41 and second arm 42 and a phase shift unit 13 for providing an appropriate phase difference between a pair of optical inputs obtained by branching optical waveguide; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and a phase shifter 2 for shifting the phase of the low-frequency signal f₀ by nπ/2 (where n is a natural number other than 0 and multiples of 4), for providing the low-frequency signal f₀ from the low-frequency signal generator 1 to the first electrode 43 and also for providing the low-frequency signal f₀, of which the phase was shifted by nπ/2 by the phase shifter 2, to the second electrode 44. The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5).

The low-speed photodiode 3 may be replaced by a low-speed photodiode 3′ so as to detect an optical signal from the output side of the intensity modulator 31. Because the phase shifter 2 is operated at a low frequency, amount of phase shift by the phase shifter 2 may be fixed.

In the optical transmitting apparatus shown in FIG. 22, the characteristics of the f₀ component and the 2f₀ component presented in FIG. 7 through FIG. 9 are also acquired. Consequently, in the optical transmitting apparatus, the phase shift of the phase shift unit 13 can be maintained at an appropriate value (for example, an odd-numbered multiple of π/2) by controlling the phase shift unit 13 with feedback control so that the power of the 2f₀ component attains the minimum.

In the sixth embodiment also, the feedback control may be performed by using the f₀ component, or the feedback control may be performed by using both of the f₀ component and the 2f₀ component.

### Seventh Embodiment

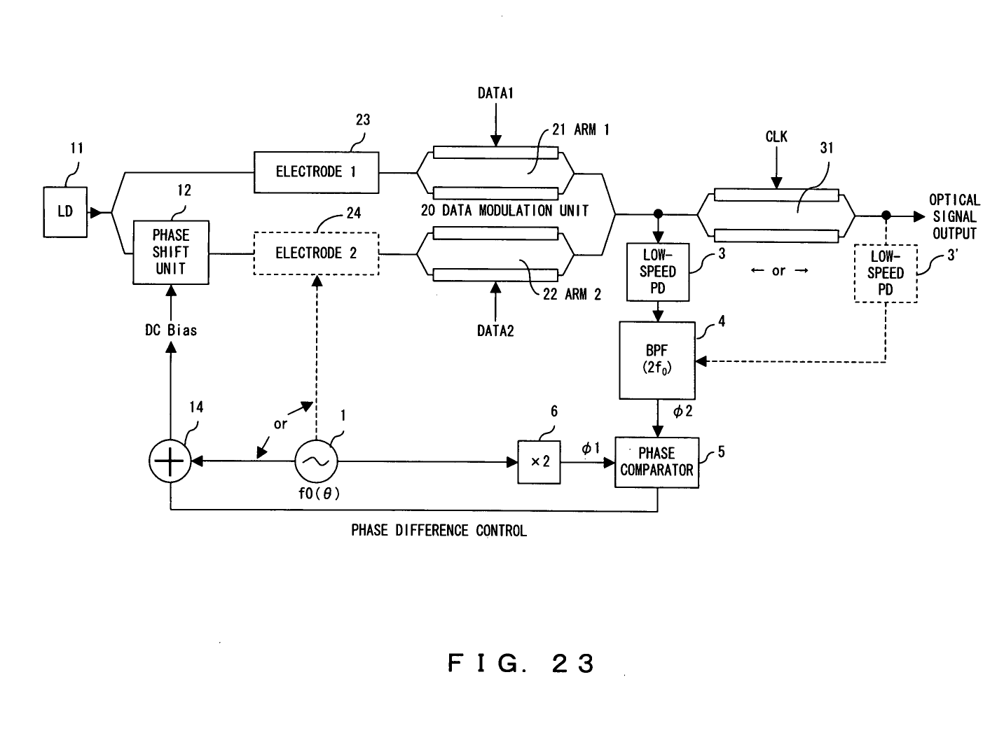

In the optical transmitting apparatus of the first through sixth embodiments, a low-frequency signal is superimposed on one of a pair of optical signals, and a signal obtained by shifting a phase of the low-frequency signal by a prescribed amount is superimposed on the other optical signal. On the other hand, in the optical transmitting apparatus of the seventh and the eighth embodiments, a low-frequency signal is superimposed only on one of a pair of optical signals. The low-frequency signal is, in an example shown in FIG. 23, provided via a bias input terminal of a phase shift unit 12; however, in order to superimpose the low-frequency signal, it may be provided via an electrode, may be superimposed on either of data signals DATA 1 or DATA 2, or may be provided via a bias terminal of one arm of a data modulation unit. Even with the configuration in which the low-frequency signal is superimposed only on one of a pair of optical signals, it was confirmed by simulations that the characteristics of the f₀ component and the 2f₀ component presented in FIG. 7 through FIG. 9 are acquired.

FIG. 23 is an overview block diagram describing a configuration of an optical transmitting apparatus relating to the seventh embodiment of the present invention. In FIG. 23, the illustration of the driving signal generator unit 110 and the clock signal generator unit 120 shown in FIG. 6 is omitted.

The optical transmitting apparatus shown in FIG. 23 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, first and second electrodes 23 and 24, provided in former stages of corresponding arms of a data modulation unit 20, for superposing a low-frequency signals, and the data modulation unit 20 comprising data terminals for respectively inputting the pre-coded data signals DATA 1 and DATA 2 to first arm 21 and second arm 22; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and for providing the low-frequency signal f₀ to a bias terminal of the phase shift unit 12 via an adder 14. Here, the low-frequency superimposing unit may provide the low-frequency signal to the electrode 23 or the electrode 24 instead of providing the phase shift unit 12.

The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5). The low-speed photodiode 3 may be replaced by a low-speed photodiode 3′ so as to detect an optical signal from the output side of the intensity modulator 31.

In the optical transmitting apparatus shown in FIG. 23, the characteristics of the f₀ component and the 2f₀ component presented in FIG. 7 through FIG. 9 are also acquired. Consequently, in this optical transmitting apparatus, the phase shift of the phase shift unit 12 can be also maintained at an appropriate value (for example, an odd-numbered multiple of π/2) by controlling the phase shift unit 13 with feedback control so that the power of the 2f₀ component attains the minimum.

In the seventh embodiment also, the feedback control may be performed by using the f₀ component, or the feedback control may be performed by using both of the f₀ component and the 2f₀ component.

### Eighth Embodiment

The configuration of the optical transmitting apparatus of the eighth embodiment is basically the same as that of the optical transmitting apparatus of the seventh embodiment. However, in the optical transmitting apparatus of the eighth embodiment, a phase shift unit 13 is configured in the later stage of a data modulation unit 40, and when an electrode for superimposing a low-frequency signal is required, the electrode would be also configured in the later stage of the data modulation unit 40.

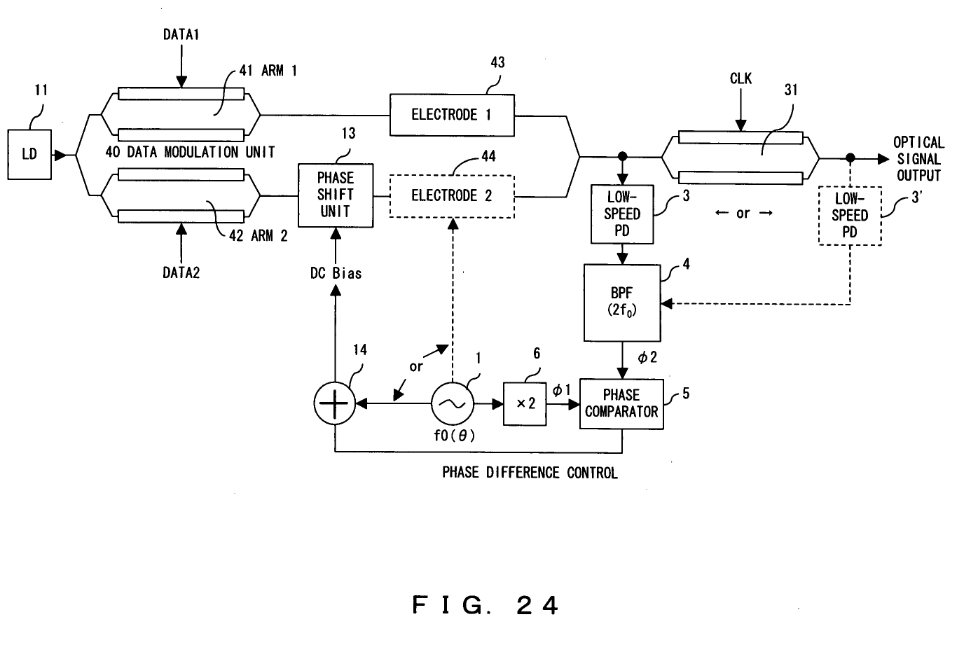

FIG. 24 is an overview block diagram describing the eighth embodiment of the present invention. In FIG. 24, the illustration of the driving signal generator unit 110 and the clock signal generator unit 120 shown in FIG. 6 is omitted.

The optical transmitting apparatus shown in FIG. 24 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a data modulation unit 40 comprising data terminals for respectively inputting the pre-coded data signals DATA 1 and DATA 2 to first arm 41 and second arm 42, a phase shift unit 13 for providing an appropriate phase difference between a pair of optical inputs obtained by branching optical waveguide, and first and second electrodes 43 and 44, provided in later stages of corresponding arms of the data modulation unit 40, for superposing a low-frequency signals; an intensity modulator 31 for modulating the intensity of the optical output from the phase modulator using the clock signal from the clock signal generation unit; and a low-frequency superimposing unit comprising a low-frequency signal generator 1 for generating a low-frequency signal f₀ of several KHz (a several MHz is also acceptable), and for providing the low-frequency signal f₀ to a bias terminal of the phase shift unit 13 via an adder 14. Here, the low-frequency superimposing unit may provide the low-frequency signal to the electrode 43 or the electrode 44 instead of providing the phase shift unit 13.

The optical transmitting apparatus further comprises a monitor unit comprises a low-speed photodiode 3 for extracting a low-frequency signal from optical output of the phase modulator, which has waveguide to split optical beam into two for generating two optical signals and to couple the two optical signals, a band-pass filter BPF 4 with its center frequency of 2f₀, a multiplier 6 for doubling the frequency of the low-frequency signal from the low-frequency generator 1, and a phase comparator 5 for comparing the phase φ1 of the multiplier 6 with the phase φ2 of the BPF 4 and for generating a “+” signal when the phase φ1 is delayed and a “−” signal when the phase φ2 is delayed, and for outputting an “approximate zero” signal when the phase of the phase shift unit 12 has an appropriate value (an odd-numbered multiple of π/2, for example); and a phase difference control unit, not shown in figures, for controlling the amount of phase shift of the phase shift unit 12 according to the output of the monitor unit (the phase comparator 5). The low-speed photodiode 3 may be replaced by a low-speed photodiode 3′ so as to detect an optical signal from the output side of the intensity modulator 31.

In the optical transmitting apparatus shown in FIG. 24, the characteristics of the f₀ component and the 2f₀ component presented in FIG. 7 through FIG. 9 are also acquired. Consequently, in the optical transmitting apparatus, the phase shift of the phase shift unit 13 can be maintained at an appropriate value (for example, an odd-numbered multiple of π/2) by controlling the phase shift unit 13 with feedback control so that the power of the 2f₀ component attains the minimum.

In the eighth embodiment also, the feedback control may be performed by using the f₀ component, or the feedback control may be performed by using both of the f₀ component and the 2f₀ component.

### Ninth Embodiment

The above optical transmitting apparatus of the first through the eighth embodiments have a configuration for monitoring variation components of modulator output power or transmitter output power in a state that a low-frequency signal is superimposed on an optical signal, and for controlling the amount of phase shift in the phase shift unit so as to be an appropriate value (for example, an odd-numbered multiple of π/2). Meanwhile, an optical transmitting apparatus relating to the ninth embodiment monitors the modulator output power or transmitter output power by RF (Radio Frequency) power monitor with a square-law detector function, and controls the amount of the phase shift of the phase shift unit to be an appropriate value (for example, an odd-numbered multiple of π/2) without superimposing a low-frequency signal.

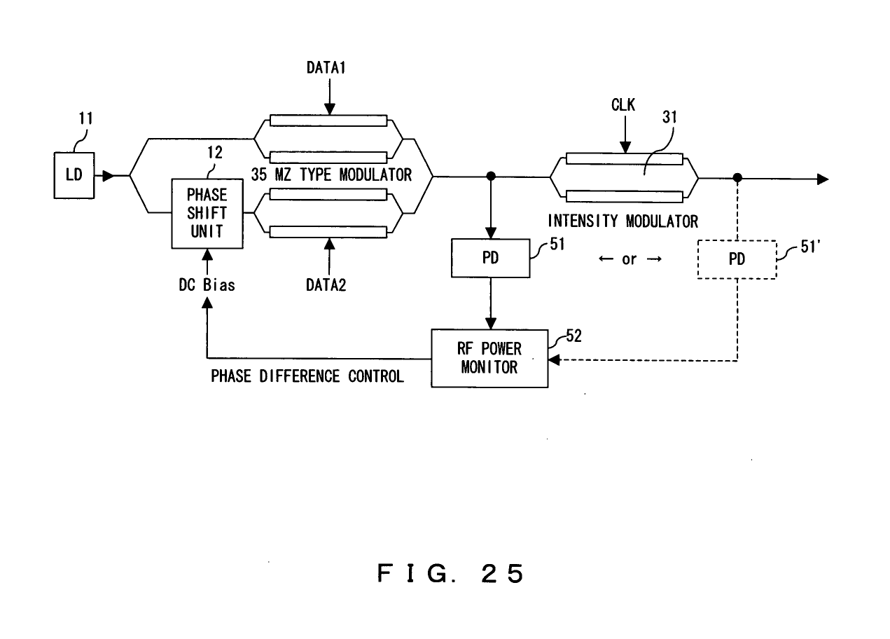

FIG. 25 is an overview block diagram describing the ninth embodiment of the present invention. In FIG. 25, the illustration of the driving signal generator unit 110 and the clock signal generator unit 120 shown in FIG. 6 is omitted.

The optical transmitting apparatus shown in FIG. 25 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, and a MZ type modulator 35 comprising data terminals for respectively inputting the pre-coded data signals DATA 1 and DATA 2 to a pair of arms; and an intensity modulator 31 for modulating the intensity of the optical output from the phase modulator using the clock signal from the clock signal generation unit.

The optical transmitting apparatus further comprises a photodiode (PD) 51 for converting optical output of the phase modulator, which has waveguide to split optical beam into two for generating two optical signals and to couple the two optical signals, into an electrical signal from in order to detect deviation from the appropriate value of the phase shift unit 12 (for example, an odd-numbered multiple of π/2); an RF power monitor 52 for detecting by a square-law detector an output signal of the photodiode 51 and for monitoring fluctuation of the peak power; and a phase difference control unit, not shown in figures, for controlling the phase shift unit 12 based on the output of the RF power monitor 52. The photodiode 51 may be replaced by a photodiode 51′ so as to extract an electrical signal from the output side of the intensity modulator 31. The photodiode 51 can be realized by a high speed response photodiode, which can be compliant with the speed of the data signal.

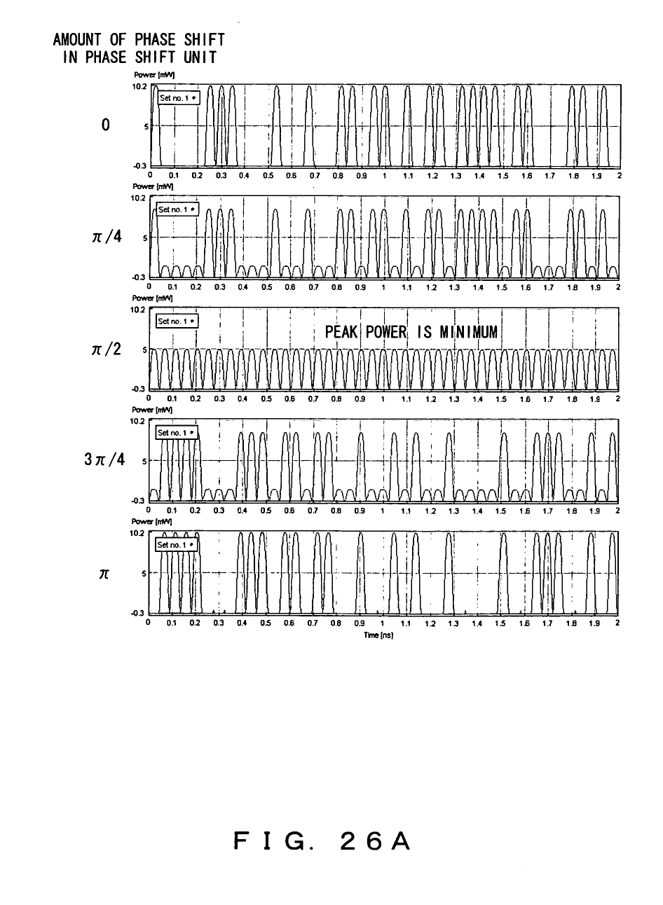

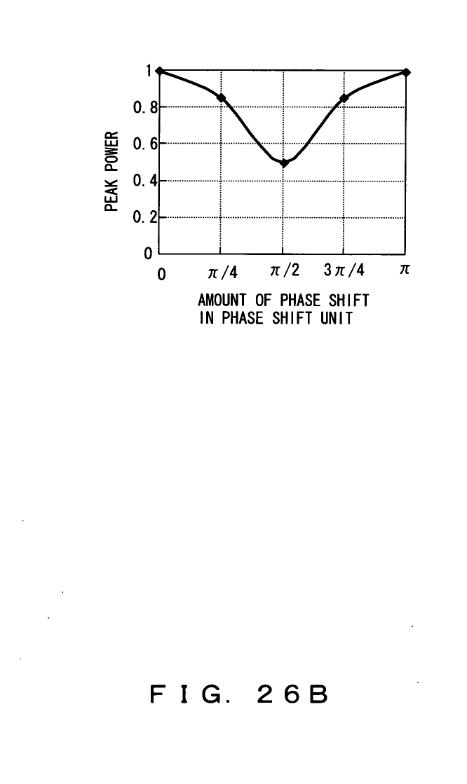

FIG. 26A is a simulation result showing a relation between the amount of phase shift in the phase shift unit and the output optical signal waveform. FIG. 26B is a graph showing a relation between the amount of phase shift and the peak power of the output optical signal. As shown in FIG. 26A and FIG. 26B, when the amount of phase shift of the phase shift unit 12 is “π/2”, the peak power of the output optical signal attains minimum. In other words, if the feedback control is performed so that the peak power of the output optical signal attains minimum, the amount of phase shift of the phase shift unit 12 can be maintained at “π/2”.

In such a manner, the optical transmitting apparatus of the ninth embodiment monitors fluctuation of the peak power of the optical signal using the RF power monitor with the square-law detector function, and by controlling the phase shift unit by bias controlling according to the monitoring result, the amount of the phase shift of the phase shift unit can be maintained at an appropriate value (for example, an odd-numbered multiple of π/2), and the quality of the output optical signal can be stabilized.

### Tenth Embodiment

The first through the ninth embodiments has a configuration for controlling to maintain only the amount of phase shift of the phase shift unit at an appropriate value. The tenth embodiment, meanwhile, has a configuration to stabilize the operation of a whole optical transmitting apparatus.

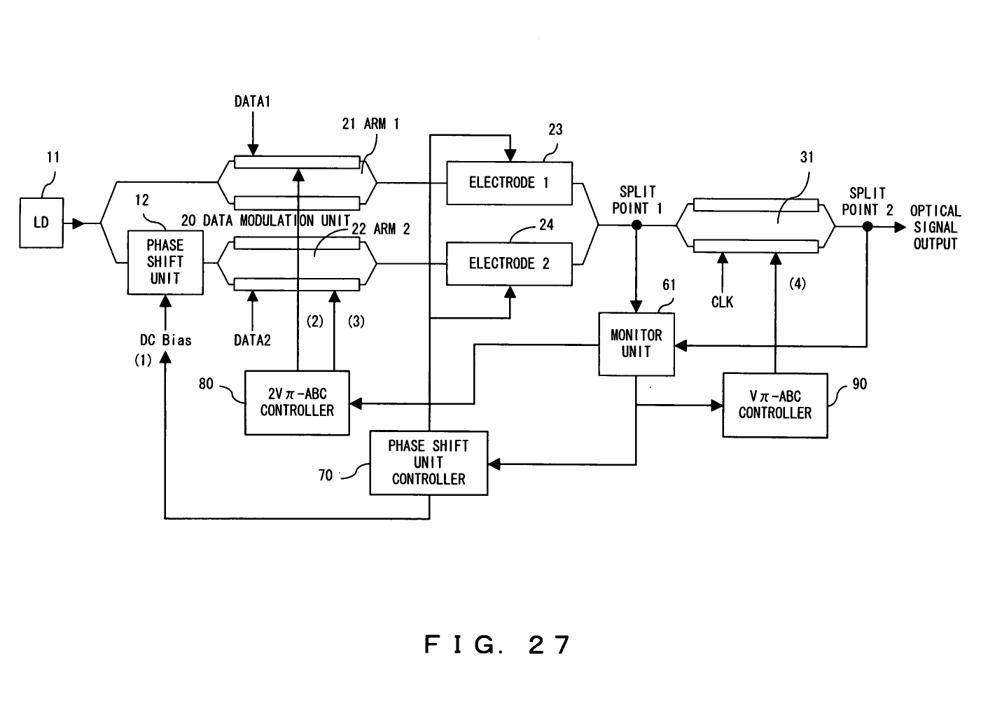

FIG. 27 is a block diagram describing an entire configuration of the optical transmitting apparatus using DMPSK modulation (where M=2ⁿ). When “n=2”, it becomes DQPSK modulation, in which four values can be transmitted. FIG. 27 shows an entire configuration of the optical transmitting apparatus employing DQPSK modulation as an example of the DMPSK modulation. In FIG. 27, the illustration of the driving signal generator unit 110 and the clock signal generator unit 120 shown in FIG. 6 is omitted.

The optical transmitting apparatus shown in FIG. 27 comprises a clock signal generation unit; a driving signal generation unit for generating data signals DATA 1 and DATA 2 pre-coded for DQPSK using a clock signal from the clock signal generation unit; a semiconductor laser (LD) 11; a phase modulator comprising a phase shift unit 12 for providing an appropriate phase difference between a pair of optical inputs obtained by branching optical waveguide, a data modulation unit 20 comprising data terminals for respectively inputting the pre-coded data signals DATA 1 and DATA 2 to first arm 21 and second arm 22, and first and second electrodes 23 and 24, provided in later stages of corresponding arms of the data modulation unit 20, for superposing a low-frequency signal from a phase shift unit controller 70; an intensity modulator 31 for modulating the intensity of the optical output from the phase modulator using the clock signal from the clock signal generation unit. A monitor unit 61 monitors optical output from the phase modulator, which has waveguide to split optical beam into two for generating two optical signals and to couple the two optical signals, to detect fluctuation components such as interference and DC drift etc. of the phase modulator using optical signal from a split point 1, and monitors DC drift component of the intensity modulator 31 using optical signal from a split point 2 in output side of the intensity modulator 31, and supplies monitor output to the phase shift unit controller 70, 2Vπ-ABC controller 80 and Vπ-ABC controller 90. The phase shift unit controller 70 controls bias (a control signal (1) in FIG. 27) of the phase shift unit 12 based on the monitor output of the monitor unit 61. The 2Vπ-ABC controller 80 performs a bias control (a control signal (2) in FIG. 27) on a bias input unit configured in the first arm 21 of the data modulation unit 20 and a bias control (a control signal (3) in FIG. 27) on a bias input unit configured in the second arm 22 of the data modulation unit 20 based on the monitor output from the monitor unit 61. The Vπ-ABC controller 90 performs a bias control (a control signal (4) in FIG. 27) on a bias input unit of the intensity modulator 31 based on the monitor output from the monitor unit 61. It is also possible to perform the above monitoring using only optical signal from the the split point 2 without using optical signal from the split point 1.

In the above optical transmitting apparatus, like the first through the ninth embodiment, when superimposing a low-frequency signal on an optical signal, the monitor unit 61 monitors power of the f₀ component and/or the 2f₀ component. By the feedback control according to the monitoring result, each of the phase shift unit controller 70, the 2Vπ-ABC controller 80 and the Vπ-ABC controller 90 generates individually corresponding bias voltage. By so doing, stable operation of the entire optical transmitting apparatus can be realized. When the intensity modulator 31 performs CSRZ modulation, the 2Vπ-ABC controller should be used instead of the Vπ-ABC controller 90.

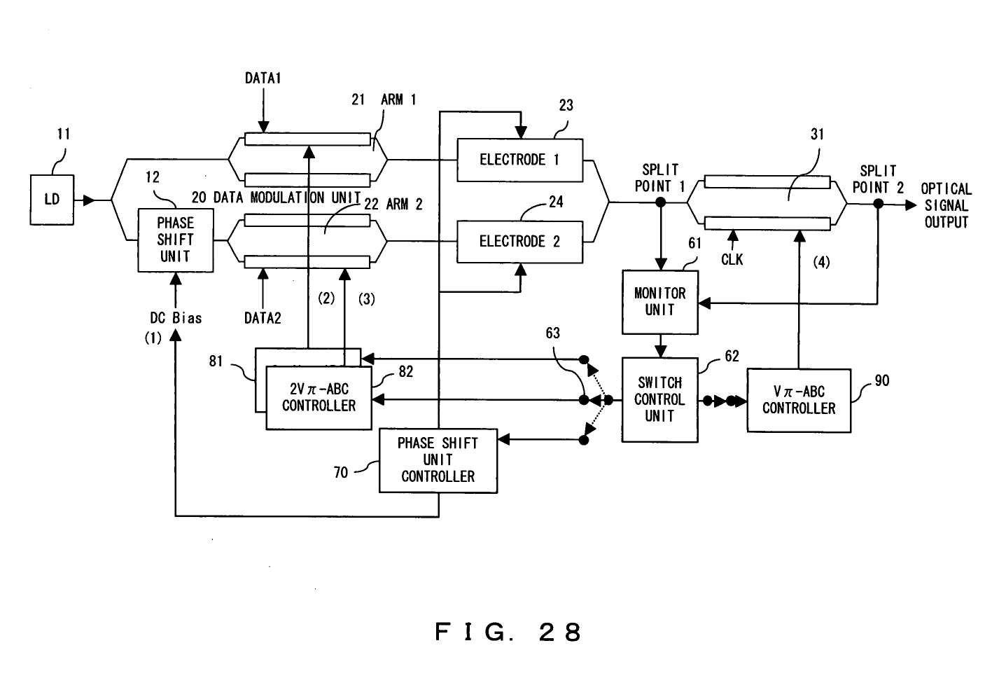

FIG. 28 is a diagram describing a first specific example of the control method shown in FIG. 27. In FIG. 28, the illustration of the driving signal generator unit 110 and the clock signal generator unit 120 shown in FIG. 6 is omitted.

In the method described in FIG. 28, low-frequency signals with the same frequency are superimposed on the control signals (1)-(4). Then, the bias control and monitoring of the low-frequency signal is performed on the control signals (1)-(4) by time-division manner. In this example, a signal generator for generating the low-frequency signal is incorporated into a switch control unit 62, and the low-frequency signal is provided in sequence to the phase shift controller 70, to the 2Vπ-ABC controllers 81 and 82 and to the Vπ-ABC controller 90, via a switch 63.

In FIG. 28, when controlling the phase shift unit 12, the switch 63 is switched so that the low-frequency signal is provided to the phase shift unit 12 via a phase shift unit controller 70. At that time, the control signals (2)-(4) are fixed. The monitor unit 61 monitors the low-frequency signal superimposed on the optical signal. According to the monitoring result, the phase shift unit 12 is controlled. When the control for the phase shift unit 12 is finished, the switch 63 is switched so that the low-frequency signal is provided to the arm 21 of the data modulation unit 20 via the 2Vπ-ABC controller 81. At that time, the control signal (1), (3) and (4) are fixed. The monitor unit 61 monitors the low-frequency signal superimposed on the optical signal. According to the monitoring result, DC drift in the arm 21 of the data modulation unit 20 is controlled. In the same manner, control over the DC drift in the arm 22 of the data modulation unit 20 and control over the DC drift in the intensity modulator 31 are performed. Although it is not shown in FIG. 28, methods shown as the above the first through the eighth embodiments can be used for superimposing the low-frequency signal. At that time, when the intensity modulator 31 supports CSRZ, the 2Vπ-ABC controller should be used instead of the Vπ-ABC controller 90.

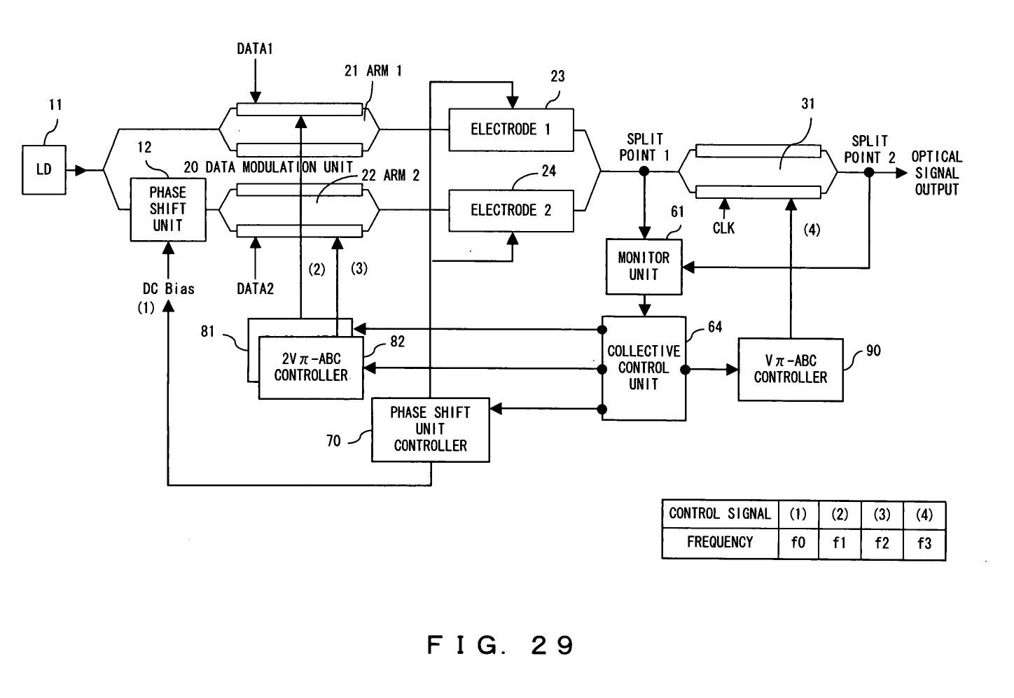

FIG. 29 is a diagram describing a second specific example of the control method shown in FIG. 27. In FIG. 29, the illustration of the driving signal generator unit 110 and the clock signal generator unit 120 shown in FIG. 6 is omitted.

In the method shown in FIG. 29, low-frequency signals with different frequencies are superimposed on the control signals (1)-(4). Then, the bias control and the monitoring of the low-frequency signal are performed simultaneously on the control signal (1)-(4). In other words, as shown in FIG. 29, the low-frequency signals with the frequency f₀ through f₃ are superimposed on the control signal (1) through (4), respectively. In this method, a collective control unit 64 controls the phase shift controller 70, the 2Vπ-ABC controllers 81 and 82 and the Vπ-ABC controller 90. A signal generator for generating the low-frequency signals with the frequency f₀ through f₃ is, for example, incorporated in the collective control unit 64.

As a modified example of he above second example, a configuration which comprises the switch control unit in the first specific example, superimposes the low-frequency signal with different frequencies on the control signals by time-division and performs the bias control and monitoring on the control signals (1)-(4) by time-division is also possible. In addition, as a modified example of the above first and the second specific examples, a configuration, in which some of the control signals (1)-(4) are superimposed by low-frequency signals with the same frequencies and the rest of the control signals are superimposed by the low-frequency signals with different frequencies and the monitoring and the bias control are performed combining the time-division and simultaneous control, can be also a possibility.

### Eleventh Embodiment

In the eleventh embodiment, like the tenth embodiment, a configuration for enhancing the stability of the operation of the entire optical transmitting apparatus. The eleventh embodiment, however, is an optical transmitting apparatus, which adopted a DBPSK modulation (i.e. n=1) among the DMPSK modulation (M=2ⁿ).

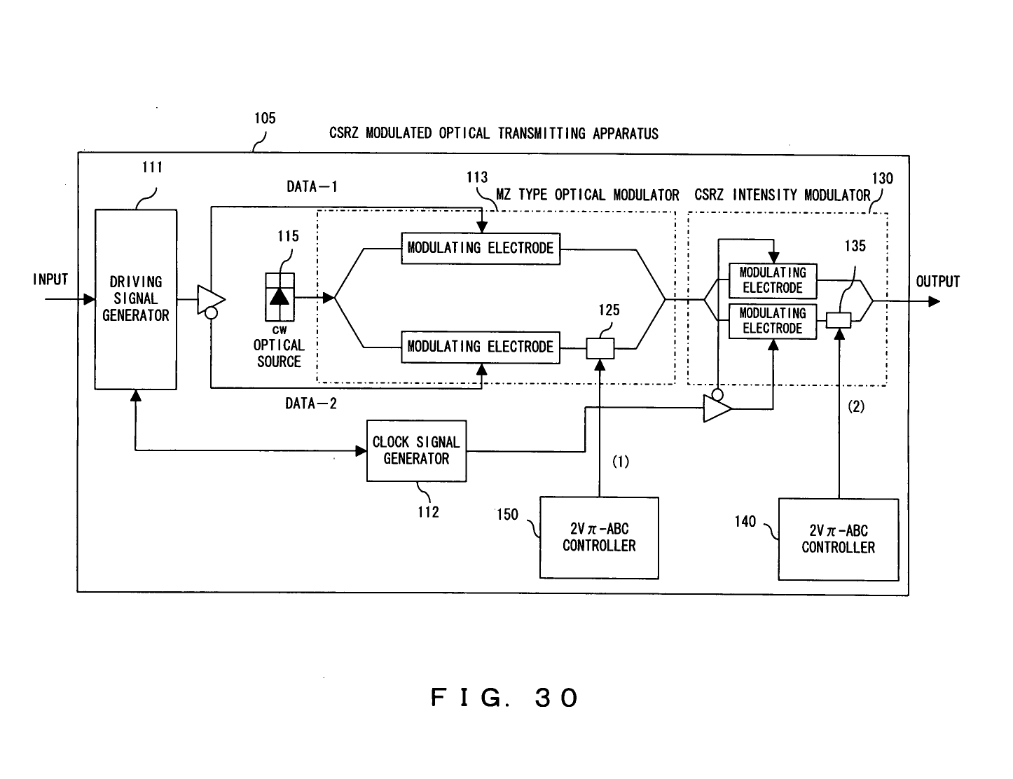

FIG. 30 is a block diagram of an optical transmitting apparatus using CSRZ (Carrier Suppressed Return-to-Zero)-DPSK modulation. An optical transmitting apparatus 105 shown in FIG. 30 comprises a driving signal generator 111 for generating a driving signal to be sent to a MZ modulator 113 using an input signal and a clock signal from a clock signal generator 112; a clock signal generator 112 for providing a clock signal to the driving signal generator 111 and a CSRZ intensity modulator 130; a CW optical source 115; a MZ modulator 113 comprising a plurality of modulating electrodes with input terminals for receiving data signals DATA 1 and DATA 2; the CSRZ intensity modulator 130 for generating a CSRZ-pulsed optical signal; a 2Vπ-ABC controller 150 for bias-controlling a bias input terminal 125 (a control signal (1) in FIG. 30) of the MZ modulator 113 based on the monitor output from a monitor unit (not shown in figures) for monitoring the low-frequency signal component superimposed on the optical signal; and a 2Vπ-ABC controller 140 for bias-controlling a bias input terminal 135 (the control signal (2) in FIG. 30) of the CSRZ intensity modulator 130 based on the above monitor output. The MZ modulator 113 comprises the bias input terminal 125 at one side of the modulating electrodes, and the CSRZ intensity modulator 130 also comprises the bias input terminal 135 at one side of the modulating electrodes.

In such a manner, the optical transmitting apparatus of the eleventh embodiment can operate stably as a whole by controlling the bias fluctuation of both of the MZ modulator and the CSRZ intensity modulator, using control signals (1) and (2) based on the monitor output from the monitor unit (not shown in figures) for monitoring the low-frequency signal component superimposed on the optical signal.

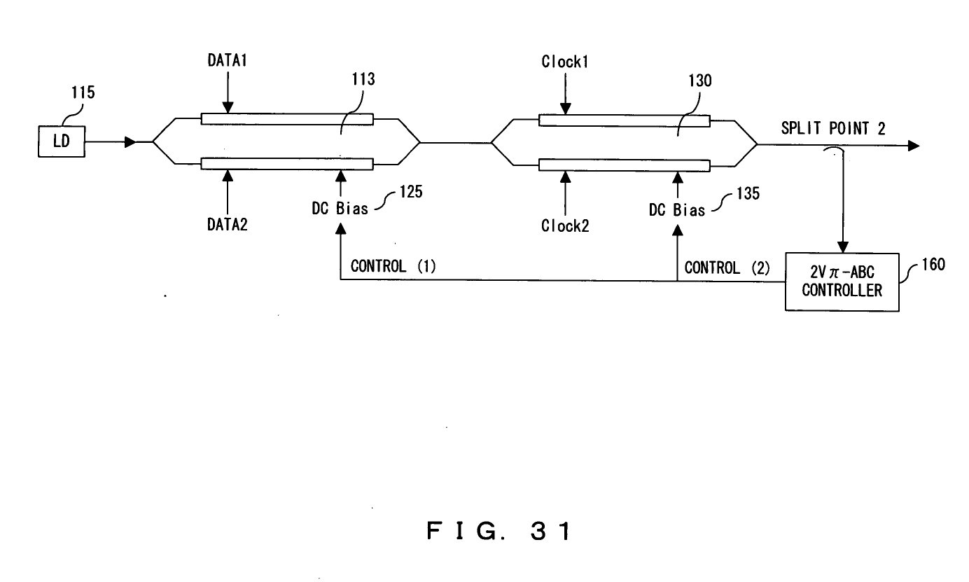

FIG. 31 is a diagram showing a first practical example of fluctuation control in the optical transmitting apparatus shown in FIG. 30. In FIG. 31, the illustration of the driving signal generator 111 and the clock signal generator 112 shown in FIG. 30 is omitted.

In a method shown in FIG. 31, the low-frequency signals with the same frequency are added to the bias input terminal 125 of the MZ modulator 113 and the bias input terminal 135 of the CSRZ intensity modulator 130 by time-division manner. A 2Vπ-ABC controller 160 monitors an optical signal split at the split point 2 by the time-division. In addition, the 2Vπ-ABC controller 160 performs the bias control over the bias input terminal 125 of the MZ modulator 113 and the bias input terminal 135 of the CSRZ intensity modulator 130 by time-division, as shown in the control signals (1) and (2) in FIG. 31.

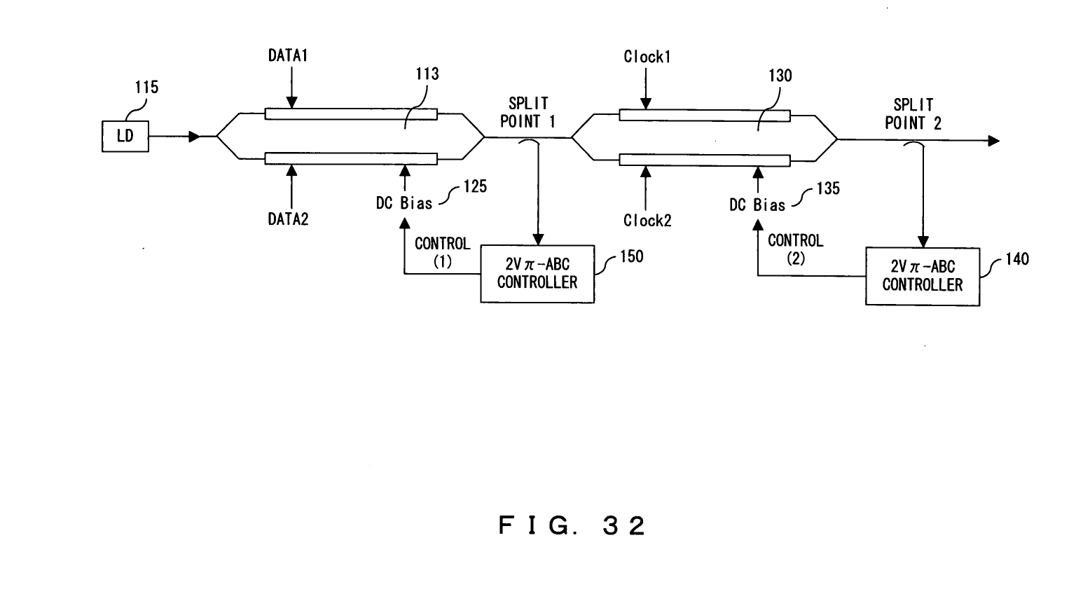

FIG. 32 is a diagram showing a second practical example of a fluctuation control in the optical transmitting apparatus shown in FIG. 30. In FIG. 32, the illustration of the driving signal generator 111 and the clock signal generator 112 shown in FIG. 30 is omitted.

In a method shown in FIG. 32, the low-frequency signals with different frequencies from each other are superimposed on corresponding DC bias. A 2Vπ-ABC controller 150 monitors the optical signal split from the split point 1, and performs bias control using the control signal (1) shown in FIG. 32, over the bias input terminal 125 of the MZ modulator 113. A 2Vπ-ABC controller 140 monitors an optical signal split at the split point 2, and performs bias control using the control signal (2) shown in FIG. 32, over the bias input terminal 135 of the CSRZ intensity modulator 130, in parallel with the operation of the 2Vπ-ABC controller 150.

In the configuration in FIG. 32, the optical signals split at the split points 1 and 2 is guided to the 2Vπ-ABC controllers 150 and 140, respectively; however, a configuration in which the optical signal split at the split point 2 is guided to both of the 2Vπ-ABC controllers 150 and 140 is also possible.

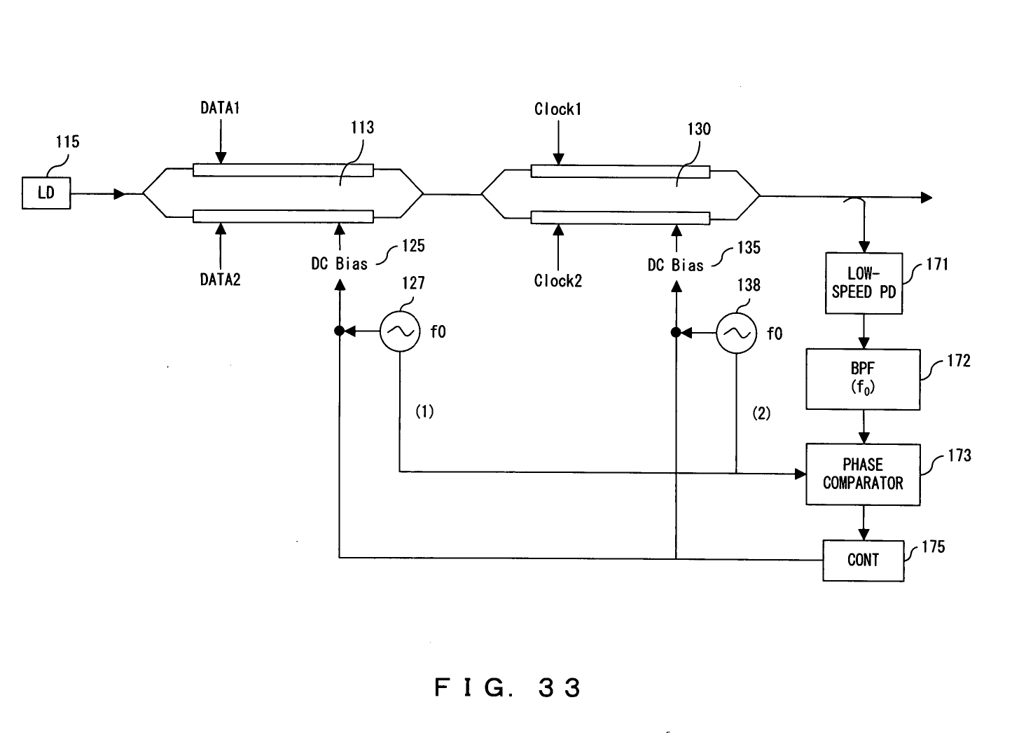

FIG. 33 is a diagram describing a specific example of the first configuration shown in FIG. 31. In FIG. 33, the illustration of the driving signal generator 111 and the clock signal generator 112 shown in FIG. 30 is omitted.

In FIG. 33, a 2Vπ-ABC controller 160, in which low-frequency signal generators 127 and 138 for generating a low-frequency signal f₀ are configured near the bias input terminals 125 and 135, comprises a low-speed photodiode 171, a band pass filter BPF 172 with pass frequency f₀, a phase comparator 173 for monitoring the bias fluctuation in the MZ modulator 113 and the bias fluctuation in the CSRZ intensity modulator 130 by comparing the output phase of the low-frequency signal generators 127 and 138 and the output phase of the BPF 172, and a controller CONT 175 for controlling the bias of the MZ modulator 113 and the CSRZ intensity modulator 130 based on the monitor output. In this example, superimposing of the low-frequency signal and bias control are performed by time-division, respectively.

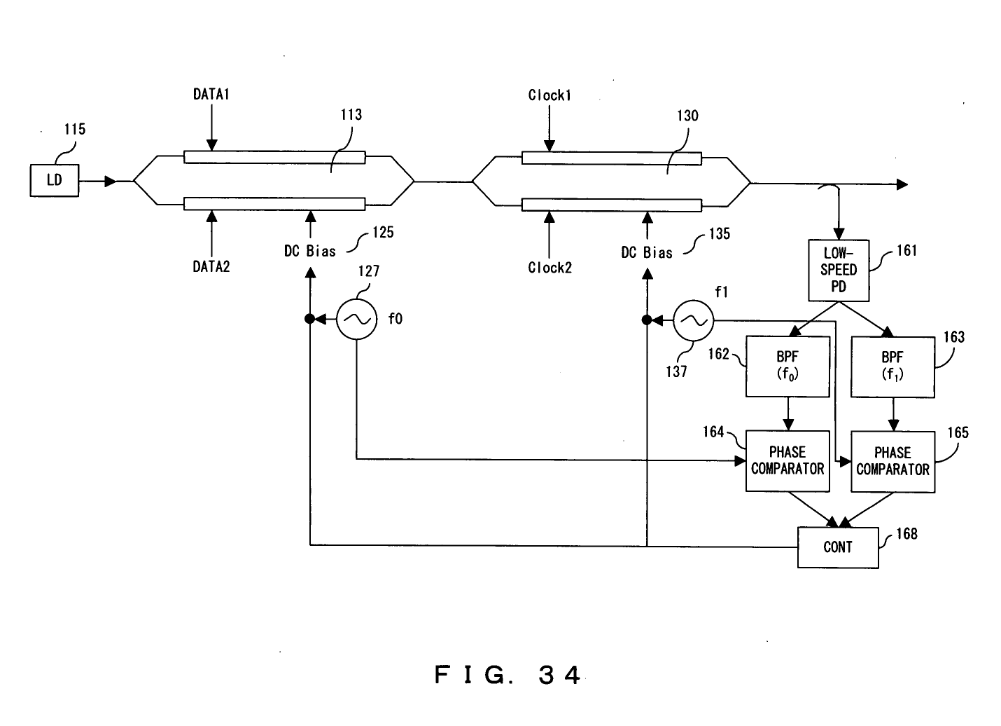

FIG. 34 is a diagram describing a specific example of the second configuration shown in FIG. 32. The illustration of the driving signal generator 111 and the clock signal generator 112 shown in FIG. 30 is omitted in FIG. 34. In FIG. 34, also, one 2Vπ-ABC controller controls the MZ modulator 113 and the CSRZ modulator 130.

In FIG. 34, a low-frequency signal generator 127 for generating a low-frequency signal with a frequency f₀ is configured near the bias input terminal 125, and a low-frequency signal generator 137 for generating a low-frequency signal with a frequency fl is configured near the bias input terminal 135. The 2Vπ-ABC controller comprises a low-speed photodiode 161, a bandpass filter BPF 162 with pass frequency f₀, a phase comparator 164 for monitoring bias deviation in the MZ modulator 113 by comparing the output phase of the low-frequency signal generator 127 and the output phase of the BPF 162, a bandpass filter BPF 163 with pass frequency f1, a phase comparator 165 for monitoring bias deviation in the CSRZ modulator 130 by comparing the output phase of the low-frequency signal generator 137 and the output phase of the BPF 163, and a controller 168 for controlling the MZ modulator 113 and the CSRZ modulator 130 according to the monitoring result of the phase comparators 164 and 165.

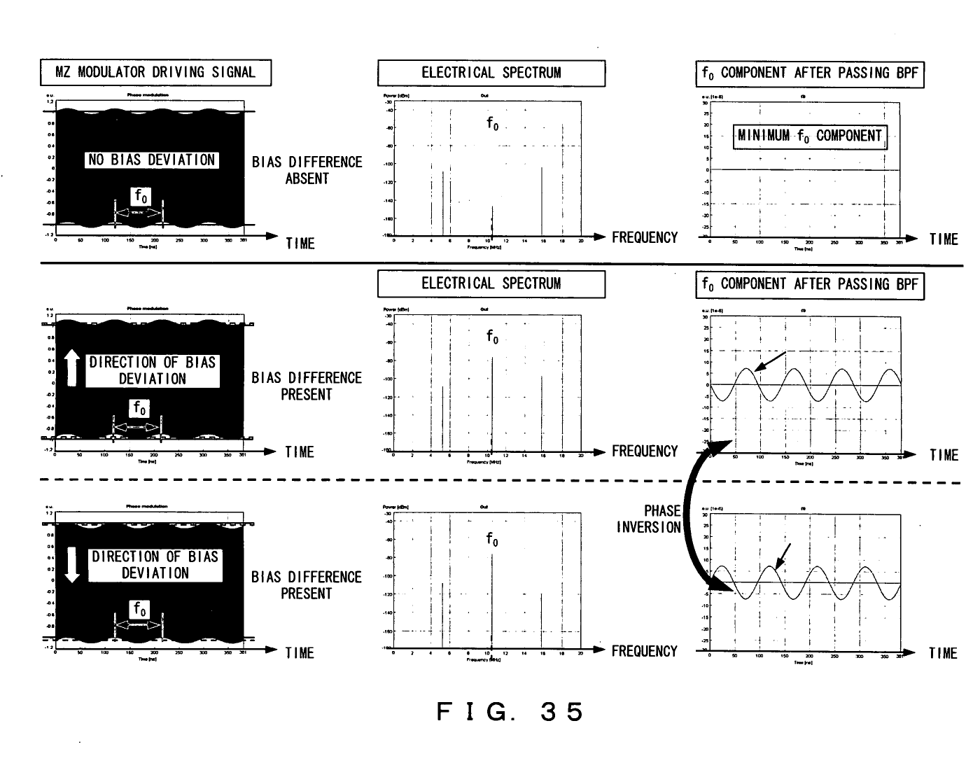

FIG. 35 is a diagram indicating a relation between the bias in the MZ modulator 113 and detected low-frequency signals shown in FIG. 31-FIG. 34. As in FIG. 35, when the bias in the MZ modulator 113 is proper, the f₀ component extracted from the output optical signal attains the minimum, and when the bias deviation is generated, the f₀ component becomes large. The phase of the extracted f₀ component signal when the bias deviation is on the + side is inverted from the phase of the extracted f₀ component signal when the bias deviation is on the − side. Therefore, the bias in the MZ modulator 113 can be properly controlled by performing feedback control so that the f₀ component attains its minimum.

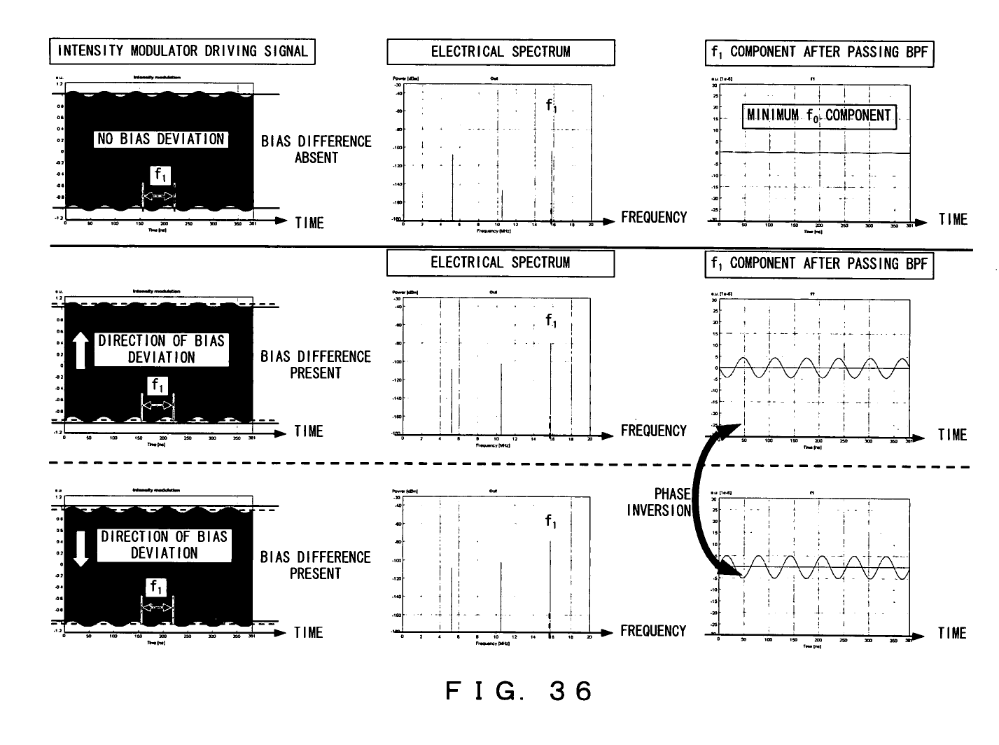

FIG. 36 is a diagram indicating a relation between the bias in the CSRZ modulator 130 and detected low-frequency signals shown in FIG. 31-FIG. 34. As in FIG. 36, when the bias in the CSRZ modulator 130 is proper, the f1 component extracted from the output optical signal attains the minimum, and when the bias deviation is generated, the f1 component becomes large. The phase of the extracted f1 component signal when the bias deviation is on the + side is inverted from the phase of the extracted f1 component signal when the bias deviation is on the − side. Therefore, the bias in the CSRZ modulator 130 can be properly controlled by performing feedback control so that the fl component attains its minimum.

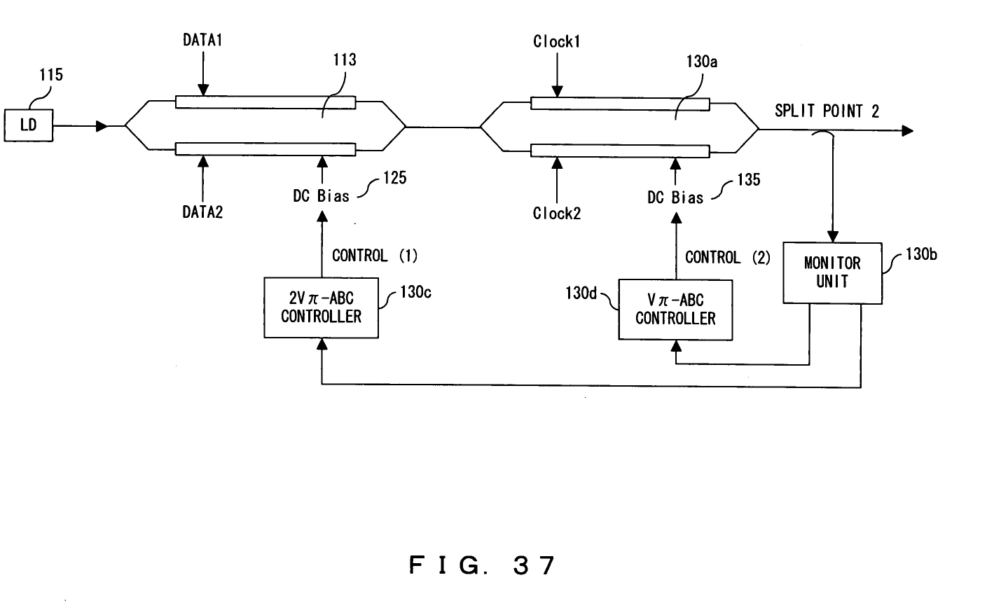

FIG. 37 is a modified example of the optical transmitting apparatus shown in FIG. 31, and a RZ intensity modulator 130a is configured instead of the CSRZ modulator 130. In this apparatus, the f₀ component contained in the optical signal split at the split point 2 is monitored in a monitor unit 130b. Each of a 2Vπ-ABC controller 130c for providing bias to the MZ modulator 113 and a Vs-ABC controller 130d for providing bias to the RZ intensity modulator 130a refers to the monitoring result by the monitor unit 130b. According to this configuration, the 2Vπ-ABC controller 130c and the Vπ-ABC controller 130d shares one monitor unit.

As explained above, the phase shift units 12 and 13 can provide an appropriate phase difference (for example, an odd-numbered multiple of π/2) between a pair of optical waveguides in a phase modulator. As another embodiment, for example, the refractive index of the optical waveguides can be changed by changing the temperature of the optical waveguide by configuring a thin film heater on the split optical waveguide, or by adding stress on the optical waveguide by configuring a piezoelectric element etc. and applying appropriate voltage to the optical waveguide. As a result, the control to provide an appropriate phase difference between a pair of optical waveguides in the phase modulator becomes possible.

In addition, in the above embodiments, the phase shift units 12 and 13 are configured in one of a pair of optical waveguides; however, they can be configured in both of the optical waveguides. In such a case, relative phase difference can be provided properly by asymmetrical applied voltage or temperature to the phase shift unit (electrode, thin film heater, piezoelectric element) configured in the waveguides.

Moreover, in the above embodiment, the explanation is mainly on the DQPSK modulation; however, the control of the present invention can be applied to the QPSK modulation without any modification. The present invention, also, can be applied to 2ⁿPSK (n≧3) or QAM. However, when applying the present invention to these modulation, for example, multivalued data with four or more values should be used as a data signal input to the data modulation unit.

In the following description, an explanation of a technology for improving the adjustment accuracy of the above amount of the phase shift is provided.

In the DQPSK modulation, as described above, a phase shift unit for generating a phase difference of “π/2” between a pair of optical signals is required. In order for the phase shift unit to adjust the amount of the phase shift, the bias voltage provided to the phase shift unit is controlled by the feedback control. Here, it is desirable to have a configuration for monitoring the time average optical power of the modulated optical signal using low-price and low-speed photodiode in attempting to downsize and cut the cost of a circuit for monitoring a parameter used for the feedback control. However, in the DQPSK modulation, even though the phase difference deviates from “π/2”, the change in average optical power is small, and it is not easy to detect and to adjust the DC drift.

In view of the problem, in the following twelfth and thirteenth embodiments, a configuration for enlarging the change in average optical power of an output optical signal with respect to the DC drift of a phase shift unit is presented.

### Twelfth Embodiment

In the DQPSK modulation, as explained referring to FIG. 3, each symbol comprises 2-bit data (DATA 1 and DATA 2). Either “0” or “π” is assigned to the data DATA 1, and either “π/2” or “3π/2” is assigned to the data DATA 2. Therefore, each of the symbols (00, 10, 11, 01) can be represented by “π/4”, “3π/4”, “5π/4” and “7π/4”.

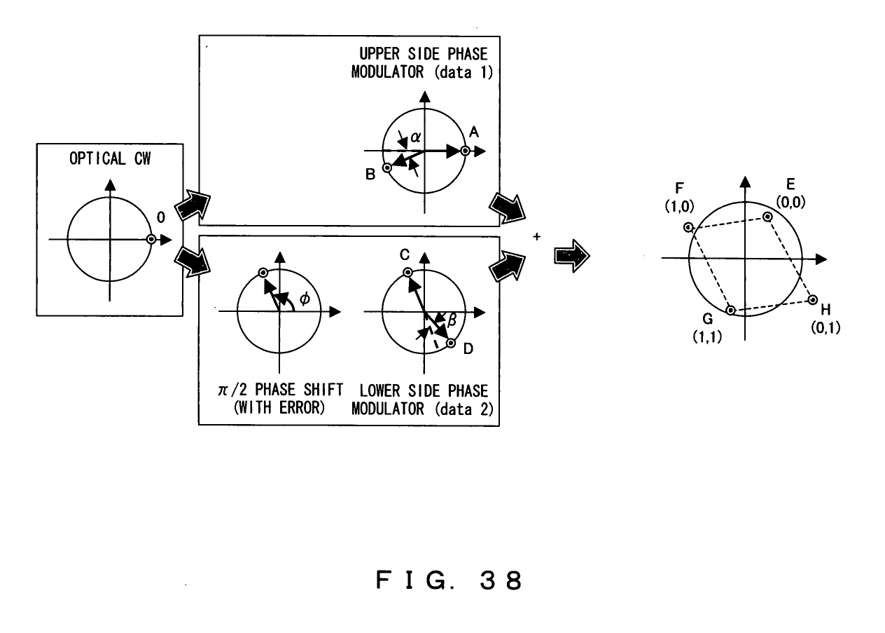

In the twelfth embodiment, as shown in FIG. 38, “0” or “π+α” is assigned to the data DATA 1. “φ” or “φ+π+β” is assigned to the data DATA 2. Here, “φ” is the amount of phase shift by the phase shift unit, and is ideally “π/2”. “α” and “β” are the phases added in the twelfth embodiment.

Signal points A and B corresponding to the data DATA 1, and signal points C and D corresponding to the data DATA 2 are represented as the following on the phase plane.

Math 1

Signal points E, F, G and H corresponding to each of the symbols (00, 10, 11, 01) are represented as the following on the phase plane.

Math 2

The average optical power Pₐᵥₑ of the modulated optical signal is proportional to an average of squared distance from an origin of the phase plane to each of the signal points (E through H). Consequently, the average optical power Pₐᵥₑ of the modulated optical signal is represented as the following equation (1).

Math 3

In the DQPSK modulation, generally, both “α” and are zero. Therefore, in this case, the average optical power Pₐᵥₑ of the modulated optical signal maintains “1”, being independent of “φ”. In other words, when the amount of phase shift by the phase shift unit deviates from π/2 due to aged deterioration etc., it is difficult to detect the deviation of the amount of the phase shift by monitoring the average power Pₐᵥₑ,

On the contrary, according to the optical transmitting apparatus of the twelfth embodiment, neither “α” nor “β” is zero, and therefore the terms including “φ” remain in the above equation (1). Consequently, when the amount of phase shift deviates from π/2, the average optical power Pₐᵥₑ changes in response to the deviation. In other words, by monitoring the average optical power Pₐᵥₑ, the change in the amount of phase shift by the phase shift unit can be easily detected.

“α” and “β” can be the same to or can be different from each other. “α” and “β”, also, can be positive phases or negative phases. Thus, in the twelfth embodiment, “adding the phase” includes both rotating the phase in a positive direction and rotating the phase in a negative direction. It is required that “α” and “β” have to be determined within a range where the reduction of communication quality is permissible.

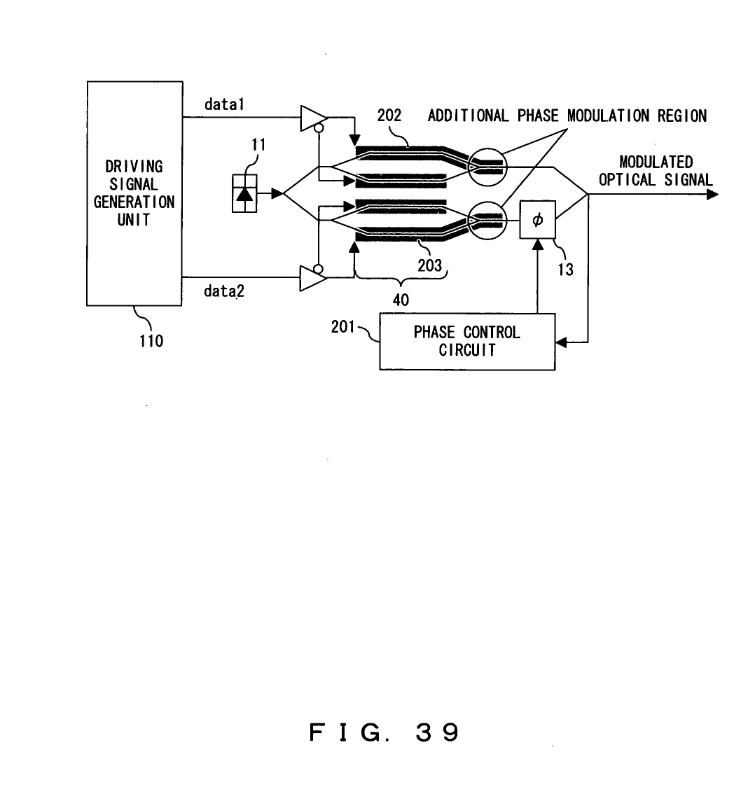

FIG. 39 through FIG. 41 are first through third practical examples of the twelfth embodiment. In these examples, only a configuration for adding “α” and “β” explained with reference to FIG. 38 is described. The semiconductor laser 11, the phase shift unit 13, the data modulation unit 40 and the driving signal generation unit 110 are the same as explained above. A phase control circuit 201 monitors the average optical power of the modulated optical signal output from the data modulation unit 40 and controls the amount of phase shift by the phase shift unit 13 according to the monitoring result.

In the first practical example, one of a pair of electrodes for applying data signal voltage to each MZ modulator is formed so as to reach the coupled waveguide in the output side of the MZ modulator. In an example shown in FIG. 39, each of electrodes 202 and 203 are formed so as to reach the Y-coupler. In a case that the electrodes 202 and 203 of a MZ modulator are formed in a way as explained above, the frequency of an optical signal in the MZ modulator changes instantaneously upon changing in the logical value of a data signal, and so-called chirp is generated. As a result a phase a and a phase β shown in FIG. 38 are obtained. Details of the technique for generating chirp by extending electrodes of a MZ modulator are described in, for example, Japanese laid-open unexamined patent publication No. 07-199133.

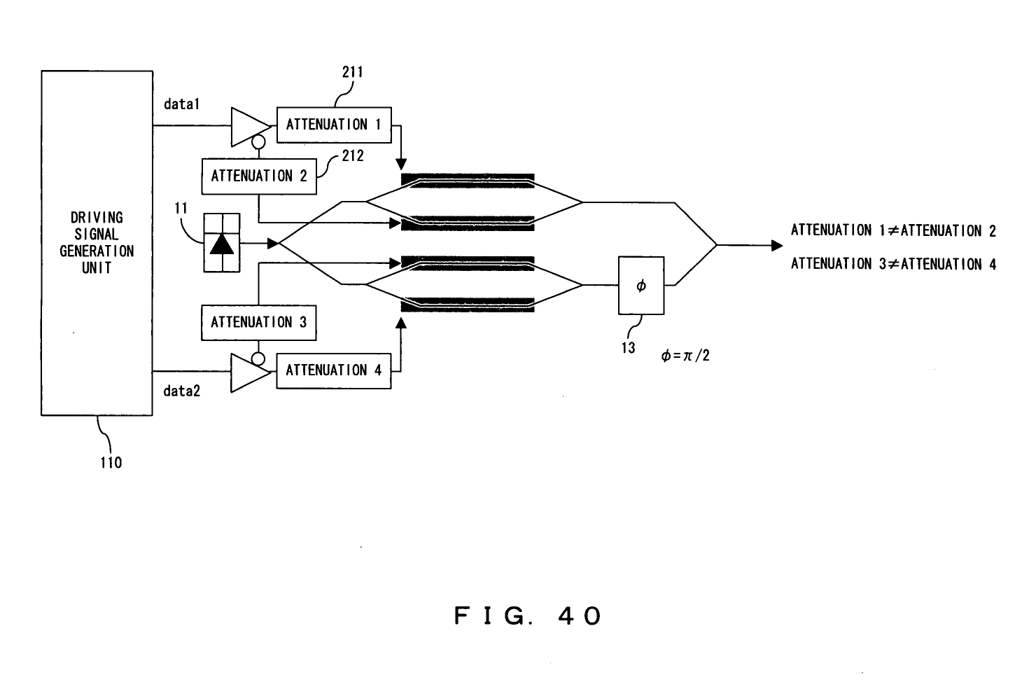

In the second practical example, amplitudes of a pair of data signals provided to a MZ modulator differ from each other. In an example shown in FIG. 40, a data signal DATA 1 is provided to one of the electrodes of the MZ modulator via an attenuator element 211, and the data signal DATA 2 is provided to the other electrode of the MZ modulator via an attenuator element 212. Here, the attenuation by the attenuator element 211 (attenuation 1) and the attenuation by the attenuator element 212 (attenuation 2) are different from each other. Then, like the first practical example, chirp is generated when logical value of the data signal changes, and the phase α, explained with reference to FIG. 38, is obtained. The same thing is applied to the data signal DATA 2, and the phase β is generated by having attenuation 3 and attenuation 4 differ from each other.

The attenuation elements to obtain the attenuation 1 through 4 can be a metal pattern for transmitting the electrical signals. In such a case, the attenuation can be adjustable by changing the width and/or the length of the metal pattern.

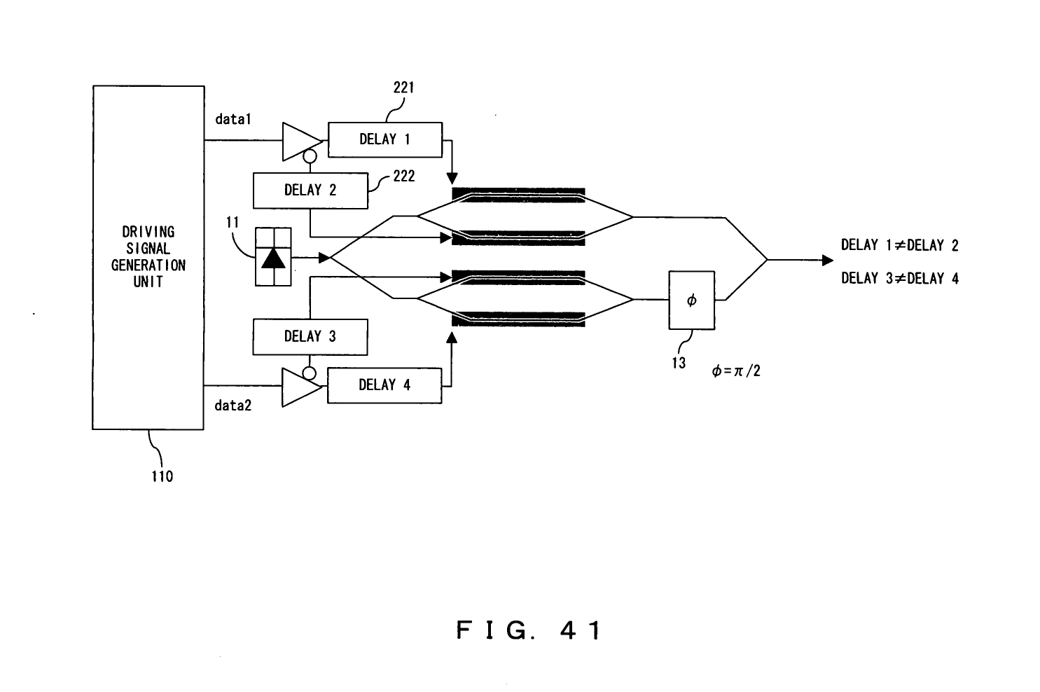

In the third practical example, timing of a pair of data signals provided to a MZ modulator differs from each other. In an example shown in FIG. 41, a data signal DATA 1 is provided to one of the electrode in a MZ modulator via a delay element 221, and the data signal DATA 2 is provided to the other electrode of the MZ modulator via a delay element 222. At that time, the delay by the delay element 221 (delay 1) and the delay by the delay element 222 (delay 2) are different from each other. Then, like the first practical example, chirp is generated when logical value of the data signal changes, and the phase α, explained with reference to FIG. 38, is obtained. The same thing is applied to the data signal DATA 2, and the phase β is generated by having delay 3 and delay 4 differ from each other.

The attenuation elements to obtain the delay 1 through 4 can be a metal pattern for transmitting the electrical signals. In such a case, the delay can be adjustable by changing the length of the metal pattern.

### Thirteenth Embodiment

The average optical power Pₐᵥₑ of a modulated optical signal is represented by the above equation (1) as explained in the twelfth embodiment. However, the above equation (1) is under an assumption that a mark rate of a data signal is equal. In other words, the above equation (1) assumes that four kinds of symbol (00, 10, 11, 01) are generated with equal frequency.

On the contrary, in the thirteenth embodiment, the mark rates of four kinds of symbols in the data signal are not equal. By having the unequal mark rates of the data signal, practically the same effect as the twelfth embodiment can be acquired.

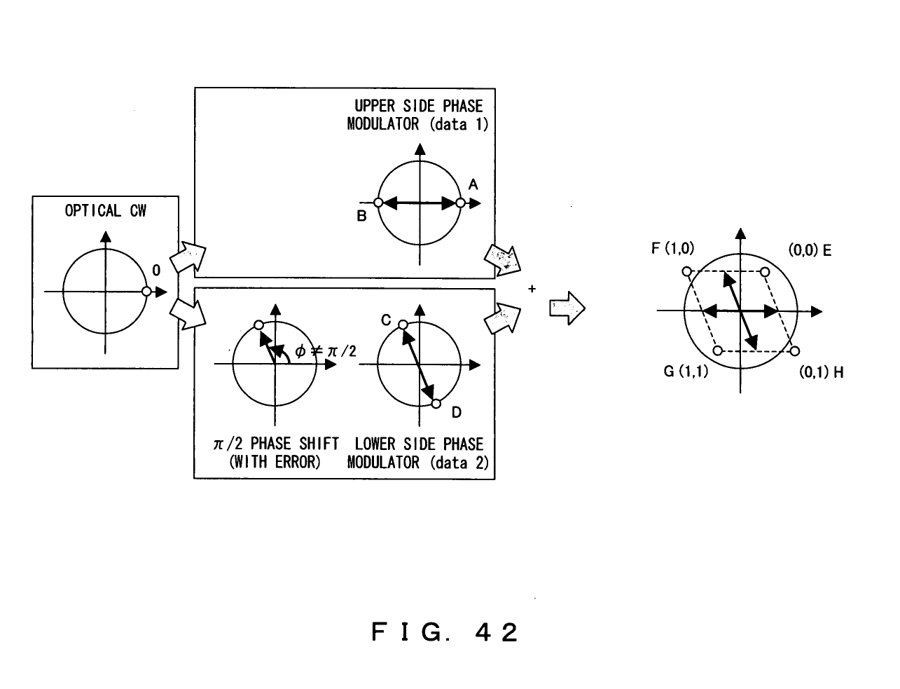

FIG. 42 is a diagram explaining the principle of the thirteenth embodiment. In the thirteenth embodiment, either “0” or “π” is assigned to the data DATA 1. Either “φ” or “φ+π” is assigned to the data DATA 2 as well. Here, “φ” is the amount of phase shift by the phase shift unit, and is ideally “π/2”.

Signal points A and B corresponding to the data DATA 1 and signal points C and D corresponding to the data DATA 2 are represented as the following on a phase plane.

Math 4

Signal points E, F, G and H corresponding to each of the symbols (00, 10, 11, 01) are represented as the following on the phase plane.

Math 5

Optical power P_{E}, P_{F}, P_{G} and P_{H} for transmitting each of the symbols (00, 10, 11, 01) is represented as the following. The optical power for transmitting each of the symbols is proportional to squared distance from an origin the phase plane to each of signal points (E through H).

Math 6

When appearance ratio of each of the symbols (00, 10, 11, 01) is W_{E}, W_{F}, W_{G} and W_{H}, the average optical power Pₐᵥₑ of the modulated optical signal is represented by the following equation (2).

Math 7

In the thirteenth embodiment, the mark rate of the data signal is adjusted so that the appearance ratio of each of the symbols is unequal. More specifically, when the mark rate of a data signal is adjusted so that the sum of the appearance ratio W_{E} of a symbol (00) and the appearance ratio W_{G} of a symbol (11) differs from the sum of the appearance ratio W_{F} of a symbol (10) and the appearance ratio W_{H} of a symbol (01), the average optical power Pₐᵥₑ is a function of “φ”. In other words, the average optical power of a modulated optical signal changes in response to the change in the amount of the phase shift φ by a phase shift unit. Therefore, feedback control over the phase shift unit is possible using the monitoring result acquired from monitoring of the average optical power of a modulated optical signal.

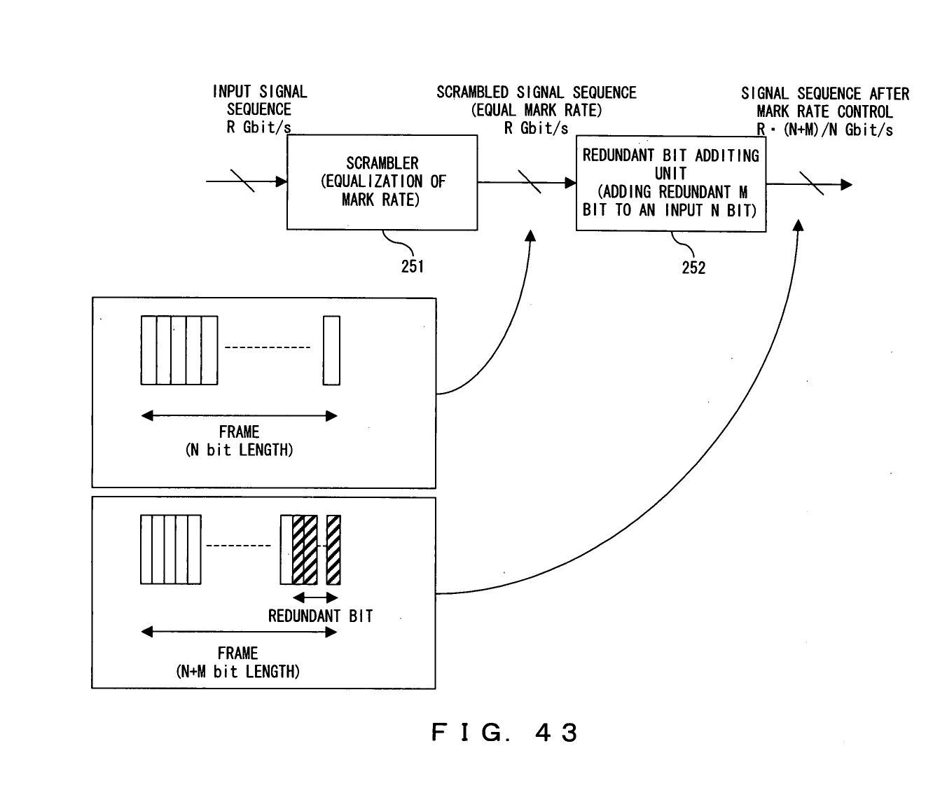

FIG. 43 is a diagram explaining a brief overview of a method for controlling a mark rate of a data signal. The control of a mark rate is performed in a driving signal generation unit, for example.

The data signal (input signal sequence) has its mark rate equalized by a scrambler 251. By so doing, the appearance ratio of each symbol (00, 10, 11, 01) is controlled to be approximately equal. A technique for equalizing a mark rate of a data signal is a publicly known technique.

A redundant bit adding unit 252 adds redundant bit to a data signal scrambled by the scrambler 251. At that time, the redundant bit with M bit is added to data signal with N bit. Therefore, the data rate increases by (N+M)/N times. As the redundant bit, a value generating a particular symbol (“00” or “11”, for example) is used. By so doing, the average optical power Pₐᵥₑ of the modulated optical signal is function of the amount of the phase shift φ, and feedback control of the phase shift unit is possible with the average optical power as a parameter.

Each of the functions shown as the twelfth and the thirteenth embodiment is applied to the optical transmitting apparatus of the first through the eighth embodiments, and can be also applied to an optical transmitting apparatus, which does not use a low-frequency signal.

<<Optical Receiving Apparatus>>

An explanation of an optical receiving apparatus relating to the present invention is described.

<DQPSK Modulation Receiving Apparatus>

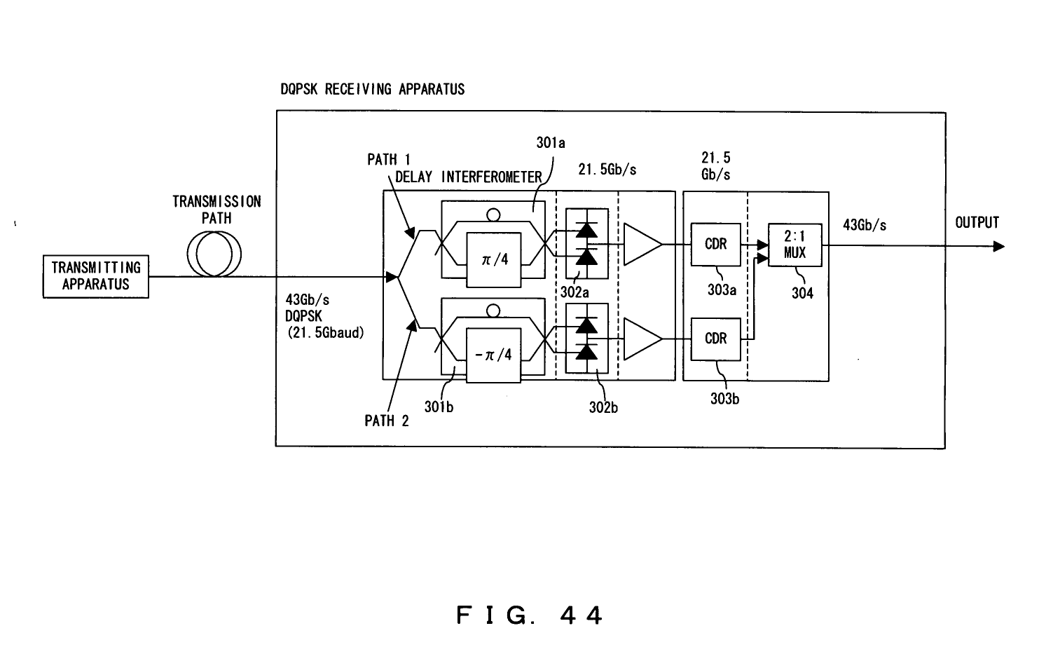

FIG. 44 is a diagram describing a configuration of an optical receiving apparatus of an embodiment of the present invention. The optical receiving apparatus receives a DQPSK-modulated optical signal, and demodulates the signal. In this example the speed of the data transmitted by the optical signal is 43 Gbps, for example, and the symbol rate is 21.5 G.

In FIG. 44, the input optical signal is split, and guided to a first path and a second path. An interferometer 301 (301a and 301b) is provided on each of the first and the second path. The interferometer 301 is a Mach-Zehnder delay interferometer, for example. The interferometer 301 comprises a first arm and a second arm. Here, the first arm of the interferometer 301 delays the optical signal by 1 symbol time. However, the second arm of the interferometer 301a shifts the phase of the optical signal by “+π/4”, and the second arm of the interferometer 301b shifts the phase of the optical signal by “−π/4”. The amount of phase shift of each of the second arm is controlled by bias voltage.

An O/E converter circuit 302 (302a and 302b) converts an optical signal output from a corresponding interferometer 301 into an electrical signal. In this example, a pair of photodiodes (twin-photodiodes) constitutes each of the O/E converter circuit 302. When a pair of optical signals output from the interferometer 301 is provided to a pair of photodiodes, the O/E converter circuit 302 outputs a differential reception signal indicating the difference in the current generated by a pair of the photodiodes.

CDR (Clock Data Recovery) circuit 303 (303a and 303b) recovers a clock signal and a data signal from the output signal from the corresponding O/E converter circuit 302. A multiplexer 304 multiplexes the output signals of the CDR circuits 303a and 303b. By so doing, demodulated data can be obtained. The configuration and the operation of this optical receiving apparatus are described in, for example, Japanese publication of translated version No. 2004-516743.

In order to recover the data from an optical signal received in the optical receiving apparatus with the above configuration, it is required that the amount of the phase shift of the second arm of each interferometer 301 should be adjusted to exactly “+π/4” or “−π/4”. In the following description, a configuration and operation for adjusting the amount of the phase shift are explained.

### First Embodiment

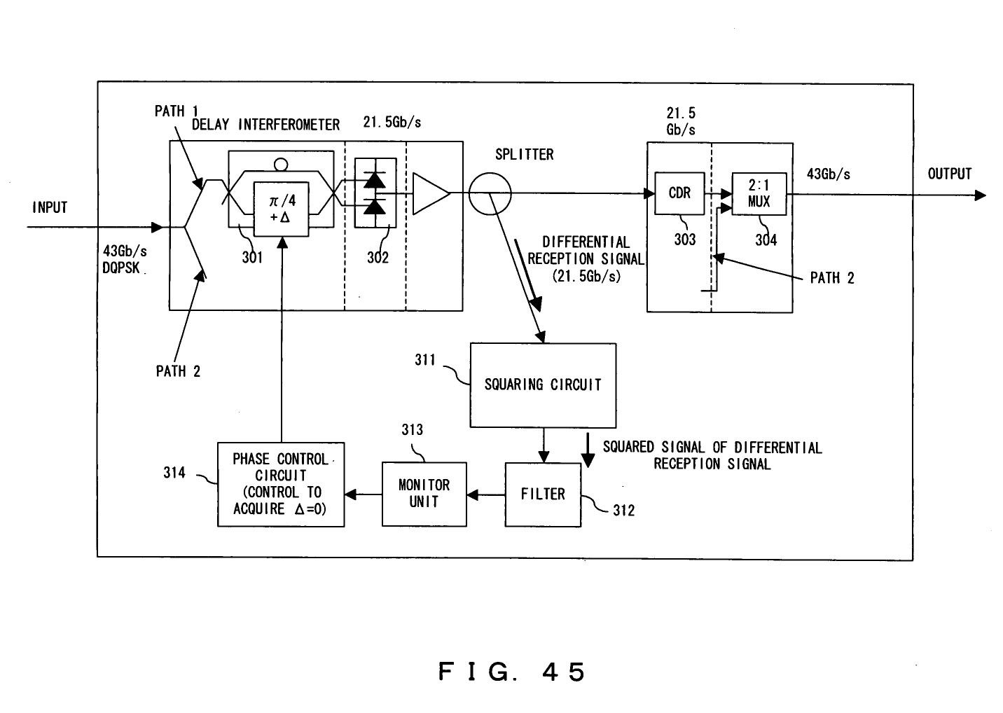

FIG. 45 is a diagram describing an optical receiving apparatus of the first embodiment. The optical receiving apparatus in the first embodiment comprises a squaring circuit 311, a filter 312, a monitor unit 313 and a phase control circuit 314. The configuration on the second path is basically the same as the configuration on the first path, and thus the description of the second path is hereinafter omitted.

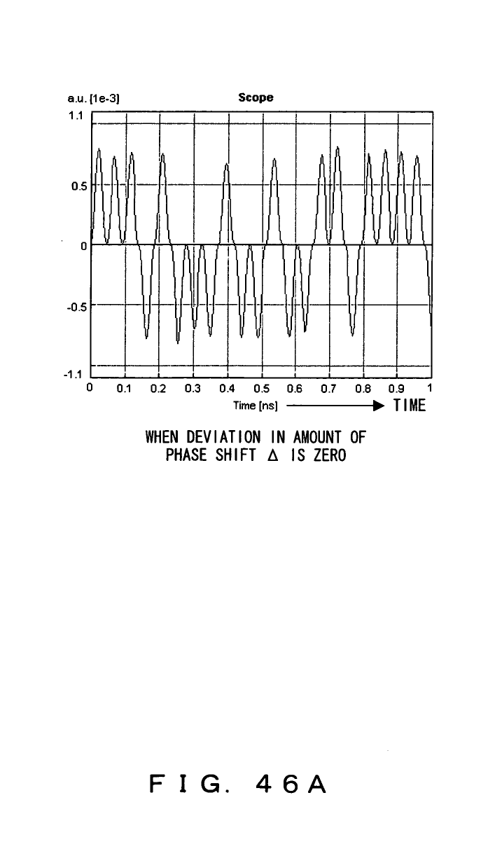

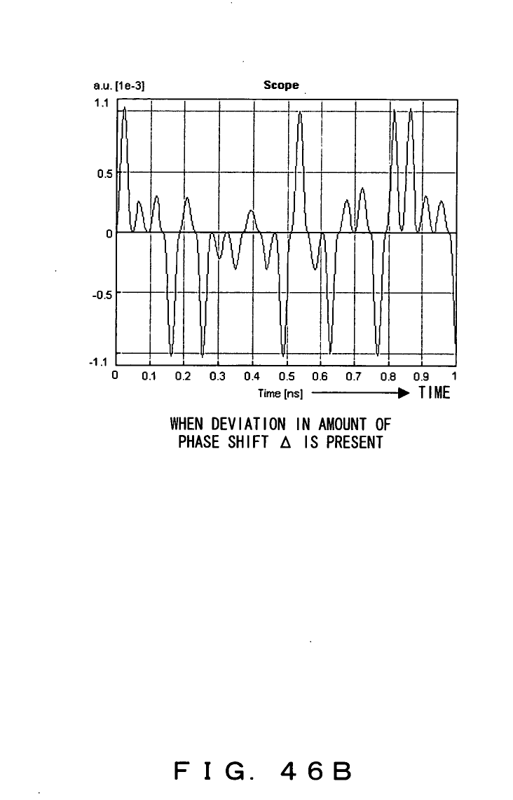

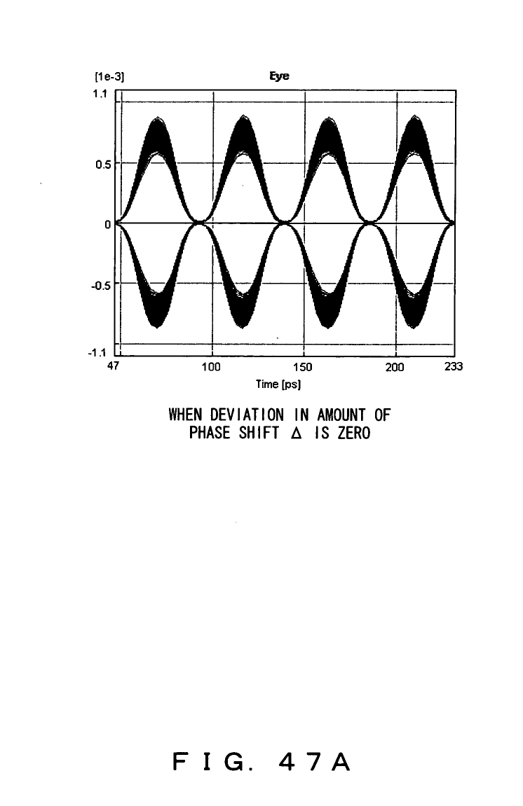

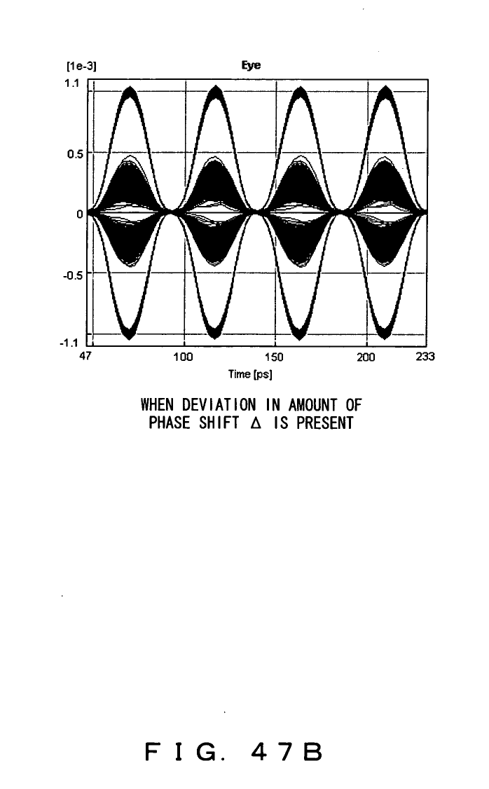

FIG. 46A and FIG. 46B are diagrams showing waveforms of the differential reception signal output from the O/E converter circuit 302. FIG. 47A and FIG. 47B are diagrams showing an eye diagram (eye pattern) of the differential reception signal. If the amount of the phase shift on the second arm is exactly the “π/4”, the differential reception signal shows stable waveform as in FIG. 46A, and the eye diagram with wide eye aperture, as shown in FIG. 47A, can be acquired. However, when the amount of the phase shift deviates from “π/4”, the waveform of the differential reception signal becomes unstable as shown in FIG. 46B, and the eye aperture of the eye diagram is small as indicated in FIG. 47B. FIG. 46B and FIG. 47B, incidentally, are simulation results when the amount of the phase shift is “π/4+Δ (Δ=30 degrees)”.

The squaring circuit 311 squares the differential reception signal output from the O/E converter circuit 302. The squaring circuit 311 is not limited in particular, but can be realized by an analog multiplier circuit including a Gilbert cell, for example. In such a case, by multiplying the differential reception signals one another using the analog multiplier circuit, squared signal of the differential reception signal can be acquired.

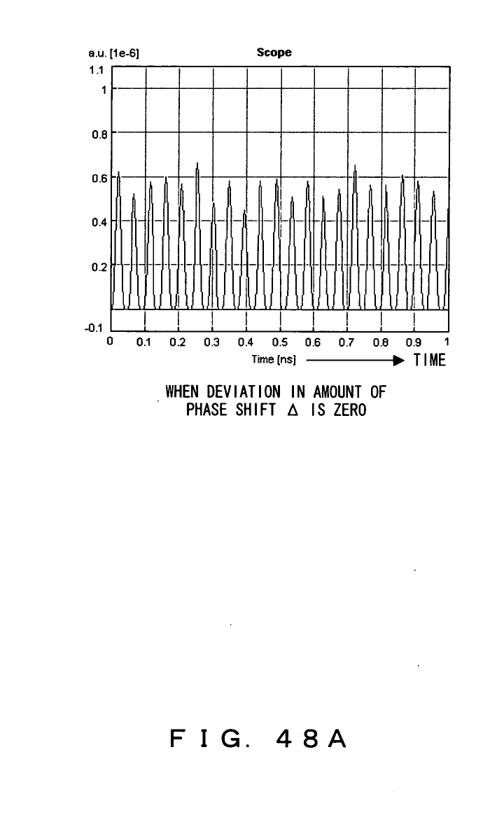

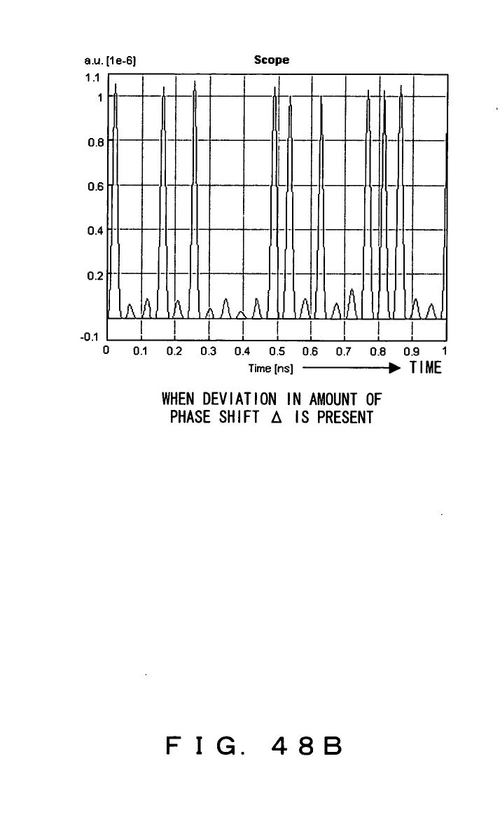

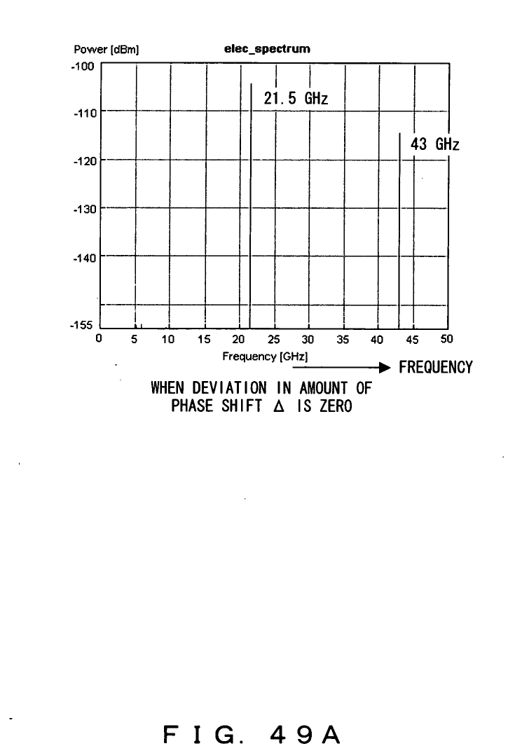

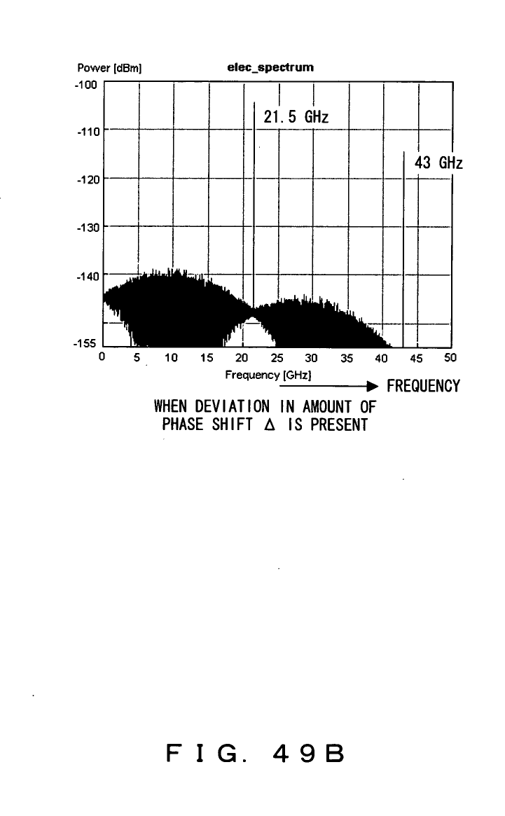

FIG. 48A and FIG. 48B are diagrams indicating the waveform of the squared signal output from the squaring circuit 311. FIG. 49A and FIG. 49B are diagrams showing spectrum of the squared signal. When the amount of the phase shift in the second arm is exactly “π/4”, the squared signal has a waveform in which a substantially constant value appears within a symbol period as shown in FIG. 48A. Thus, in this case, only a symbol frequency component (21.5 GHz in this example) and its higher harmonic components in the spectrum of the squared signal appear. On the other hand, when the amount of the phase shift deviates from “π/4”, the squared signal has waveforms in which various values appear in a random period, as shown in FIG. 48B. Consequently, in such a case, the spectrum of the squared signal contains various frequency components, as shown in FIG. 49B.

The filter 312 transmits at least a part of continuous frequency components except for the frequencies, which are integral multiples of the symbol frequencies. In other words, the filter 312 is a low-pass filter (or a bandpass filter) for transmitting frequencies lower than the symbol frequency (21.5 GHz in this example), for example, and it filters the squared signal output from the squaring circuit 311. The monitor unit 313 monitors the power of output signal from the filter 312. The phase control circuit 314 controls the amount of the phase shift of the second arm of the interferometer 301, according to the monitoring result of the monitor unit 313. The amount of the phase shift is controlled by bias voltage, for example, provided to the second arm.

In the above configuration, when deviation of the amount of the phase shift in the second arm is zero (i.e. the amount of the phase shift by the phase shift unit is exactly “π/4”), the squared signal contains the symbol frequency component and its higher harmonic components alone. In such a case, the power detected by the monitor unit 313 is close to zero. Meanwhile, when deviation of the amount of the phase shift occurs, the squared signal contains various frequency components (especially low-frequency components). In this case, the power detected by the monitor unit 313 depends on the deviation value of the phase shift. Thus, when the feedback control is performed so as to minimize the power detected by the monitor unit 313, the amount of the phase shift should be kept at “π/4”.

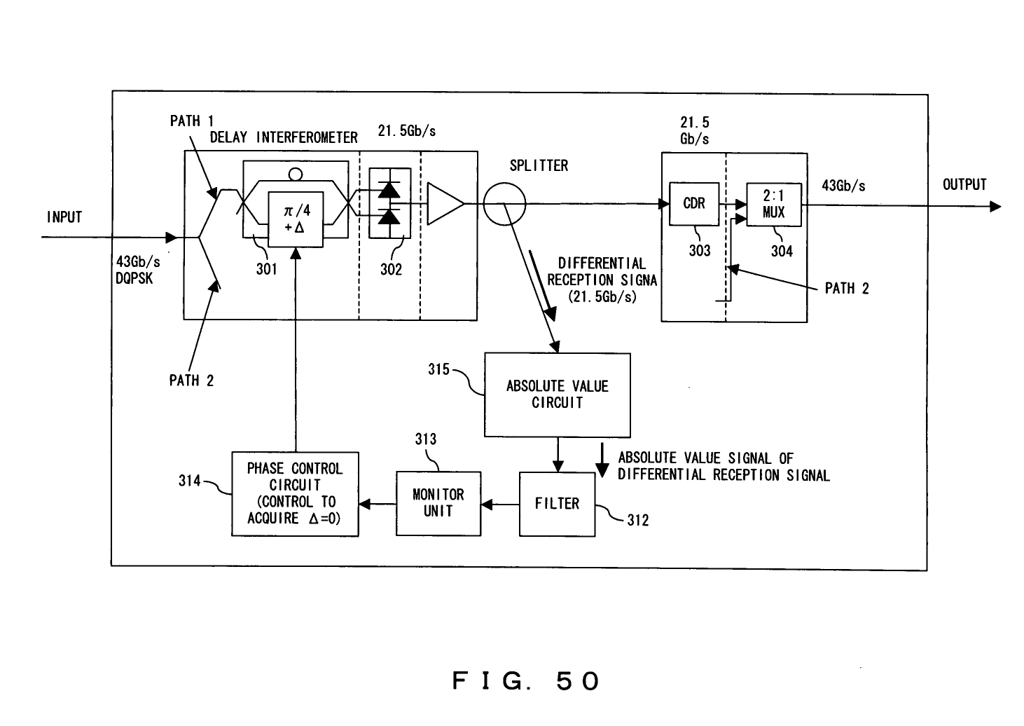

FIG. 50 is a diagram showing a modified example of the optical receiving apparatus shown in FIG. 45. The configuration of the optical receiving apparatus described in FIG. 50 is basically the same as the optical receiving apparatus shown in FIG. 45. However, the optical receiving apparatus comprises an absolute value circuit 315 instead of the squaring circuit 311.

The absolute value circuit 315 performs full-wave rectification on the differential reception signal output from the O/E converter circuit 302. The absolute value circuit 315 is not limited in particular, but, for example, is realized by a full-wave rectification circuit comprising a plurality of diodes or a full-wave rectification circuit formed using an operational amplifier.

The Filter 312, the monitor unit 313, the phase control circuit 314 are basically the same as ones in the optical receiving circuit described in FIG. 45. In this optical receiving apparatus also, when the feedback control is performed so as to minimize the power detected by the monitor unit 313, the amount of the phase shift should be kept at “π/4”.

### Second Embodiment

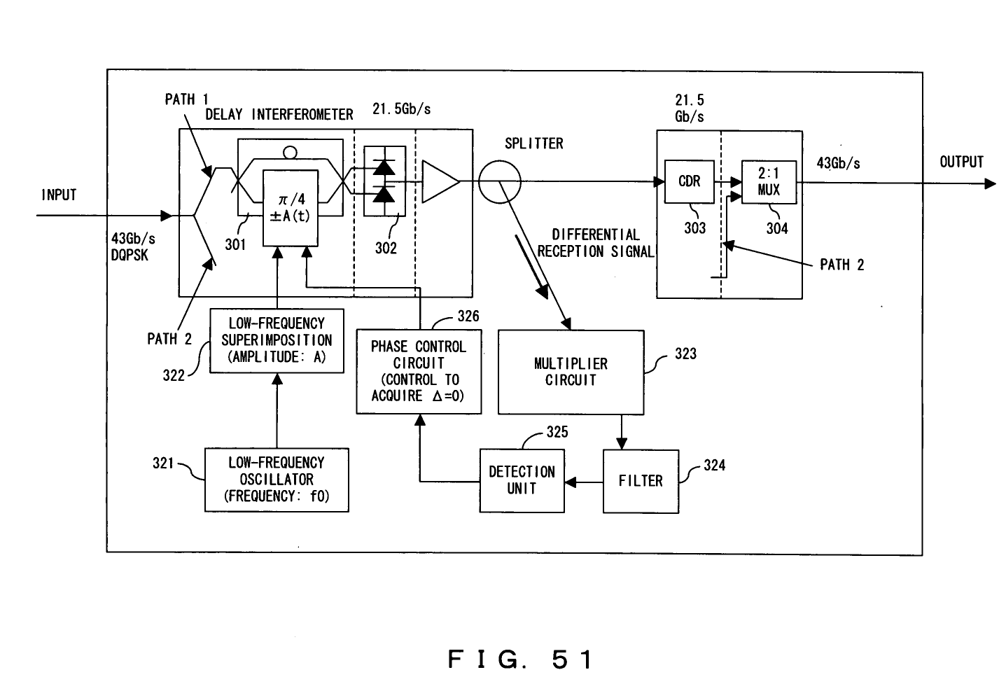

FIG. 51 is a diagram describing a configuration of the optical receiving apparatus of the second embodiment. The optical receiving apparatus of the second embodiment has a configuration for adjusting the amount of the phase shift using a low-frequency signal.

In FIG. 51, a low-frequency oscillator 321 generates a low-frequency signal, for example, in a frequency range between several kHz and several MHz. In the following description, the frequency of the low-frequency signal is defined as “f₀”. The low-frequency signal is provided to the second arm of the interferometer 301 via a low-frequency superimposing circuit 322. For that reason, the amount of the phase shift in the second arm changes periodically in response to the voltage of the low-frequency signal. Therefore, the optical signal output from the interferometer 301 or the differential reception signal output from the O/E converter circuit 302 comprises the f₀ component.

The multiplier circuit 323 multiplies the differential reception signals output from the O/E converter circuit 302 one another as in the case of the above squaring circuit 311. The filter 324 is a low-pass filter, which transmits the frequency 2f₀, and filters the output signal from the multiplier circuit 323. The detection unit 325 detects the f₀ component and/or the 2f₀ component from the output of the filter 324 by synchronous detection using the low-frequency signal. The phase control circuit 326 controls the amount of the phase shift of the second arm of the interferometer 301 according to the detection result of the detection unit 325. The amount of the phase shift is controlled by bias voltage, for example, provided to the second arm.

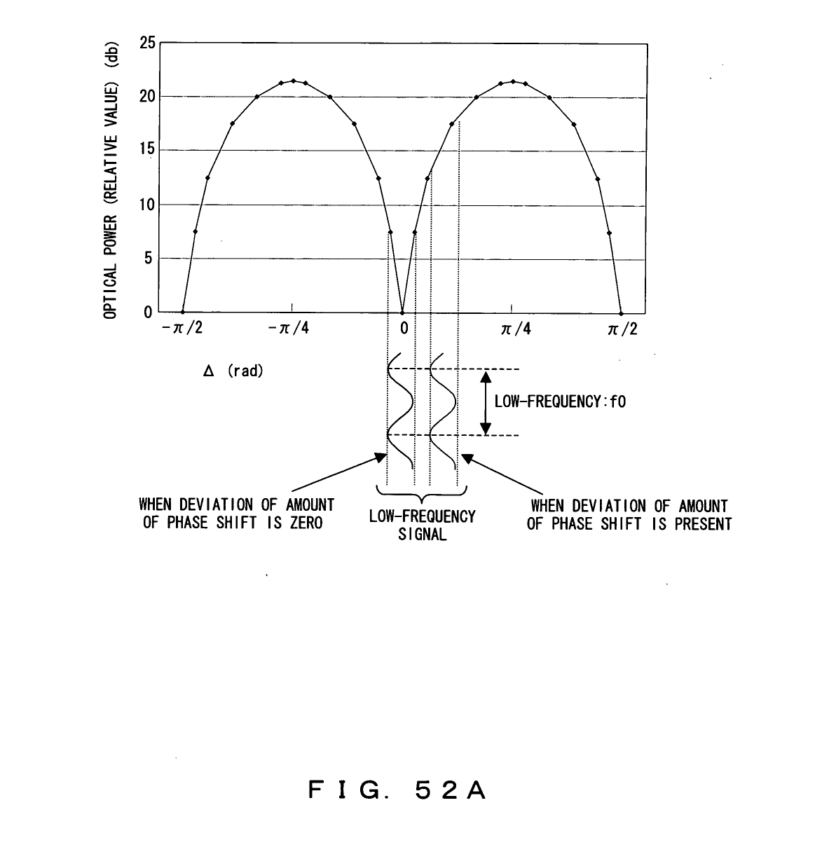

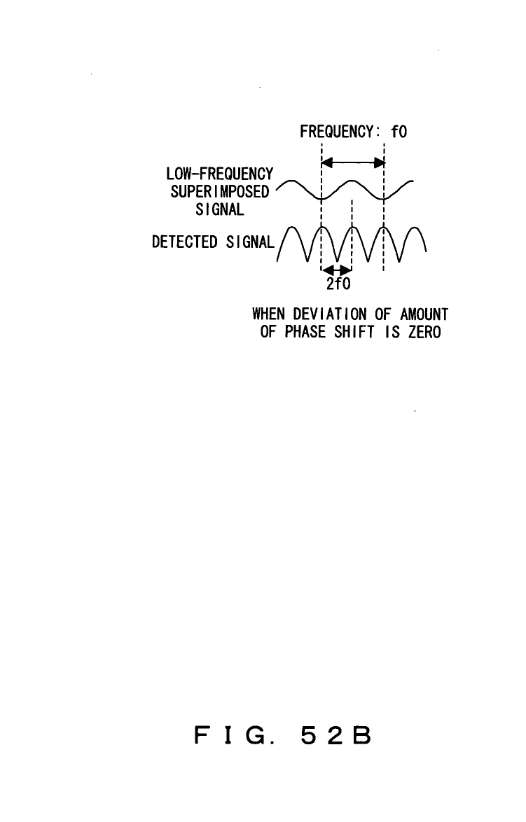

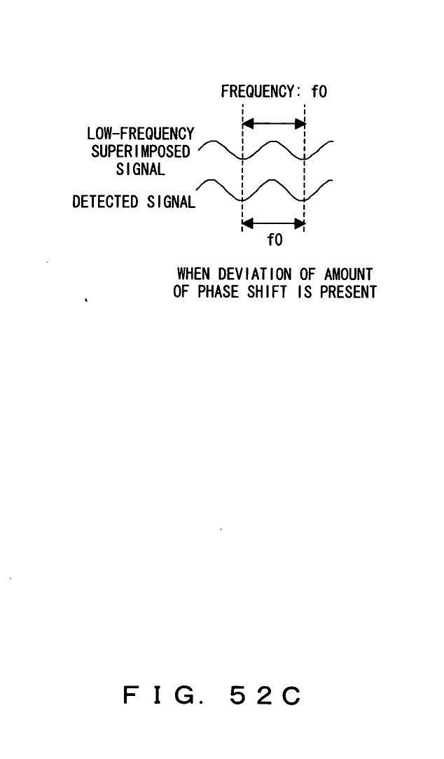

FIG. 52A through FIG. 52C explain the principle of operation of the optical receiving apparatus of the second embodiment. FIG. 52A shows a relation between the amount of the phase shift in the second arm and the optical power (relative value) of the output of the interferometer 301. In this figure, the horizontal axis indicates deviation from the “π/4”. When the amount of the phase shift controlled by the phase shift circuit 326 is exactly “π/4”, the amount of the phase shift, while the low-frequency signal is superimposed, periodically changes around the point where the optical power has its minimum value. Consequently, in such a case, the 2f₀ component is generated as shown in FIG. 52B. On the other hand, when the amount of the phase shift deviates from “π/4”, the amount of the phase shift, while the low-frequency signal is superimposed, periodically changes in a region away from the point where the optical power has its minimum value. Thus, in such a case, the 2f₀ component is not generated, and the f₀ component alone is acquired as shown in FIG. 52C.

The optical receiving apparatus of the second embodiment optimizes the amount of the phase shift in the second arm using the above principle of operation. In other words, the phase control circuit 326 performs the feedback control so that the power of the 2f₀ component detected by the detection unit 325 reaches maximum. Alternatively, the phase control circuit 326 performs the feedback control so that the power of the f₀ component detected by the detection unit 325 is its minimum. By so doing, the amount of the phase shift in the second arm is kept at “π/4”.

### Third Embodiment

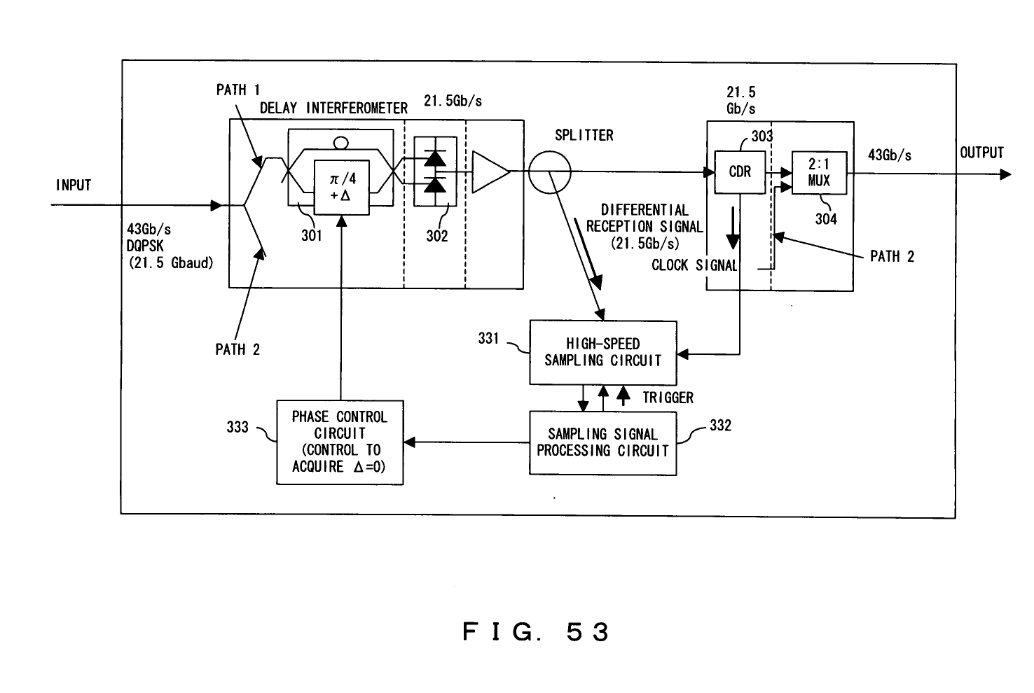

FIG. 53 is a diagram describing a configuration of the optical receiving apparatus of the third embodiment. The optical receiving apparatus of the third embodiment adjusts the amount of the phase shift by using statistical processing on the received signal.

In FIG. 53, a high-speed sampling circuit 331 samples the differential reception signal output from the O/E converter circuit 302. The sampling timing is determined by a clock signal generated by the CDR circuit 303 and a trigger signal from a sampling signal processing circuit 332. Specifically, the sampling is performed, for example, in the symbol period or in a period, which is integral multiple of the symbol period.

The sampling signal processing circuit 332 calculates occurrence frequency of each sampling value acquired from the sampling. The phase control circuit 333 controls the amount of the phase shift of the second arm of the interferometer 301 in accordance with the occurrence frequency information acquired by the sampling signal processing circuit 332. The amount of the phase shift is controlled by, for example, bias voltage provided to the second arm.

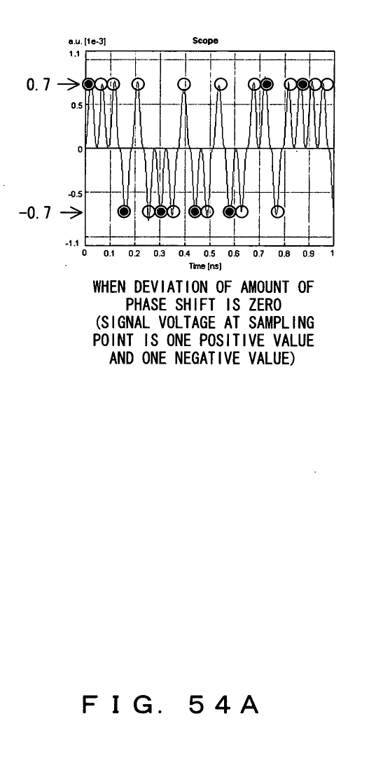

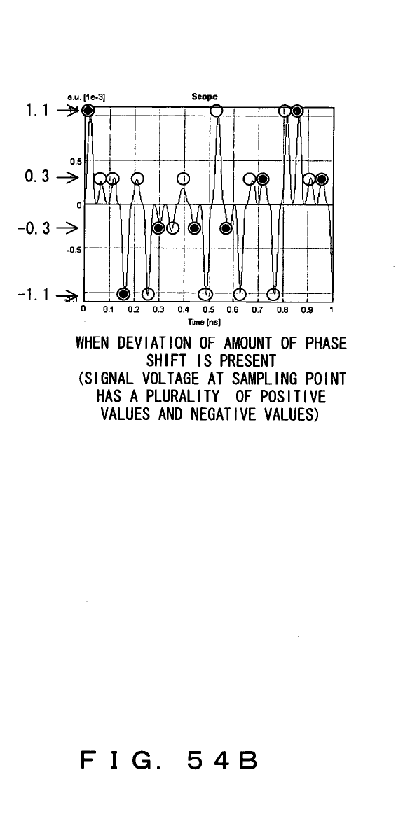

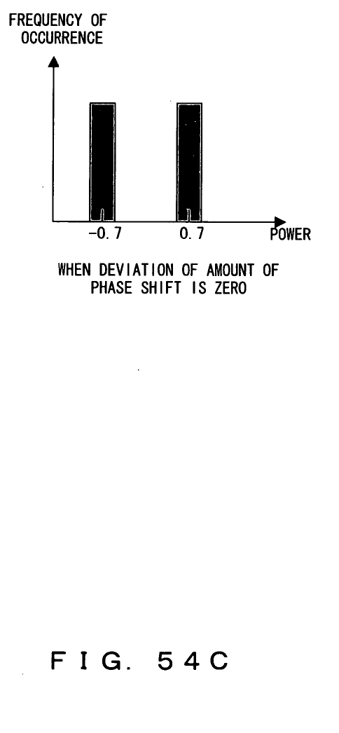

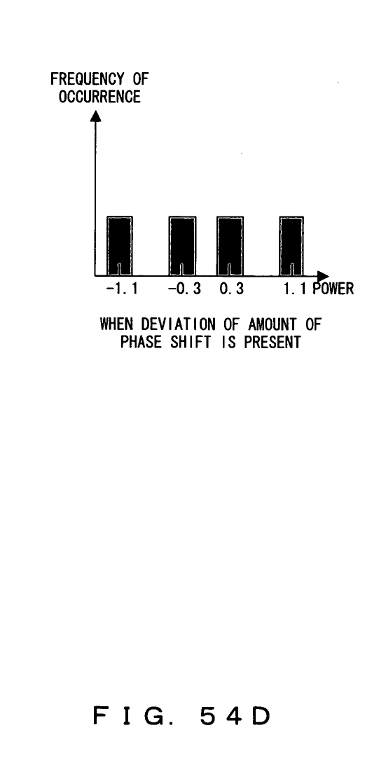

FIG. 54A and FIG. 54B shows an example of sampling operation by the high-speed sampling circuit 331. In this example, the sampling is performed in a period three times longer than the symbol period. In a case that the amount of the phase shift is exactly “π/4”, the signal voltage value acquired by the sampling is only one positive value (+0.7) and one negative value (−0.7), as shown in FIG. 54A. On the contrary, in a case that the amount of the phase shift deviates from “π/4”, four or more signal voltage values are acquired by the sampling, as shown in FIG. 54B. In this example, four values (+1.1, +0.3, −0.3, −1.1) are acquired. FIG. 54C and FIG. 54D are examples of the processing result by the sampling signal processing circuit 332, and are corresponding to FIG. 54A and FIG. 54B, respectively.

The optical receiving apparatus of the third embodiment optimizes the amount of the phase shift in the second arm using the above principle of the operation. In other words, the phase control circuit 333 performs the feedback control so as to reduce the fluctuation of the signal voltage values (for example, to keep the signal voltage value at a particular two values). By so doing, the amount of the phase shift of the second arm is kept at “π/4”.

<DPSK (DBPSK) Receiving Apparatus>

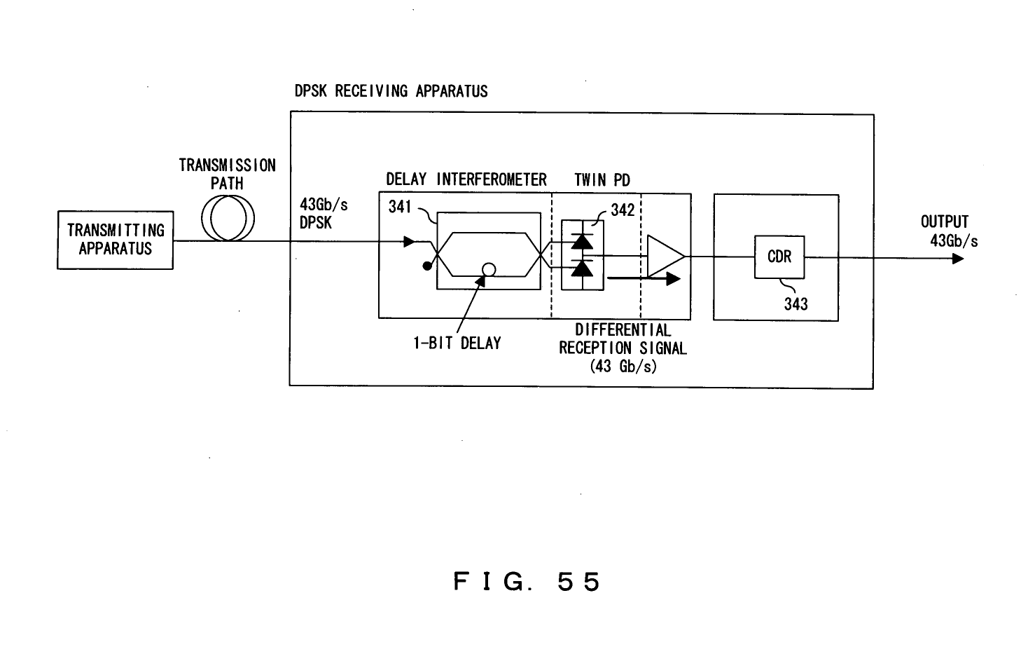

FIG. 55 is a diagram describing a configuration of the optical receiving apparatus for receiving the DPSK modulated signal. In FIG. 55, the input optical signal is guided to an interferometer 341. The interferometer 341 is, for example, a Mach-Zehnder delay interferometer, and comprises a first arm and a second arm. The second arm of the interferometer 341 provides 1-bit delay to the optical signal. The delay time in the second arm is the difference between the time period in which the optical signal is transmitted via the first arm and the time period in which the optical signal is transmitted via the second arm, and is controlled by bias voltage.

An O/E converter circuit 342 converts the optical signal output from the interferometer 341 into an electrical signal. The O/E converter circuit 342 is the same as the O/E converter circuit 302 shown in FIG. 44, and outputs a differential reception signal corresponding to the optical signal. Here, bit rate of the differential reception signal is 43 Gbps. The CDR circuit 343 recovers and outputs the clock signal and the data signal from the output signal of the O/E converter circuit 342.

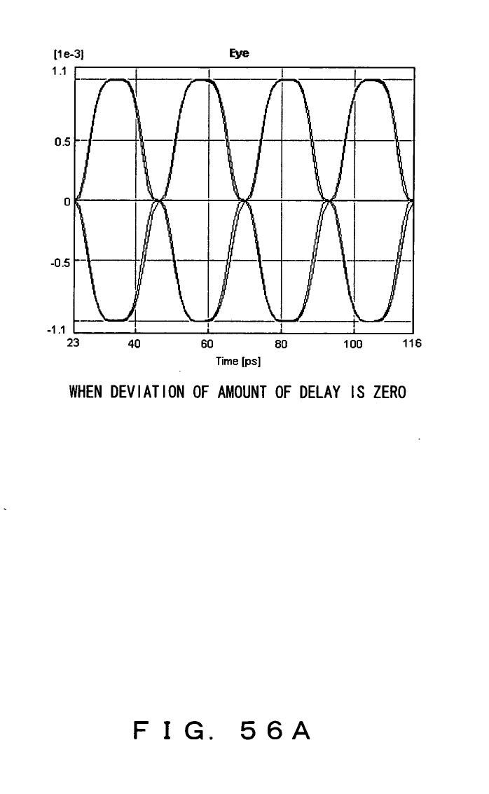

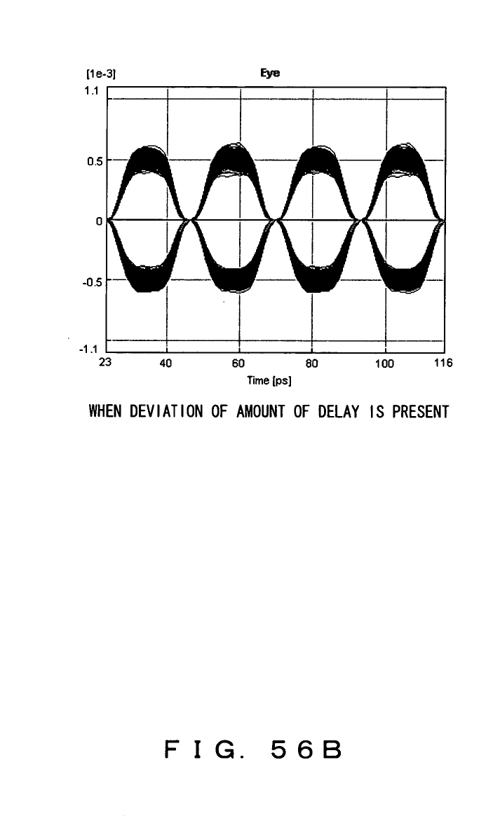

In order to regenerate data from the optical signal received in the optical receiving apparatus of the above configuration, it is required that the delay time of the second arm of the interferometer 341 is adjusted exactly to “1 bit”. In other words, if the delay time is adjusted exactly to “1 bit”, then the eye diagram (eye pattern) with wide eye aperture shown in FIG. 56A can be acquired; however, if the delay time deviates from “1 bit”, the eye aperture of the eye diagram becomes small as shown in FIG. 56B. When the eye aperture of the eye diagram is small, the possibility of the occurrence of bit error increases. In the following description, a configuration and operation for adjusting the delay time are explained.

### Fourth Embodiment

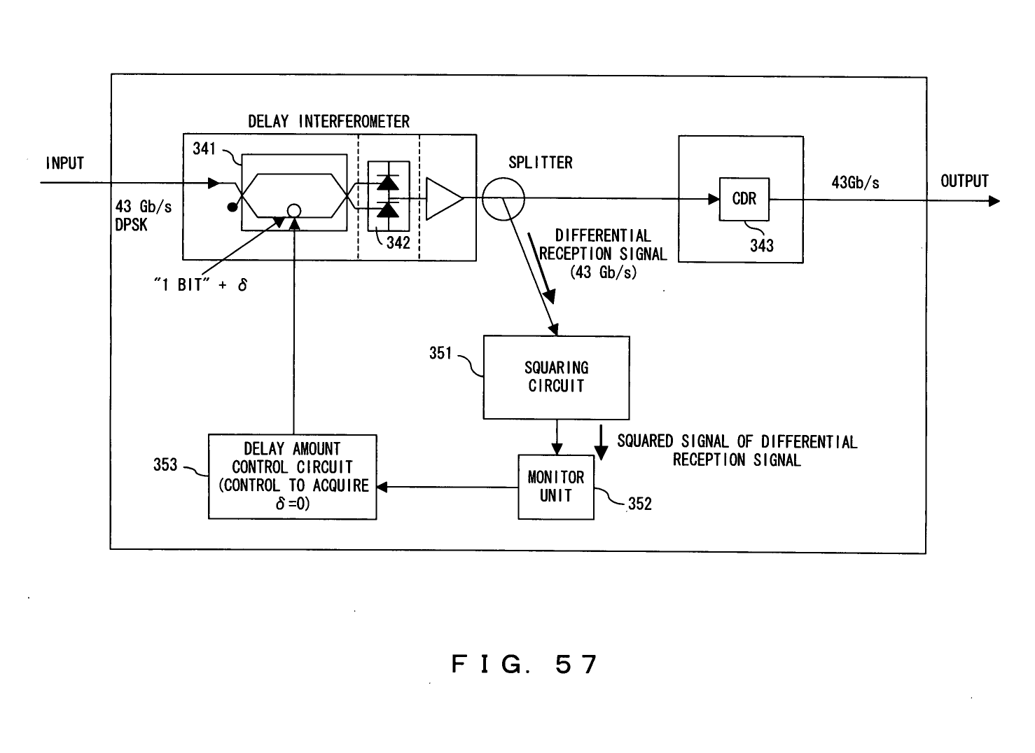

FIG. 57 is a diagram describing a configuration of the optical receiving apparatus of the fourth embodiment. In FIG. 57, a squaring circuit 351 generates a squared signal by multiplying the differential reception signals output from the O/E converter circuit 342 by one another. The squaring circuit 351 is basically the same as the squaring circuit 311 in the first embodiment. A monitor unit 352 acquires an average of the squared signals in time domain by integration. A delay control circuit 353 controls the delay time of the second arm of the interferometer 341 in accordance with the average value acquired by the monitor unit 352. The delay time is controlled by, for example, bias voltage provided to the second arm.

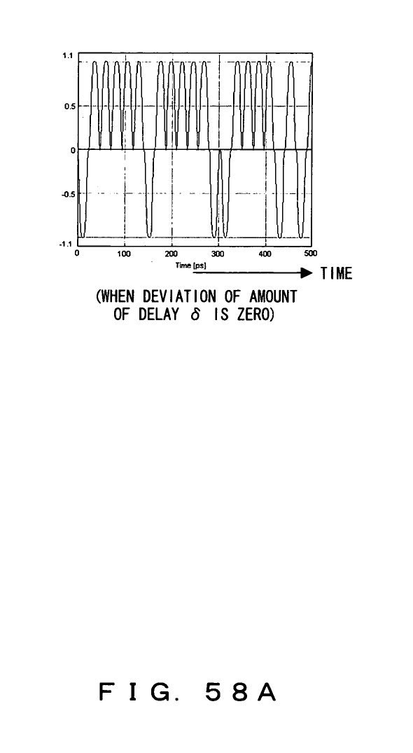

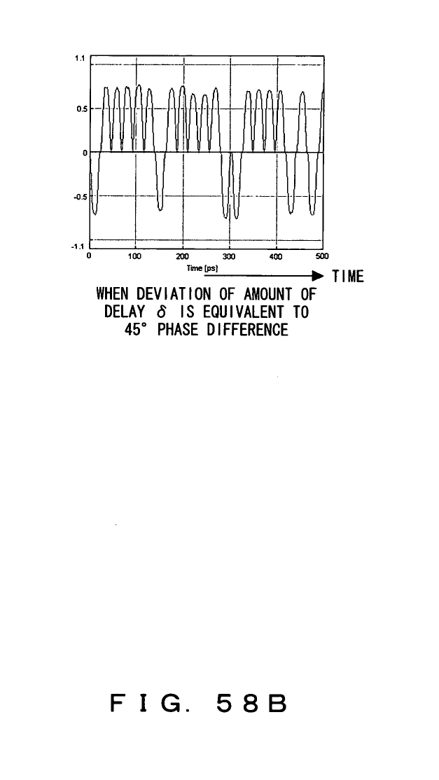

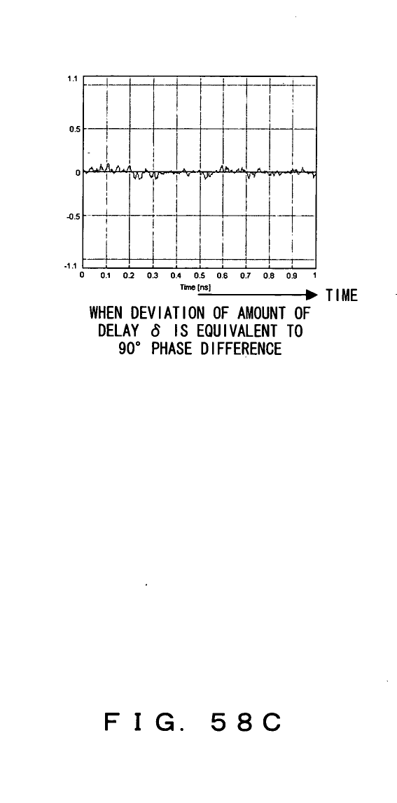

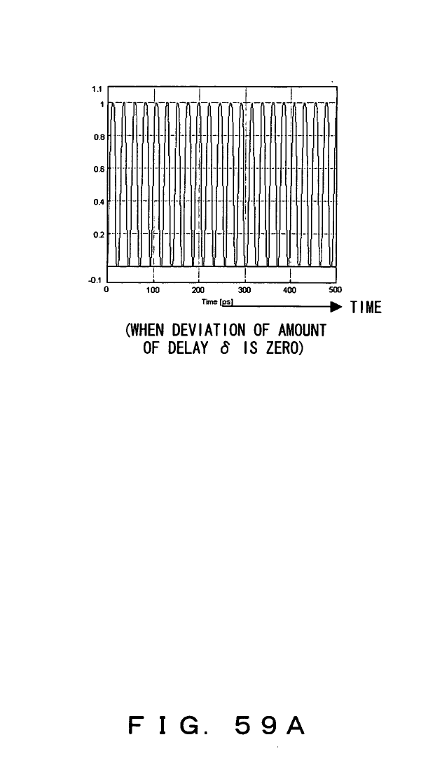

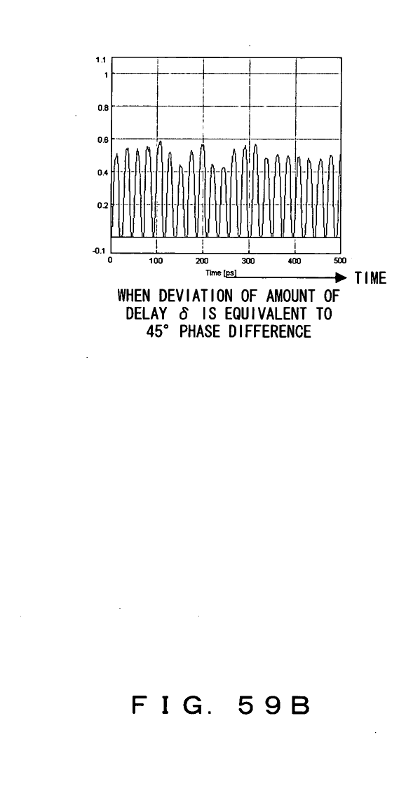

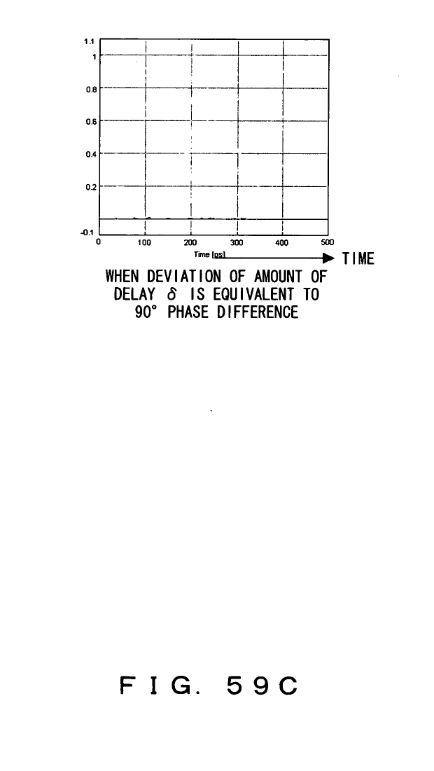

FIG. 58A through FIG. 58C show the waveform of the differential reception signal. FIG. 59A through FIG. 59C show waveform of the squared signals acquired by squaring the differential reception signal. When the delay time is adjusted properly, as shown in FIG. 58A and FIG. 59A, the amplitudes of the differential reception signal and the squared signal becomes large. In other words, in such a case, the average power of the squared signal becomes large. On the other hand, when deviation in delay time occurs, as shown in FIG. 58B, FIG. 58C, FIG. 59B and FIG. 59C, the amplitudes of the differential reception signal and the squared signal becomes small. In such a case, then, the average power of the squared signal is also small.

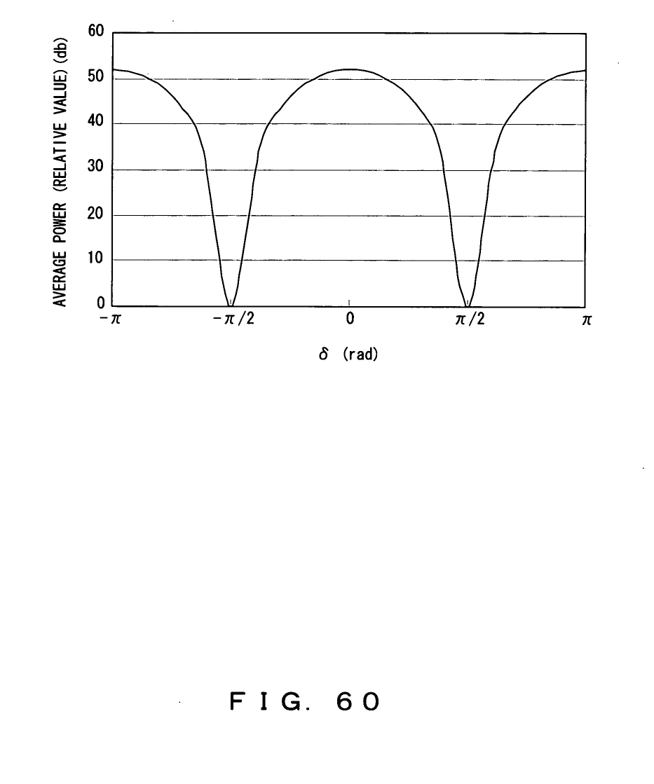

FIG. 60 describes a relation between the amount of deviation of the delay time and the average power of the squared signal. As shown in FIG. 60, when “amount of deviation δ” of the delay time is zero, the average power of the squared signal reaches its maximum. As the “amount of deviation δ” becomes large, the average power of the squared signal becomes small. However, the average power of the squared signal changes periodically as “amount of deviation δ” changes.

The optical receiving apparatus of the fourth embodiment optimizes the delay time in the second arm using the above principle of operation. In other words, the delay control circuit 353 performs the feedback control so that the average power of the squared signal acquired by the monitor unit 352 reaches its maximum. By so doing, the delay time in the second arm is kept at “1 bit”.

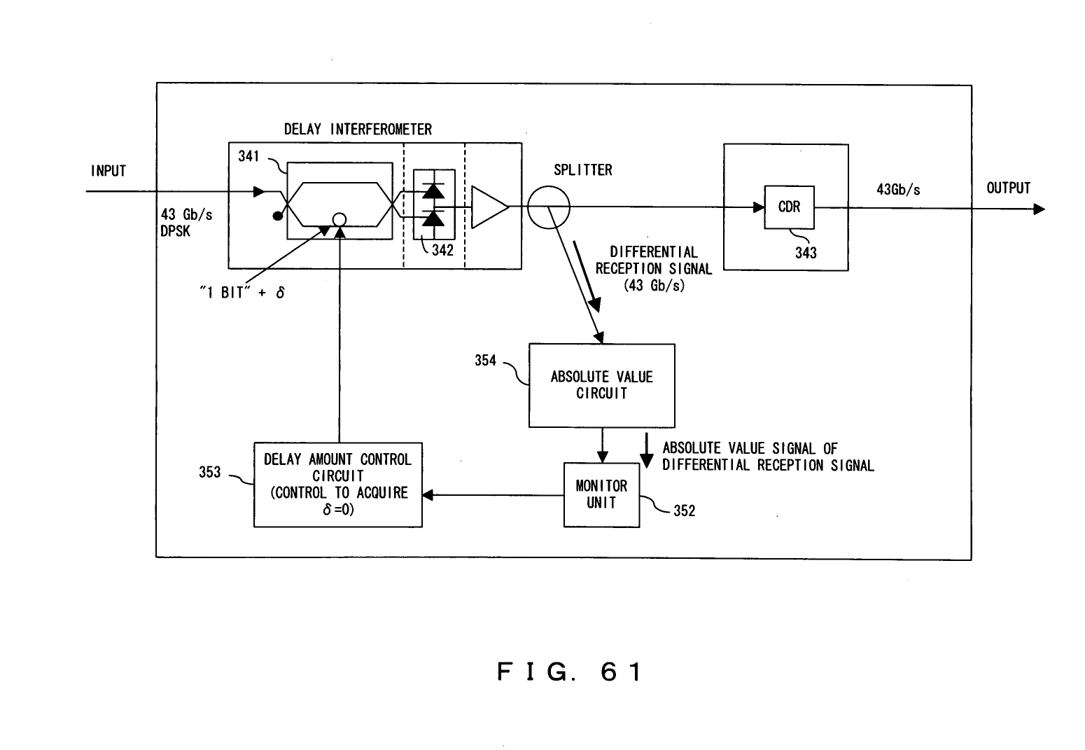

FIG. 61 is a diagram describing a modified example of the optical receiving apparatus shown in FIG. 57. The configuration of the optical receiving apparatus in FIG. 61 is basically the same as that of the optical receiving apparatus in FIG. 57. However, this optical receiving apparatus comprises an absolute value circuit 354 instead of the squaring circuit 351. The operation and the configuration comprising the absolute value circuit 354 instead of the squared circuit 351 are basically the same as the explanation of the first embodiment.

### Fifth Embodiment

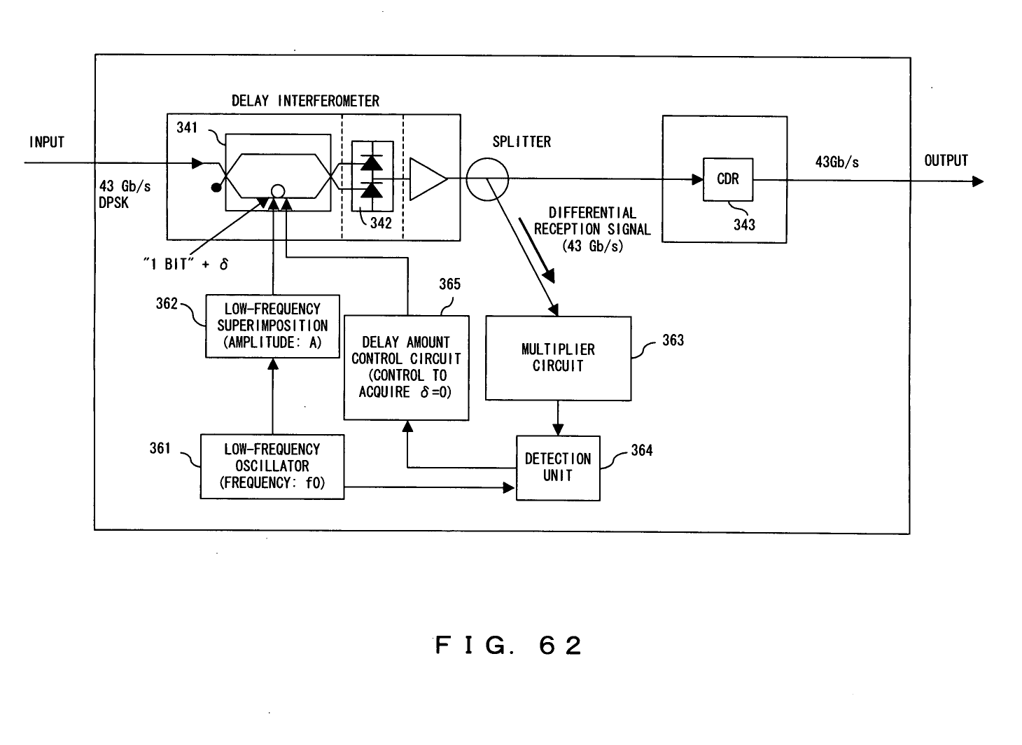

FIG. 62 is a diagram describing a configuration of the optical receiving apparatus of the fifth embodiment. In FIG. 62, operation of a low-frequency oscillator 361, a low-frequency superimposing circuit 362, a multiplier circuit 363, a detection unit 364 is basically the same as those in the second embodiment. In other words, the low-frequency signal f₀ is provided to the second arm of the interferometer 341, and the detection unit 364 detects the f₀ component and/or the 2f₀ component. The delay control circuit 365 controls the delay time of the second arm of the interferometer 341 in accordance with the detection result of the detection unit 364.

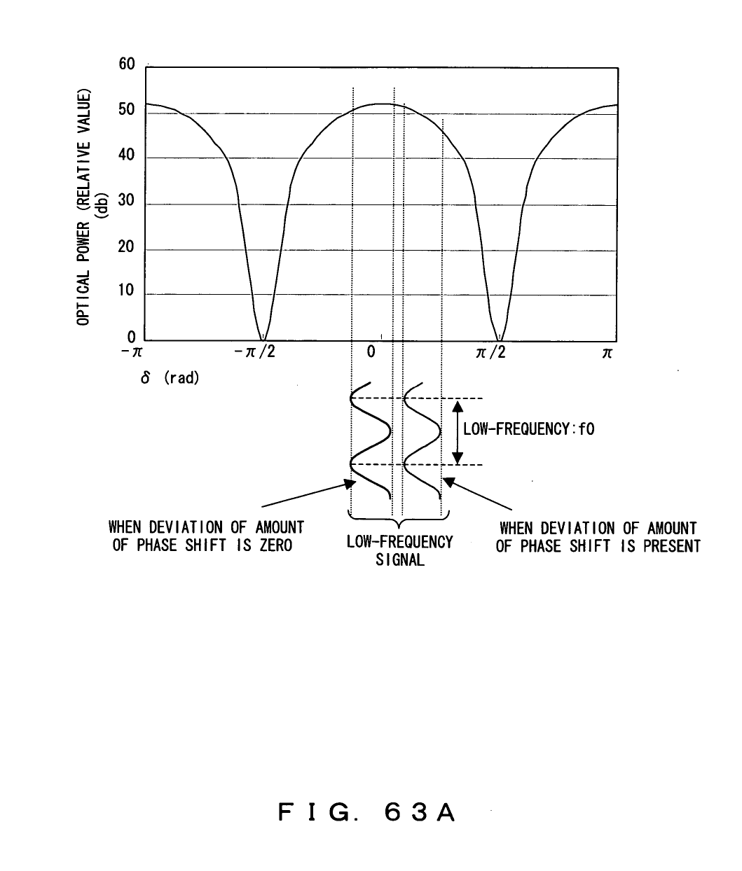

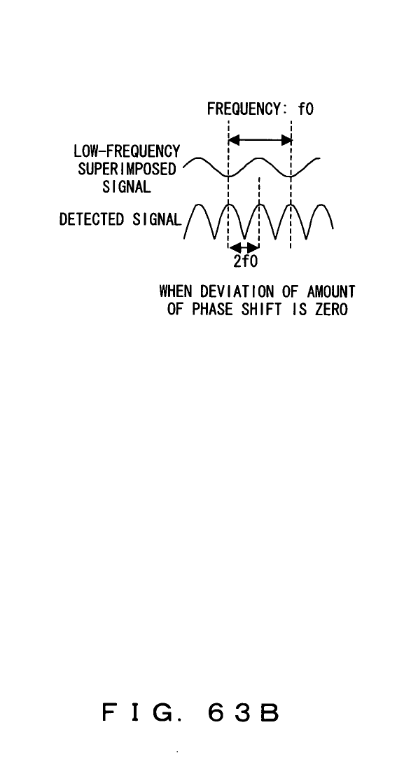

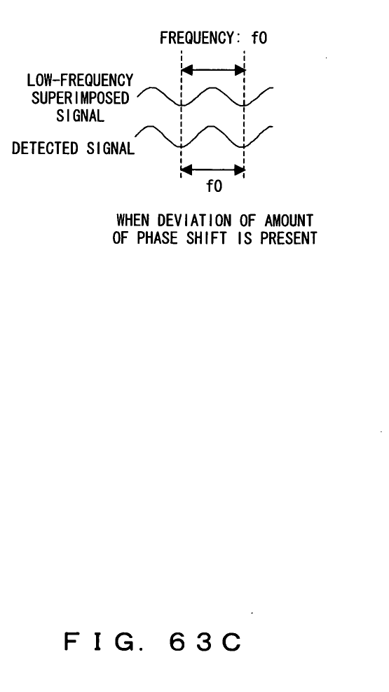

FIG. 63A through FIG. 63C explain the principle of operation of the optical receiving apparatus of the fifth embodiment. FIG. 63A shows a relation between the delay time in the second arm and the optical power (relative value) of the output of the interferometer 341. In this figure, the horizontal axis indicates deviation from the “1 bit”. In a case that the delay time controlled by the delay control circuit 365 is exactly “1 bit”, the 2f₀ component is generated as shown in FIG. 63B. On the other hand, in a case that the delay time deviates from “1 bit”, the 2f₀ component is not generated; however, the f₀ component alone is acquired as shown in FIG. 63C.

The optical receiving apparatus of the fifth embodiment optimizes the delay time in the second arm using the above principle of operation. In other words, the delay control circuit 365 performs the feedback control so that the power of the 2f₀ component detected by the detection unit 364 can reach its maximum. Alternatively, the delay control circuit performs the feedback control so that the power of the f₀ component detected by the detection unit 364 becomes its minimum. By so doing, the delay time in the second arm is kept at “1 bit”.

What is claimed is:

1. An optical transmitting apparatus for transmitting an optical signal modulated corresponding to a data signal, comprising:
a phase shift unit for controlling a phase of at least one of a first optical signal and a second optical signal, acquired by splitting an optical input, so that the first and the second optical signals have a predetermined phase difference on an optical waveguide;
a data modulation unit for modulating the first and the second optical signals by using the data signal on the optical waveguide;
superimposing means for superimposing first and second low-frequency signals with a prescribed phase difference on the first and the second optical signals, respectively;
monitor means for monitoring at least one of maximum power, minimum power and phase of the low-frequency signal or a higher harmonic signal of the low-frequency signal, superimposed on a modulated optical signal acquired by coupling the first and second optical signals modulated by the data modulation unit; and
control means for controlling the phase shift unit based on an output of the monitor means.

2. An optical transmitting apparatus for transmitting an optical signal modulated corresponding to a data signal, comprising:
a phase shift unit for controlling a phase of at least one of a first optical signal and a second optical signal, acquired by splitting an optical input, so that the first and the second optical signals have a predetermined phase difference on an optical waveguide;
a data modulation unit for modulating the first and the second optical signals by using the data signal on the optical waveguide;
superimposing means for superimposing a low-frequency signal on either one of the first optical signal and the second optical signal;
monitor means for monitoring at least one of maximum power, minimum power and phase of the low-frequency signal or a higher harmonic signal of the low-frequency signal, superimposed on a modulated optical signal acquired by coupling the first and second optical signals modulated by the data modulation unit; and
control means for controlling the phase shift unit based on an output of the monitor means.

3. An optical transmitting apparatus comprising a phase modulator and a driving signal generation unit for driving the phase modulator, wherein
the phase modulator comprises a phase shift unit which provides a proper phase difference between a pair of split optical signals on an optical waveguide, a data modulation unit which performs a phase modulation of the optical signals on the split optical waveguide and an electrode for superimposing a low-frequency signal, and wherein
said optical transmitting apparatus further comprises:
low-frequency signal superimposing means for generating low-frequency signals with a proper phase difference and for providing the low-frequency signals to the electrode on the split optical waveguide;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

4. The optical transmitting apparatus according to claim 3, wherein the phase shift unit is configured in a former stage or a later stage of the data modulation unit.

5. The optical transmitting apparatus according to claim 3, wherein the monitor means comprises synchronous detection means for extracting and synchronously detecting a signal with twice of the frequency of the low-frequency signal from an O/E converter or peak power detection means for extracting a signal with the same frequency as the low-frequency signal from the O/E converter to detect peak power.

6. The optical transmitting apparatus according to claim 5, wherein the monitor means comprises the synchronous detection means and the peak power detection means.

7. An optical transmitting apparatus comprising a phase modulator and a driving signal generation unit for driving the phase modulator, wherein
the phase modulator comprises a phase shift unit which provides a proper phase difference between a pair of split optical signals on an optical waveguide, a data modulation unit with a data input unit on the split optical waveguide and an electrode, provided on a different optical waveguide from the optical waveguide where the phase shift unit is configured, for superimposing a low-frequency signal, and wherein
said optical transmitting apparatus further comprises:
low-frequency signal superimposing means for generating low-frequency signals with a proper phase difference and for providing the low-frequency signals to the electrode and on a bias input terminal of the phase shift unit;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

8. The optical transmitting apparatus according to claim 7, wherein the phase shift unit is configured in a former stage or a later stage of the data modulation unit.

9. An optical transmitting apparatus comprising a phase modulator and a driving signal generation unit for driving the phase modulator, wherein
the phase modulator comprises a phase shift unit which provides a proper phase difference between a pair of split optical signals on an optical waveguide and data modulation unit with a data input unit on a split optical waveguide, and wherein
said optical transmitting apparatus further comprises:
low-frequency signal superimposing means for generating low-frequency signals with a proper phase difference and for providing the low-frequency signal to the data input unit of the data modulation unit;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

10. An optical transmitting apparatus comprising a phase modulator and a driving signal generation unit for driving the phase modulator, wherein
the phase modulator comprises a phase shift unit which provides a proper phase difference between a pair of split optical signals on an optical waveguide and data modulation unit with a data input unit and a bias input unit on a split optical waveguide, and wherein
said optical transmitting apparatus further comprises:
low-frequency signal superimposing means for generating low-frequency signals with a proper phase difference and for providing the low-frequency signal to the bias input unit of the data modulation unit;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

11. The optical transmitting apparatus according to claim 9, wherein the phase shift unit is configured in a former stage or in a later stage of the data modulation unit.

12. The optical transmitting apparatus according to claim 9, wherein the monitor means comprises synchronous detection means for extracting and synchronously detecting a signal component with a frequency twice of the low-frequency signal from an O/E converter.

13. An optical transmitting apparatus comprising a phase modulator and a driving signal generation unit for driving the phase modulator, wherein
the phase modulator comprises a phase shift unit which provides a proper phase difference between a pair of split optical signals on an optical waveguide, a data modulation unit with a data input unit on a split optical waveguide, and an electrode, which is configured in a former stage of the data modulation unit, for superimposing a low-frequency signal, and wherein
said optical transmitting apparatus further comprises:
low-frequency signal superimposing means for generating low-frequency signals with a proper phase difference and for providing the low-frequency signals to the electrode;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

14. The optical transmitting apparatus according to claim 13, wherein the phase shift unit is configured in a former stage of the electrode or a later stage of the data modulation unit.

15. The optical transmitting apparatus according to claim 13, wherein the monitor means comprises synchronous detection means for extracting and synchronously detecting a signal with twice of the frequency of the low-frequency signal from an O/E converter or peak power detection means for extracting a signal with the same frequency as the low-frequency signal from the O/E converter to detect peak power.

16. The optical transmitting apparatus according to the claim 3, wherein the low-frequency signal superimposing means comprises a phase shifter and the phase shifter adjusts the phase difference between the low-frequency signals at nπ/2 (where n is a natural number other than 0 and multiples of 4).

17. An optical transmitting apparatus comprising a phase modulator and a driving signal generation unit for driving the phase modulator, wherein
the phase modulator comprises a phase shift unit which provides a proper phase difference between a pair of split optical signals on an optical waveguide, a data modulation unit with a data input unit on a split optical waveguide, and an electrode, which is configured in a former stage or later stage of the data modulation unit, for superimposing a low-frequency signal, and wherein
said optical transmitting apparatus further comprises:
low-frequency signal superimposing means for generating a low-frequency signal and for providing the low-frequency signal to the electrode configured in an optical waveguide, which is the same as the optical waveguide where the phase shift unit or a bias input terminal of the phase shift unit is configured or on the electrode configured on an optical waveguide, which is different from the optical waveguide where the phase shift unit is configured;
monitor means for monitoring at least one of maximum power, minimum power and phase of a low-frequency signal or a higher harmonic signal of the low-frequency signal superimposed on the optical signal after coupling of the split optical waveguide; and
phase difference control means for controlling the phase shift unit so as to obtain a proper phase difference based on the output of the monitor means.

18. An optical transmitting apparatus comprising a phase modulator and a driving signal generation unit for driving the phase modulator, wherein
the phase modulator comprises a phase shift unit which provides a proper phase difference between a pair of split optical signals on an optical waveguide and data modulation unit with a data input unit on a split optical waveguide, and wherein
said optical transmitting apparatus further comprises:
an O/E converter for converting an optical signal into an electrical signal after coupling the split optical waveguide;
high-speed power monitor for square detection of the electrical signal from the E/O converter for monitoring peak power fluctuation; and
phase difference control means for controlling the phase shift unit based on the monitor output of the high-speed power monitor.

19. An optical transmitting apparatus comprising a phase modulator, a driving signal generation unit for driving the phase modulator and an intensity modulator for modulating an optical output signal from the phase modulator, wherein
the phase modulator comprises a phase shift unit which provides a proper phase difference between a pair of split optical signals on an optical waveguide, a data modulation unit with a data input unit on a split optical waveguide, and an electrode, which is configured in a later stage of the data modulation unit, for superimposing a low-frequency signal, and wherein
said optical transmitting apparatus further comprises:
monitor means for monitoring any of the maximum power of the low-frequency signal, the minimum power of a higher harmonic signal with a frequency of twice of the frequency of the low-frequency signal, or the phase of the higher harmonic signal, by extracting the low-frequency signal after coupling of the split optical waveguide;
phase shift unit control means for providing the low-frequency signals with a proper phase difference to the electrode and for controlling the phase shift unit by bias control so that the proper phase difference can be obtained based on the output from the monitor means;
first and second automatic bias control means for adding the low-frequency signals on each arm of the data modulation unit and for controlling the data modulation unit by bias control based on the output of the monitor means;
third automatic bias control means for adding the low-frequency signal on the intensity modulator and for controlling the intensity modulator by bias control based on the output from the monitor means; and
switch control means comprising a switch for performing the controls in the monitoring in the monitor means, the phase shift control means and the first through the third automatic control means by time division.

20. An optical transmitting apparatus comprising a phase modulator, a driving signal generation unit for driving the phase modulator and an intensity modulator for modulating an optical output signal from the phase modulator, wherein
the phase modulator comprises a phase shift unit which provides a proper phase difference between a pair of split optical signals on an optical waveguide, a data modulation unit with a data input unit on a split optical waveguide, and an electrode, which is configured in a later stage of the data modulation unit, for superimposing a low-frequency signal, and wherein
said optical transmitting apparatus further comprises:
monitor means for monitoring at least one of maximum power, minimum power and phase of a low-frequency signal or a higher harmonic signal of the low-frequency signal superimposed on the optical signal after coupling of the split optical waveguide;
phase shift unit control means for adding a first low-frequency signals with a proper phase difference to the electrode, and for controlling the phase shift unit by bias control so as to obtain a proper phase difference based on the output from the monitor means;
first and second automatic bias control means for adding second and third low-frequency signals on each arm of the data modulation unit and for controlling the data modulation unit by bias control based on the output from the monitor means;
third automatic bias control means for adding a fourth low-frequency signal on the intensity modulator and for controlling the intensity modulator by bias control based on the output from the monitor means; and
collective control means for causing controls in the monitor operation in the monitor means, the phase shift unit control means, and the first through third automatic bias control means in parallel.

21. An optical transmitting apparatus comprising a phase modulator for performing phase modulation according to input data signal, an intensity modulator for performing intensity modulation on an optical output signal from the phase modulator, and a driving signal generator unit for driving the phase modulator and the intensity modulator, comprising:
monitor means for monitoring at least one of maximum power, minimum power and phase of a low-frequency signal or a higher harmonic signal of the low-frequency signal superimposed on the optical signal after coupling of the split optical waveguide;
automatic bias control means for adding a low-frequency signal on the phase modulator and the intensity modulator and for controlling the phase modulator and the intensity modulator by bias control based on the output from the monitor means; and
control means for causing the bias control in the monitor operation of the monitor means and the automatic bias control means by time division.

22. An optical transmitting apparatus comprising a phase modulator for performing phase modulation according to input data signal, an intensity modulator for performing intensity modulation on an optical output signal from the phase modulator, and a driving signal generator unit for driving the phase modulator and the intensity modulator, comprising:
first monitor means for extracting a first low-frequency signal superimposed on optical output signal from the phase modulator, and for monitoring the phase and power of the first low-frequency signal;
first automatic bias means for adding the first low-frequency signal on the phase modulator and for controlling the phase modulator by bias control based on the output from the first monitor means;
second monitor means for extracting a second low-frequency signal superimposed on optical output signal from the intensity modulator, and for monitoring the phase and power of the second low-frequency signal; and
second automatic bias means for adding the second low-frequency signal on the intensity modulator and for controlling the intensity modulator by bias control based on the output from the second monitor means.

23. An optical transmitting apparatus for transmitting an optical signal modulated corresponding to a data signal, comprising:
a phase shift unit for controlling a phase of at least one of a first optical signal and a second optical signal, acquired by splitting an optical input, so that the first and the second optical signals have a predetermined phase difference on an optical waveguide;
a data modulation unit for modulating the phases of the first and the second optical signals by using the data signal on the optical waveguide;
monitor means for monitoring average optical power of a modulated optical signal acquired by coupling the first and the second optical signals modulated by the data modulation unit; and
control means for controlling the phase shift unit based on an output of the monitor means,
wherein the data modulation unit comprises phase addition means for adding a prescribed phase to a phase determined according to the data signal.

24. The optical transmitting apparatus according to claim 23, wherein
the data modulation unit is a Mach-Zehnder modulator, and
the phase addition means is realized by forming an electrode for providing voltage to one waveguide of the Mach-Zehnder modulator so that the electrode reaches the coupled waveguide in the output side of the Mach-Zehnder modulator.

25. The optical transmitting apparatus according to claim 23, wherein
the data modulation unit is Mach-Zehnder modulator, and
the phase addition means is attenuation means for causing difference in amplitudes of a pair of data signals provided for the Mach-Zehnder modulator from each other.

26. The optical transmitting apparatus according to claim 23, wherein
the data modulation unit is Mach-Zehnder modulator, and
the phase addition means is delay means for causing difference in timings of a pair of data signals provided for the Mach-Zehnder modulator from each other.

27. An optical transmitting apparatus for transmitting an optical signal modulated corresponding to a data signal, comprising:
mark rate adjustment means for adjusting mark rate of the data signal;
a phase shift unit for controlling a phase of at least one of a first optical signal and a second optical signal, acquired by splitting an optical input, so that the first and the second optical signals have a predetermined phase difference on an optical waveguide;
a data modulation unit for modulating the phase of the first and the second optical signals by using a data signal with its mark rate adjusted on the optical waveguide;
monitor means for monitoring average optical power of a modulated optical signal acquired by coupling the first and the second optical signals modulated by the data modulation unit; and
control means for controlling the phase shift unit based on the output of the monitor means.

28. An optical receiving apparatus for receiving and demodulating a phase-modulated optical signal, comprising:
an interferometer comprising a first arm for delaying first split light of optical input by a symbol time period and a second arm for shifting a phase of the second split light of the optical input by a prescribed amount;
an O/E converter circuit for converting an optical signal output from the interferometer into an electrical signal;
a calculation circuit for generating a squared signal or an absolute value signal of the electrical signal;
a filter, connected to the calculation circuit, for transmitting at least a part of frequency component except for the frequency, which is a integral multiple of a symbol frequency; and
control means for controlling the amount of the phase shift in the second arm based on the output from the filter.

29. An optical receiving apparatus for receiving and demodulating a phase-modulated optical signal, comprising:
an interferometer comprising a first arm for delaying first split light of optical input by a symbol time period and a second arm for shifting a phase of the second split light of the optical input by a prescribed amount;
a low-frequency signal generator unit for providing a low-frequency signal to the second arm;
an O/E converter circuit for converting an optical signal output from the interferometer into an electrical signal; and
control means for controlling the amount of the phase shift in the second arm based on the power of the low-frequency signal or a higher harmonic signal of the low-frequency signal extracted from the electrical signal.

30. An optical receiving apparatus for receiving and demodulating a phase-modulated optical signal, comprising:
an interferometer comprising a first arm for delaying first split light of optical input by a symbol time period and a second arm for shifting a phase of the second split light of the optical input by a prescribed amount;
an O/E converter circuit for converting an optical signal output from the interferometer into an electrical signal;
sampling means for sampling the electrical signal in a period of a symbol period or an integral multiple of the symbol period; and
control means for controlling the amount of the phase shift in the second arm based on distribution of sampling values acquired by the sampling means.

31. An optical receiving apparatus for receiving and demodulating a phase-modulated optical signal, comprising:
an interferometer comprising a first arm for transmitting first split light of an optical input and a second arm for delaying second split light of the optical input by one bit;
an O/E converter circuit for converting an optical signal output from the interferometer into an electrical signal;
a calculation circuit for generating a squared signal or an absolute value signal of the electrical signal; and
control means for controlling delay time in the second arm based on the output of the calculation circuit.

32. An optical receiving apparatus for receiving and demodulating a phase-modulated optical signal, comprising:
an interferometer comprising a first arm for transmitting first split light of an optical input and a second arm for delaying second split light of the optical input by one bit;
a low-frequency signal generator unit for providing a low-frequency signal to the second arm;
an O/E converter circuit for converting an optical signal output from the interferometer into an electrical signal; and
control means for controlling delay time in the second arm based on power of the low-frequency signal or a higher harmonic signal of the low-frequency signal extracted from the electrical signal.

33. An optical communication system, comprising:
the optical transmitting apparatus according to claim 1; and
an optical receiving apparatus receiving an optical signal transmitted from the optical transmitting apparatus.

34. An optical communication system, comprising:
an optical transmitting apparatus; and
the optical receiving apparatus according to claim 28 for receiving an optical signal transmitted from the optical transmitting apparatus.
